(19) United States
(12) Patent Application Publication
(10) Pub. No.: US 2024/0008024 A1
(43) Pub. Date: Jan. 4, 2024

(54) METHOD AND DEVICE FOR REPEATEDLY TRANSMITTING DOWNLINK CONTROL INFORMATION WHEN PERFORMING NETWORK COOPERATIVE COMMUNICATION

(71) Applicant: Samsung Electronics Co., Ltd., Suwon-si (KR)

(72) Inventors: Euichang JUNG, Suwon-si (KR); Youngrok JANG, Suwon-si (KR); Suha YOON, Suwon-si (KR)

(21) Appl. No.: 18/468,124

(22) Filed: Sep. 15, 2023

Related U.S. Application Data
(63) Continuation of application No. PCT/KR2022/005654, filed on Apr. 20, 2022.

(30) Foreign Application Priority Data
Apr. 20, 2021 (KR) 10-2021-0051368

(51) Int. Cl. H04W 72/11; H04W 72/232; H04L 1/1812

(52) U.S. Cl. CPC H04W 72/11; H04W 72/232; H04L 1/1812

(57) ABSTRACT

A 5G or 6G communication system for supporting higher data transmission rates. A method performed by a terminal in a communication system may include one or more of the steps: receiving semi persistent scheduling (SPS) configuration information and control channel configuration information from a base station; receiving downlink control information (DCI), repeatedly transmitted through a plurality of physical downlink control channels (PDCCHs), from the base station on the basis of the control channel configuration information; and confirming, on the basis of information included in each of pieces of repeatedly transmitted DCI, whether an activated SPS PDSCH is deactivated. When the activated SPS PDSCH is deactivated, data decoding is not attempted in the deactivated SPS PDSCH.

### CROSS-REFERENCE TO RELATED APPLICATIONS

This application is a continuation of International Application No. PCT/KR2022/005654 filed on Apr. 20, 2022, designating the United States, in the Korean Intellectual Property Receiving Office, and claiming priority to KR patent Application No. 10-2021-0051368 filed on Apr. 20, 2021, in the Korean Intellectual Property Office, the disclosures of all of which are hereby incorporated by reference herein in their entireties.

### BACKGROUND

### Field

Certain example embodiments relate to operations of a terminal and/or base station in a wireless communication system. For example, certain example embodiments relate to a method and/or device for repeatedly transmitting downlink control information in network cooperative communication, and/or a device capable of performing the same.

### Description of Related

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with eXtended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

Certain example embodiments provide a device and/or method capable of effectively providing services in a mobile communication system.

For solving one or more of the above problems, a method may be performed by a terminal in a communication system and may comprise: receiving, from a base station, semi persistent scheduling (SPS) configuration information and control channel configuration information, receiving, from the base station, downlink control information (DCI) repetitively transmitted through a plurality of physical downlink control channels (PDCCHs) based on the control channel configuration information; and identifying whether activated SPS PDSCH is deactivated based on information included in each of the repetitively transmitted DCI, wherein in case that the activated SPS PDSCH is deactivated, decoding of data is not attempted in the deactivated SPS PDSCH.

In certain example embodiments, a method performed by a base station in a communication system may comprise transmitting, to a terminal, semi persistent scheduling (SPS) configuration information and control channel configuration information, determining deactivation of an activated SPS physical downlink shared channel (PDSCH), producing repetitively transmitted downlink control information (DCI) each including information for deactivating the activated SPS PDSCH, and transmitting, to the terminal, the repetitively transmitted DCI through a plurality of physical downlink control channels (PDCCHs) based on the control channel configuration information, wherein data is not transmitted in the deactivated SPS PDSCH.

In certain example embodiments, a terminal in a communication system may include a transceiver, and a controller (comprising processing circuitry) configured to receive, from a base station, semi persistent scheduling (SPS) configuration information and control channel configuration information, receive, from the base station, repetitively transmitted downlink control information (DCI) through a plurality of physical downlink control channels (PDCCHs) based on the control channel configuration information, and identify whether an activated SPS PDSCH is deactivated based on information included in each of the repetitively transmitted DCI, wherein in case that the activated SPS PDSCH is deactivated, decoding of data in the deactivated SPS PDSCH is not attempted.

In certain example embodiments, a base station in a communication system may include a transceiver, and a controller (comprising processing circuitry) that is connected, directly or indirectly, to the transceiver and is configured to transmit, to a terminal, semi persistent scheduling (SPS) configuration information and control channel configuration information, determine deactivation of an activated SPS physical downlink shared channel (PDSCH), produce repetitively transmitted downlink control information (DCI) each including information for deactivating the activated SPS PDSCH, and transmit, to the terminal, the repetitively transmitted DCI through a plurality of physical downlink control channels (PDCCHs) based on the control channel configuration, wherein data is not transmitted in the deactivated SPS PDSCH in certain example embodiments.

Certain example embodiments provide a device and/or method capable of effectively providing services in a mobile communication system.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating a basic structure of time-frequency domains in a wireless communication system according to an example embodiment.

FIG. 2 is a diagram illustrating frame, subframe, and slot structures in a wireless communication system according to an example embodiment.

FIG. 3 is a diagram illustrating an example of a configuration of the bandwidth part in a wireless communication system according to an example embodiment.

FIG. 4 is a diagram illustrating an example of a configuration of a control resource set of a downlink control channel in a wireless communication system according to an example embodiment.

FIG. 5A is a diagram illustrating a structure of a downlink control channel in a wireless communication system according to an example embodiment.

FIG. 5B is a diagram illustrating a case in which an UE may have a plurality of physical downlink control channel (PDCCH) monitoring occasions within a slot through a span in a wireless communication system according to an example embodiment.

FIG. 6 is a diagram illustrating an example of a discontinuous reception (DRX) operation in a wireless communication system according to an example embodiment.

FIG. 7 is a diagram illustrating an example of BS beam allocation according to a transmission configuration indication (TCI) state configuration in a wireless communication system according to an example embodiment.

FIG. 8 is a diagram illustrating an example of a method of allocating TCI states for a PDCCH in a wireless communication system according to an example embodiment.

FIG. 9 is a diagram illustrating a TCI indication medium access control (MAC) control element (CE) signaling structure for a PDCCH demodulation reference signal (DMRS) in a wireless communication system according to an example embodiment.

FIG. 10 is a diagram illustrating an example of a control resource set and beam configuration of search spaces in a wireless communication system according to an example embodiment.

FIG. 11 is a diagram illustrating a method for a BS and an UE to transmit/receive data in consideration of a downlink data channel and a rate matching resource in a wireless communication system according to an example embodiment;

FIG. 12A is a diagram illustrating a method for an UE to select a receivable control resource set in consideration of priority when receiving a downlink control channel in a wireless communication system according to an example embodiment.

FIG. 12B is a diagram illustrating a method for an UE to select a receivable control resource set in consideration of priority when receiving a downlink control channel in a wireless communication system according to an example embodiment.

FIG. 13 is a diagram illustrating an example of frequency domain resource allocation of a PDSCH in a wireless communication system according to an example embodiment.

FIG. 14 is a diagram illustrating an example of time domain resource allocation of a PDSCH in a wireless communication system according to an example embodiment.

FIG. 15 is a diagram illustrating an example of time domain resource allocation according to subcarrier spacing of a data channel and a control channel in a wireless communication system according to an example embodiment.

FIG. 16 is a diagram illustrating a procedure for beam configuration and activation of a PDSCH according to an example embodiment.

FIG. 17 is a diagram illustrating an example of PUSCH repetitive transmission type B in a wireless communication system according to an example embodiment.

FIG. 18 is a diagram illustrating a wireless protocol structure of a BS and an UE in single cell, carrier aggregation, and dual connectivity in a wireless communication system according to an example embodiment.

FIG. 19 is a diagram illustrating a constitution of antenna ports and an example of resource allocation for cooperative communication in a wireless communication system according to an example embodiment.

FIG. 20 is a diagram illustrating an example for a constitution of downlink control information (DCI) for cooperative communication in a wireless communication system according to an example embodiment.

FIG. 21A is a diagram illustrating an Enhanced PDSCH TCI state activation/deactivation MAC-CE structure.

FIG. 21B is a diagram illustrating a terminal operation according to semi-persistent scheduling (SPS) configuration and configured grant configuration according to an example embodiment.

FIG. 21C is a diagram illustrating a method for deactivating ConfiguredGrant type2 (UL grant type 2) according to an example embodiment.

FIG. 21D is a diagram illustrating a method for determining a PDSCH for data reception in the case where a plurality of SPS PDSCH resources in a slot overlap according to an example embodiment.

FIG. 22 is a diagram illustrating a process of producing a PDCCH that is repetitively transmitted through two TRPs according to an example embodiment.

FIG. 23 is a diagram illustrating a method for a BS to repeatedly transmit PDCCHs according to an example embodiment.

FIG. 24 is a diagram illustrating a method for allocating time and frequency resources of a plurality of PDSCHs, based on NC-JT, scheduled from control resource sets in which different CORESETPoolIndex are configured according to an example embodiment.

FIG. 25A is a flowchart illustrating an operation in which an UE receives control and/or data transmitted by a base station in a communication system according to an example embodiment.

FIG. 25B is a flowchart illustrating an operation in which an UE receives control and/or data transmitted by a base station in a communication system according to an example embodiment.

FIG. 25C is a flowchart illustrating an operation in which an UE receives control and/or data transmitted by a base station in a wireless communication system according to an example embodiment.

FIG. 26 is a diagram illustrating a structure of an UE in a wireless communication system according to an example embodiment.

FIG. 27 is a diagram illustrating a structure of a BS in a wireless communication system according to an example embodiment.

### DETAILED DESCRIPTION

Hereinafter, certain example embodiments will be described in detail with reference to the accompanying drawings.

In describing the embodiments, descriptions related to technical contents well-known in the art to which the disclosure pertains and not associated directly with the disclosure will be omitted. Such an omission of unnecessary descriptions is intended to prevent or reduce a chance of obscuring of the main idea of the disclosure and more clearly transfer the main idea.

For the same reason, in the accompanying drawings, some elements may be exaggerated, omitted, or schematically illustrated. Further, the size of each component does not completely reflect the actual size. In the drawings, identical or corresponding components are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements. Further, in describing the disclosure, a detailed description of known functions or constitutions incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

In the following description, a base station is an entity that allocates resources to terminals, and may be at least one of a gNode B, an eNode B, a Node B, a base station (BS), a wireless access unit, a base station controller, and a node on a network. A terminal may include a user equipment (UE), a mobile station (MS), a cellular phone, a smartphone, a computer, or a multimedia system capable of performing communication functions. In the disclosure, a “downlink (DL)” refers to a radio transmission path via which a base station transmits a signal to a terminal, and an “uplink (UL)” refers to a radio transmission path via which a terminal transmits a signal to a base station. Further, in the following description, LTE or LTE-A systems may be described by way of example, but the embodiments of the disclosure may also be applied to other communication systems having similar technical backgrounds or channel types. Examples of such communication systems may include 5th generation mobile communication technologies (5G, new radio, and NR) developed beyond LTE-A, and in the following description, the “5G” may be the concept that covers the exiting LTE, LTE-A, or other similar services. In addition, based on determinations by those skilled in the art, the embodiments of the disclosure may also be applied to other communication systems through some modifications without significantly departing from the scope of the disclosure.

Herein, it will be understood that each block of the flowchart illustrations, and combinations of the flowchart illustrations, can be implemented by computer program instructions. These computer program instructions can be provided to a processor of a general-purpose computer, special purpose computer, or other programmable data processing apparatus, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable data processing apparatus to produce a computer implemented process such that the instructions that execute on the computer or other programmable data processing apparatus provide steps for implementing the functions specified in the flowchart block or blocks.

Further, each block of the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software component or a hardware component, such as a Field Programmable Gate Array (FPGA) or an Application Specific Integrated Circuit (ASIC), which performs a predetermined function. However, the “unit” does not always have a meaning limited to software or hardware. The “unit” may be constituted either to be stored in an addressable storage medium or to execute one or more processors. Therefore, the “unit” includes, for example, software components, object-oriented software components, class components or task components, processes, functions, properties, procedures, sub-routines, segments of a program code, drivers, firmware, micro-codes, circuits, data, database, data structures, tables, arrays, and parameters. The components and functions provided by the “unit” may be either combined into a smaller number of components, or a “unit”, or divided into a larger number of components, or a “unit”. Moreover, the components and “units” or may be implemented to reproduce one or more CPUs within a device or a security multimedia card. Further, in the embodiments, the “unit” may include one or more processors.

A wireless communication system has been developed from a wireless communication system providing a voice centered service in the early stage toward broadband wireless communication systems providing high-speed and high-quality packet data services using communication standards, such as high-speed packet access (HSPA) of 3GPP, LTE ({long-term evolution or evolved universal terrestrial radio access (E-UTRA)}, LTE-Advanced (LTE-A), LTE-Pro, high-rate packet data (HRPD) of 3GPP2, ultra-mobile broadband (UMB), IEEE 802.16e, and the like.

As a typical example of the broadband wireless communication system, an LTE system employs an orthogonal frequency division multiplexing (OFDM) scheme in a downlink (DL) and employs a single carrier frequency division multiple access (SC-FDMA) scheme in an uplink (UL). The uplink indicates a radio link through which a user equipment (UE or MS) transmits data or control signals to a base station (BS)(eNode B), and the downlink indicates a radio link through which the base station transmits data or control signals to the UE. The above multiple access scheme may separate data or control information of respective users by allocating and operating time-frequency resources for transmitting the data or control information for each user so as to avoid overlapping each other, that is, so as to establish orthogonality.

Since a 5G communication system, which is a post-LTE communication system, must freely reflect various requirements of users, service providers, and the like, services satisfying various requirements must be supported. The services considered in the 5G communication system include enhanced mobile broadband (eMBB) communication, massive machine-type communication (mMTC), ultra-reliability low-latency communication (URLLC), and the like.

eMBB aims at providing a data rate higher than that supported by existing LTE, LTE-A, or LTE-Pro. For example, in the 5G communication system, eMBB must provide a peak data rate of 20 Gbps in the downlink and a peak data rate of 10 Gbps in the uplink for a single base station. Furthermore, the 5G communication system must provide an increased user-perceived data rate to the UE, as well as the maximum data rate. In order to satisfy such requirements, transmission/reception technologies including a further enhanced multi-input multi-output (MIMO) transmission technique are required to be improved. In addition, the data rate required for the 5G communication system may be obtained using a frequency bandwidth more than 20 MHz in a frequency band of 3 to 6 GHz or 6 GHz or more, while transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, in order to effectively provide the Internet of Things. Since the Internet of Things provides communication functions while being provided to various sensors and various devices, it must support a large number of UEs (e.g., 1,000,000 UEs/km2) in a cell. In addition, the UEs supporting mMTC may require wider coverage than those of other services provided by the 5G communication system because the UEs are likely to be located in a shadow area, such as a basement of a building, which is not covered by the cell due to the nature of the service. The UE supporting mMTC must be constituted to be inexpensive, and may require a very long battery life-time, such as 10 to 15 years, because it is difficult to frequently replace the battery of the UE.

Lastly, URLLC is a cellular-based mission-critical wireless communication service. For example, URLLC may be used for remote control for robots or machines, industrial automation, unmanned aerial vehicles, remote health care, emergency alert, and the like. Thus, URLLC must provide communication with ultra-low latency and ultra-high reliability. For example, a service supporting URLLC must satisfy an air interface latency of less than 0.5 ms, and also requires a packet error rate of 10⁻⁵ or less. Therefore, for the services supporting URLLC, a 5G system must provide a transmit time interval (TTI) shorter than those of other services, and also may require a design for assigning a large number of resources in a frequency band in order to secure reliability of a communication link.

Three services in 5G, that is, eMBB, URLLC, and mMTC, may be multiplexed and transmitted in a single system. In this case, different transmission/reception techniques and transmission/reception parameters may be used between services in order to satisfy different requirements of the respective services. It is apparent that 5G is not limited to the three services described above.

[NR Time-Frequency Resources]

Hereinafter, a frame structure of the 5G system is described in more detail with reference to the drawings.

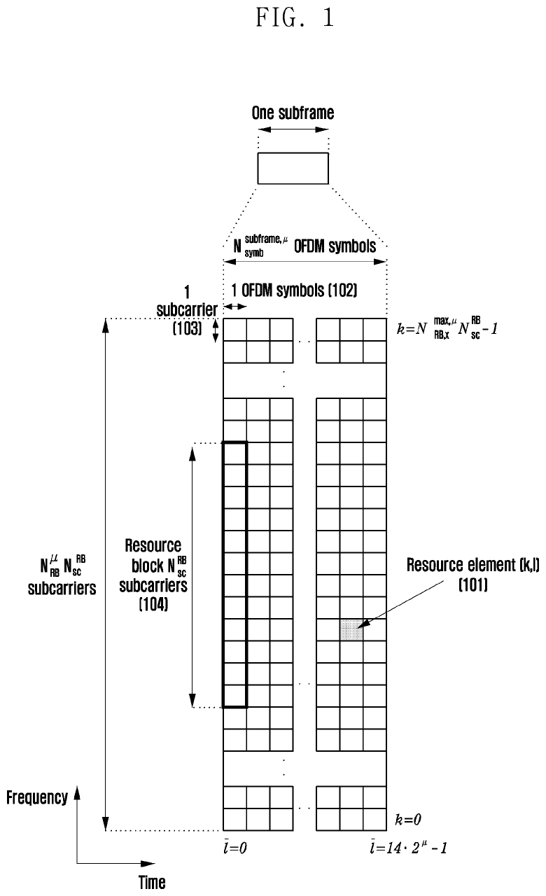

FIG. 1 illustrates a basic structure of a time-frequency domain which is a radio resource area in which data or a control channel is transmitted in a 5G system.

In FIG. 1, a horizontal axis indicates a time domain and a vertical axis indicates a frequency domain. A basic unit of resources in the time and frequency domains is a resource element (RE) 101 and may be defined as 1 orthogonal frequency division multiplexing (OFDM) symbol 102 in the time domain and 1 subcarrier 103 in the frequency domain. In the frequency domain, N_{SC}^{RB} (for example, 12) consecutive REs may constitute one resource block (RB) 104.

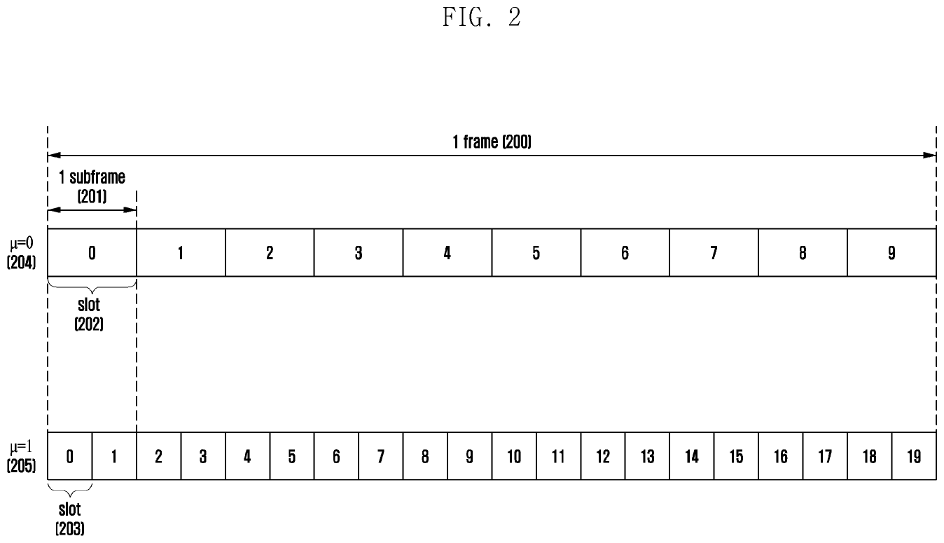

FIG. 2 is a diagram illustrating structures of a frame, subframe, slot in a wireless communication system according to an example embodiment.

In FIG. 2, an example of the structures of a frame 200, subframe 201, and slot 202 is illustrated. One frame 200 may be defined as 10 ms. One subframe 201 may be defined as 1 ms, and accordingly one frame 200 may include a total of 10 subframes 201. One slot 202 or 203 may be defined as 14 OFDM symbols (that is, the number of symbols (N_{symb}^{slot}) per slot=14). One subframe 201 may include one or a plurality of slots 202 or 203, and the number of slots 202 or 203 per subframe 201 may vary depending on a configuration value μ 204 or 205 for subcarrier spacing. In the example of FIG. 2, the cases in which the subcarrier spacing configuration values μ=0 204 and μ=1 205 are illustrated. One subframe 201 may include one slot 202 in the case of μ=0 204, and one subframe 201 may include two slots 203 in the case of μ=1 205. That is, the number of slots (Nₛₗₒₜ^{subframe,μ}) per subframe may be different according to the configuration value μ for subcarrier spacing, and accordingly, the number of slots (Nₛₗₒₜ^{frame,μ}) per frame may be different. Nₛₗₒₜ^{subframe,μ} and Nₛₗₒₜ^{frame,μ} according to each subcarrier spacing configuration μ may be defined as shown in [Table 1] below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

[Bandwidth Part (BWP)]

Next, a configuration of a bandwidth part (BWP) in the 5G communication system will be described in detail with reference to the drawings.

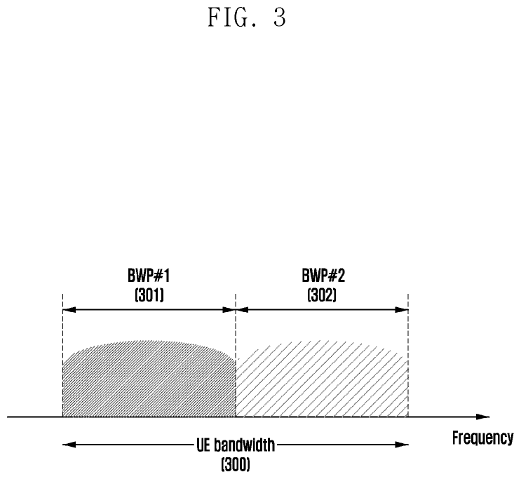

FIG. 3 is a diagram illustrating an example of a configuration for a BWP in a wireless communication system according to an example embodiment.

FIG. 3 shows an example in which an UE bandwidth 300 is configured as two bandwidth parts, that is, bandwidth part #1 (BWP #1) 301 and bandwidth part #2 (BWP #2) 302. The BS may configure one or a plurality of BWPs in the UE, and the following information may be configured to each BWP.

TABLE 2

| BWP ::= | | SEQUENCE { |
|---|---|---|
| | bwp-Id | BWP-Id, |
| ( | BWP identity ) | |
| | locationAndBandwidth | INTEGER (1..65538), |
| | ( BWP location ) | |
| | subcarrierSpacing | ENUMERATED {n0, n1, n2, n3, n4, |

n5},

| | |
|---|---|
| cyclicPrefix | ENUMERATED { extended } |

}

Of course, the disclosure is not limited to the example, and various parameters related to a BWP as well as the configuration information may be configured in the UE. The information may be transmitted from to the UE by the BS through higher-layer signaling, for example, radio resource control (RRC) signaling. Among one or a plurality of configured BWPs, at least one BWP may be activated. Whether to activate the configured BWPs may be semi-statically transferred from the BS to the UE through RRC signaling or may be dynamically transferred through Downlink Control Information (DCI).

According to some embodiments, the UE before the radio resource control (RRC) connection may receive a configuration of an initial BWP for initial access from the BS through a master information block (MIB). More specifically, the UE may receive configuration information for a control resource set (CORESET) and a search space in which a PDCCH for receiving system information (remaining system information (RMSI) or system information block 1 (SIB 1)) required for initial access through the MIB can be transmitted in an initial access step. Each of the CORESET and the search space configured through the MIB may be considered as an identity (ID) 0. The BS may inform the UE of configuration information such as frequency allocation information for control resource set #0, time allocation information, numerology, and the like through the MIB. Further, the BS may inform the UE of configuration information for a monitoring period and an occasion of control resource set #0, that is, configuration information for search space #0 through the MIB. The UE may consider a frequency region configured as control resource set #0 acquired from the MIB as an initial bandwidth part for initial access. Here, the identity (ID) of the initial BWP may be considered as 0.

The configuration of the BWP supported by 5G may be used for various purposes.

According to some embodiments, in case that a BWP supported by the UE is smaller than the system BWP, the smaller BWP may be supported through the configuration of the BWP. For example, the BS may configure a frequency location (configuration information 2) of the BWP in the UE, and thus the UE may transmit and receive data at a specific frequency location within the system BWP.

Further, according to some embodiments, the BS may configure a plurality of BWPs in the UE in order to support different numerologies. For example, in order to support the UE to perform data transmission and reception using both subcarrier spacing of 15 kHz and subcarrier spacing of 30 kHz, two BWPs may be configured as subcarrier spacings of 15 kHz and 30 kHz, respectively. Different BWPs may be frequency-division-multiplexed, and in the case that data is transmitted and received at particular subcarrier spacing, the BWP configured at the corresponding subcarrier spacing may be activated.

Further, according to some embodiments, the BS may configure BWPs having different sizes in the UE in order to reduce power consumption of the UE. For example, in the case that the UE supports a very large bandwidth, for example, 100 MHz and always transmits and receives data through the corresponding bandwidth, very high power consumption may be generated. Particularly, monitoring an unnecessary downlink control channel through a large bandwidth of 100 MHz in the state in which there is no traffic is very inefficient from the aspect of power consumption. In order to reduce power consumption of the UE, the BS may configure a BWP having a relatively narrow bandwidth, for example, a bandwidth of 20 MHz. The UE may perform a monitoring operation in the bandwidth part of 20 MHz in the state in which there is no traffic, and in the case that data is generated, may transmit and receive data through the bandwidth part of 100 MHz according to an instruction from the BS.

In a method of configuring the BWP, UEs before the RRC connection may receive configuration information for an initial bandwidth part through a master information block (MIB) in an initial access step. More specifically, the UE may receive a configuration of a control resource set (CORESET) for a downlink control channel in which downlink control information (DCI) for scheduling a system information block (SIB) can be transmitted from an MIB of a physical broadcast channel (PBCH). A bandwidth of the control resource set configured as the MIB may be considered as an initial bandwidth part, and the UE may receive a physical downlink shared channel (PDSCH), in which the SIB is transmitted, through the configured initial bandwidth part. The initial BWP may be used not only for reception of the SIB but also other system information (OSI), paging, or random access.

[Change of Bandwidth Part (BWP)]

In the case where one or more BWPs are configured for the UE, the BS may instruct the UE to change (switch or transition) the BWP using a bandwidth part indicator field in the DCI. For example, in the case that a currently active BWP of the UE is BWP #1 301 in FIG. 3, the BS may notify the UE of BWP #2 302 using a bandwidth part indicator in the DCI, and the UE may perform changing of a BWP to BWP #2 302 indicated by the bandwidth part indicator in the received DCI.

As described above, since DCI-based BWP change is indicated by the DCI for scheduling a PDSCH or a PUSCH, in the case that the UE receives a request for changing the BWP, the UE must easily receive and transmit a PDSCH or PUSCH scheduled by the corresponding DCI in the changed BWP. To this end, the standard stipulates the requirements for a delay time (T_{BWP}) required when changing the BWP, and may be defined, for example, as follows.

TABLE 3

BWP switch delay T_{BWP} (slots)

| μ | NR Slot length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of SCS, the BWP switch delay is determined by the larger one between the SCS before BWP switch and the SCS after BWP switch.

The requirements for a BWP change delay time supports Type 1 or Type 2 depending on the capability of a UE. The UE may report a supported BWP delay time type to the BS.

In accordance with the above-described requirements for a BWP change delay time, in the case that the UE receives DCI including a BWP change indicator in slot n, the UE may complete a change to a new BWP indicated by the BWP change indicator at the time not later than slot n+T_{BWP}, and perform transmission/reception of a data channel scheduled by the corresponding DCI in the new changed BWP. In the case that the BS is to schedule a data channel with a new BWP, the BS may determine resource allocation for the data channel in the time domain in consideration of the BWP change delay time (T_{BWP}) of the UE. That is, when scheduling a data channel with a new BWP, the BS may schedule a corresponding data channel after the BWP change delay time in a method of determining time domain resource assignment for the data channel. Accordingly, the UE may not expect that the DCI indicating the BWP change will indicate a slot offset value (K0 or K2) smaller than the BWP change delay time (T_{BWP}).

If the UE receives a DCI (e.g., DCI format 1_1 or 0_1) indicating a BWP change, the UE may not perform any transmission or reception during a period of time from the third symbol of the slot in which a PDCCH including the corresponding DCI is received to the starting point of the slot indicated by a slot offset value (K0 or K2) indicated by a time-domain resource assignment indicator field in the corresponding DCI. For example, if the UE receives DCI indicating a BWP change in slot n, and if the slot offset value indicated by the DCI is K, the UE may not perform any transmission or reception from the third symbol of slot n to the symbol before slot n+K (e.g., the last symbol of slot n+K−1). Meanwhile, in the disclosure, the UE receiving the DCI through the PDCCH, the UE receiving the PDCCH including the DCI, or the UE receiving the PDCCH may be used in the same meaning. In addition, the BS transmitting the DCI through the PDCCH, the UE transmitting the PDCCH including the DCI, or the UE transmitting the PDCCH may be used in the same meaning.

[SS/PBCH Block]

Subsequently, a synchronization signal (SS)/PBCH block in 5G is described.

The SS/PBCH block may be a physical layer channel block including a primary SS (PSS), a secondary SS (SSS), and a physical broadcast channel (PBCH). A detailed description thereof is made below.
PSS: It is a signal which is a reference of downlink time/frequency synchronization and provides some pieces of information of a cell ID.
SSS: It is a reference of downlink time/frequency synchronization and provides the remaining cell ID information which the PSS does not provide. In addition, it serves as a reference signal for demodulation of a PBCH.
PBCH: It provides necessary system information required for transmitting and receiving a data channel and a control channel by the UE. The necessary system information may include control information related to a search space indicating radio resource mapping information of a control channel, scheduling control information for a separate data channel for transmitting system information, and the like.
SS/PBCH block: It includes a combination of PSS, SSS, and PBCH. One or a plurality of SS/PBCH blocks may be transmitted within a time of 5 ms, and each of the transmitted SS/PBCH blocks may be separated by an index.

The UE may detect the PSS and the SSS in an initial access stage and decode the PBCH. The UE may acquire an MIB from the PBCH and receive a configuration of control resource set (CORESET) #0 (corresponding to a control resource set having control resource set index 0) therefrom. The UE may monitor control resource set #0 on the basis of the assumption that the selected SS/PBCH block and a demodulation reference signal (DMRS) transmitted in control resource set #0 are quasi co-located (QCLed). The UE may receive system information through downlink control information transmitted in control resource set #0. The UE may acquire configuration information related to a random access channel (RACH) required for initial access from the received system information. The UE may transmit a physical RACH (PRACH) to the BS in consideration of the selected SS/PBCH block index, and the BS receiving the PRACH may acquire the SS/PBCH block index selected by the UE. The BS may know which block is selected by the UE from among the SS/PBCH blocks and that CORESET #0 related thereto is monitored.

[DRX]

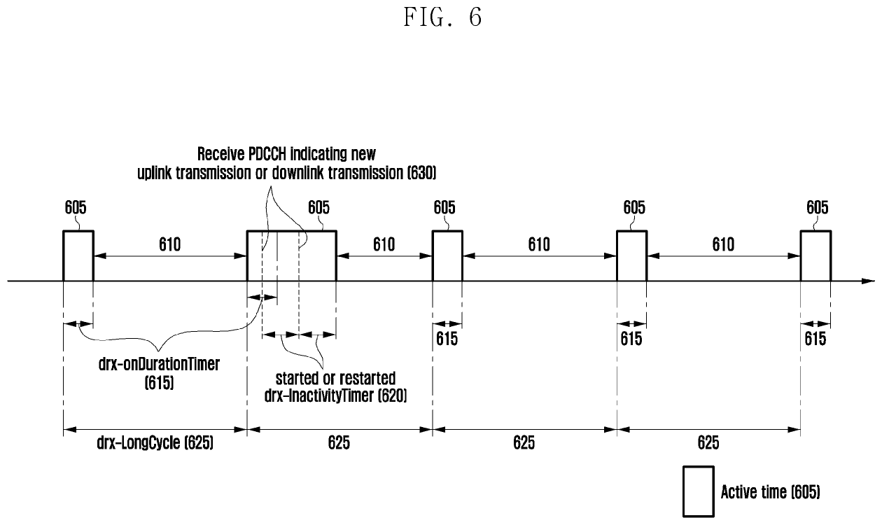

FIG. 6 is a diagram illustrating an example of a discontinuous reception (DRX).

Discontinuous reception (DRX) is an operation in which the UE using a service discontinuously receives data in an RRC-connected state in which a radio link is established between the BS and the UE. When DRX is applied, the UE may turn on a receiver at a specific time point and monitor a control channel, and when there is no data received for a predetermined period, turn off the receiver to reduce power consumption of the UE. The DRX operation may be controlled by a MAC layer device on the basis of various parameters and a timer.

With reference to FIG. 6, an active time 605 is a time during which the UE wakes up every DRX cycle and monitors a PDCCH. The active time 605 may be defined as follows.
drx-onDurationTimer or drx-InactivityTimer or drx-RetransmissionTimerDL or drx-RetransmissionTimerUL or ra-ContentionResolutionTimer is running; or
a Scheduling Request is sent on PUCCH and is pending; or
a PDCCH indicating a new transmission addressed to the C-RNTI of the MAC entity has not been received after successful reception of a Random Access Response for the Random Access Preamble not selected by the MAC entity among the contention-based Random Access Preamble

drx-onDurationTimer, drx-InactivityTimer, drx-RetransmissionTimerDL, drx-RetransmissionTimerUL, ra-ContentionResolutionTimer, and the like are timers of which values are configured by the BS, and have functions configured to monitor a PDCCH by the UE in the state in which a predetermined condition is satisfied.

The drx-onDurationTimer 615 is a parameter for configuring a minimum time during which the UE is awake in a DRX cycle. The drx-InactivityTimer 620 is a parameter for configuring a time during which the UE is additionally awake in the case that a PDCCH indicating new uplink transmission or downlink transmission is received as indicated by reference numeral 630. The drx-RetransmissionTimerDL is a parameter for configuring a maximum time during which the UE is awake in order to receive downlink retransmission in a downlink HARQ procedure. The drx-RetransmissionTimerUL is a parameter for configuring a maximum time during which the UE is awake in order to receive a grant of uplink retransmission in an uplink HARQ procedure. The drx-onDurationTimer, drx-InactivityTimer, drx-RetransmissionTimerDL, and drx-RetransmissionTimerUL may be configured as, for example, a time, the number of subframes, the number of slots, and the like. The ra-ContentionResolutionTimer is a parameter for monitoring a PDCCH in a random access procedure.

An inactive time 610 is a time in which no PDCCH monitoring is performed or a time in which no PDCCH reception is performed during the DRX operation, and the remaining time except for the active time 605 in the entire time in which the DRX operation is performed. When the PDCCH is not monitored during the active time 605, the UE may enter a sleep or inactive state and reduce power consumption.

The DRX cycle refers to a cycle on which the UE wakes up and monitors a PDCCH. That is, the DRX cycle is a time interval or a cycle of on duration from monitoring of the PDCCH to monitoring of the next PDCCH by the UE. The DRX cycle has two types such as a short DRX cycle and a long DRX cycle. The short DRX cycle may be optionally applied.

The long DRX cycle 625 is a longer cycle among the two DRX cycles configured in the UE. The UE starts the drx-onDurationTimer 615 at a time point at which the long DRX cycle 625 passes after a start point (for example, a start symbol) of the drx-onDurationTimer 615 while the long DRX cycle operates. In the operation of the long DRX cycle 625, the UE may start the drx-onDurationTimer 615 in a slot after drx-SlotOffset in a subframe that satisfies [Equation 1] below. Here, the drx-SlotOffset is a delay before the drx-onDurationTimer 615 starts. The drx-SlotOffset may be configured as, for example, a time, the number of slots, or the like.

[(SFN×10)+subframe number]modulo(drx-LongCycle)=drx-StartOffset [Equation 1]

Here, the “drx-LongCycleStartOffset” and the “drx-StartOffset” may be used to define the long DRX cycle 625 and a subframe in which the long DRX cycle 625 is to start. The drx-LongCycleStartOffset may be configured as, for example, a time, the number of subframes, the number of slots, or the like.

[PDCCH: In Relation to DCI]

Next, downlink control information (DCI) in a 5G system will be described in detail.

In the 5G system, scheduling information for uplink data (or a physical uplink data channel (physical uplink shared channel (PUSCH)) or downlink data (or physical downlink data channel (physical downlink shared channel (PDSCH)) is transmitted from the BS to the UE through DCI. The UE may monitor a fallback DCI format and a non-fallback DCI format for the PUSCH or the PDSCH. The fallback DCI format may include a fixed field predefined between the BS and the UE, and the non-fallback DCI format may include a configurable field.

The DCI may be transmitted through a Physical Downlink Control Channel (PDCCH) via a channel coding and modulation process. A cyclic redundancy check (CRC) may be added to a DCI message payload and may be scrambled by a radio network temporary identifier (RNTI) corresponding to the identity of the UE. Depending on the purpose of the DCI message, for example, UE-specific data transmission, a power control command, a random access response, or the like, different RNTIs may be used. That is, the RNTI is not explicitly transmitted but is included in a CRC calculation process to be transmitted. If the DCI message transmitted through the PDCCH is received, the UE may identify the CRC through the allocated RNTI, and may recognize that the corresponding message is transmitted to the UE when the CRC is determined to be correct on the basis of the CRC identification result.

For example, DCI for scheduling a PDSCH for system information (SI) may be scrambled by an SI-RNTI. DCI for scheduling a PDSCH for a random access response (RAR) message may be scrambled by an RA-RNTI. DCI for scheduling a PDSCH for a paging message may be scrambled by a P-RNTI. DCI for notifying of a slot format indicator (SFI) may be scrambled by an SFI-RNTI. DCI for notifying of transmit power control (TPC) may be scrambled with a TPC-RNTI. DCI for scheduling a UE-specific PDSCH or PUSCH may be scrambled by a cell RNTI (C-RNTI).

DCI format 0_0 may be used for fallback DCI for scheduling a PUSCH in which case the CRC may be scrambled by a C-RNTI. DCI format 0_0 in which the CRC is scrambled by the C-RNTI may include, for example, the following information.

TABLE 4

| | |
|---|---|
| - | Identifier for DCI formats - [1] bit |
| - | Frequency domain resource assignment - |
| | [┌log₂(N_{RB}^{UL, BWP}(N_{RB}^{UL, BWP} +1)/2)┐ ] bits |
| - | Time domain resource assignment - X bits |
| - | Frequency hopping flag - 1 bit. |
| - | Modulation and coding scheme - 5 bits |
| - | New data indicator - 1 bit |
| - | Redundancy version - 2 bits |
| - | HARQ process number - 4 bits |
| - | TPC command for scheduled PUSCH - [2] bits |
| - | UL/SUL (supplementary uplink) indicator - 0 or 1 bit |

DCI format 0_1 may be used for non-fallback DCI for scheduling a PUSCH in which case the CRC may be scrambled by a C-RNTI. DCI format 0_1 in which the CRC is scrambled by the C-RNTI may include, for example, the following information.

```
TABLE 5
Carrier indicator - 0 or 3 bits
UL/SUL indicator - 0 or 1 bit
Identifier for DCI formats - [1] bits
Bandwidth part indicator - 0, 1 or 2 bits
Frequency domain resource assignment
  For resource allocation type 0, ┌N [symbol] /P┐ bits
  For resource allocation type 1, ┌log₂(N [symbol] (N [symbol]  + 1)/2┐ bits
Time domain resource assignment - 1, 2, 3, or 4 bits
VRB-to-PRB mapping (virtual resource block to-physical resource
block mapping) - 0 or 1 bit, only for resource allocation type 1.
  0 bit if only resource allocation type 0 is configured;
  1 bit otherwise.
Frequency hopping flag - 0 or 1 bit, only for resource allocation
type 1.
  0 bit if only resource allocation type 0 is configured;
  1 bit otherwise.
Modulation and coding scheme - 5 bits
New data indicator - 1 bit
Redundancy version - 2 bits
HARQ process number - 4 bits
1st downlink assignment index - 1 or 2 bits
  1 bit for semi-static HARQ-ACK codebook;
  2 bits for dynamic HARQ-ACK codebook with single
  HARQ-ACK codebook.
2nd downlink assignment index - 0 or 2 bits
  2 bits for dynamic HARQ-ACK codebook with two HARQ-
  ACK sub-codebooks;
  0 bit otherwise.
TPC command for scheduled PUSCH - 2 bits
  $SRS resource indicator - ⌈ {log}_{z} ( {\sum }_{k - 1}^{\text{?}} ( \begin{matrix}N \text{?} \\ k\end{matrix} ) ) ⌉ or ⌈ {log}_{2} ( N \text{?} ) ⌉ bits$
  $⌈ {log}_{2} ( {\sum }_{k - 1}^{\text{?}} ( \begin{matrix}N \text{?} \\ k\end{matrix} ) ) ⌉ bits for no - codebook based PUSCH$
  transmission:
  ┌log₂(N [symbol] (N [symbol] )┐ bits for codebook based PUSCH
  transmission.
Precoding information and number of layers -up to 6 bits
Antenna ports - up to 5 bits
SRS request - 2 bits
CSI request - 0, 1, 2, 3, 4, 5, or 6 bits
CBG (code block group) transmission information - 0, 2, 4, 6, or 8
bits
PTRS-DMRS association - 0 or 2 bits.
beta_offset indicator - 0 or 2bits
DMRS sequence initialization - 0 or 1 bit [symbol]
indicates data missing or illegible when filed
```

DCI format 1_0 may be used for fallback DCI for scheduling a PDSCH in which case the CRC may be scrambled by a C-RNTI. DCI format 1_0 in which the CRC is scrambled by the C-RNTI may include, for example, the following information.

TABLE 6

| | |
|---|---|
| - | Identifier for DCI formats - [1] bit |
| - | Frequency domain resource |
| | assignment -[┌log₂(N_{RB}^{DL, BWP}(N_{RB}^{DL, BWP} +1)/2)┐ ] bits |
| - | Time domain resource assignment - X bits |
| - | VRB-to-PRB mapping - 1 bit. |
| - | Modulation and coding scheme - 5 bits |
| - | New data indicator - 1 bit |
| - | Redundancy version - 2 bits |
| - | HARQ process number - 4 bits |
| - | Downlink assignment index - 2 bits |
| - | TPC command for scheduled PUCCH - [2] bits |
| - | PUCCH resource indicator- 3 bits |
| - | PDSCH-to-HARQ feedback timing indicator- [3] bits |

DCI format 1 DCI format 1_1 may be used for non-fallback DCI for scheduling a PDSCH in which case the CRC may be scrambled by a C-RNTI. DCI format 1_1 in which the CRC is scrambled by the C-RNTI may include, for example, the following information.

TABLE 7

| | |
|---|---|
| - | Carrier indicator - 0 or 3 bits |
| - | Identifier for DCI formats - [1] bits |
| - | Bandwidth part indicator - 0, 1 or 2 bits |
| - | Frequency domain resource assignment |

• For resource allocation type 0, ┌N_{RB}^{DL, BWP} / P┐ bits
• For resource allocation type 1,
┌log₂(N_{RB}^{DL, BWP}(N_{RB}^{DL, BWP} +1)/2)┐ bits

| | |
|---|---|
| - | Time domain resource assignment -1, 2, 3, or 4 bits |
| - | VRB-to-PRB mapping - 0 or 1 bit, only for resource allocation |
| | type 1. |

• 0 bit if only resource allocation type 0 is configured;
• 1 bit otherwise.

| | |
|---|---|
| - | PRB bundling size indicator - 0 or 1 bit |
| - | Rate matching indicator - 0, 1, or 2 bits |
| - | ZP CSI-RS trigger - 0, 1, or 2 bits |

For transport block 1:

| | |
|---|---|
| - | Modulation and coding scheme - 5 bits |
| - | New data indicator - 1 bit |
| - | Redundancy version - 2 bits |

For transport block 2:

| | |
|---|---|
| - | Modulation and coding scheme - 5 bits |
| - | New data indicator - 1 bit |
| - | Redundancy version - 2 bits |
| - | HARQ process number - 4 bits |
| - | Downlink assignment index - 0 or 2 or 4 bits |
| - | TPC command for scheduled PUCCH - 2 bits |
| - | PUCCH resource indicator - 3 bits |
| - | PDSCH-to-HARQ feedback timing indicator - 3 bits |
| - | Antenna ports - 4, 5 or 6 bits |
| - | Transmission configuration indication - 0 or 3 bits |
| - | SRS request - 2 bits |
| - | CBG transmission information - 0, 2, 4, 6, or 8 bits |
| - | CBG flushing out information - 0 or 1 bit |
| - | DMRS sequence initialization - 1 bit |

[PDCCH: CORESET, REG, CCE, Search Space]

Hereinafter, the downlink control channel in the 5G communication system will be described in more detail with reference to the drawings.

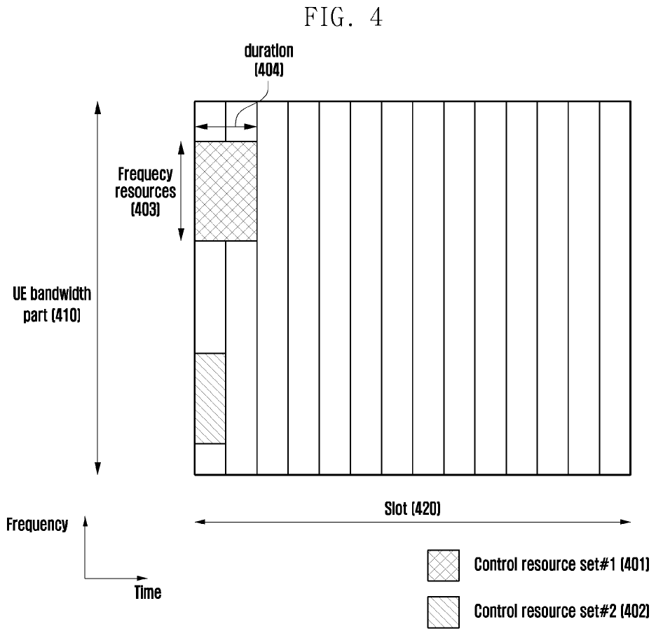

FIG. 4 is a diagram illustrating an example of a control resource set (CORESET) in which a downlink control channel is transmitted in the wireless communication system. FIG. 4 illustrates an example in which a UE bandwidth part 410 is configured in the frequency domain and two control resource sets (control resource set #1 401 and control resource set #2 402) are configured within one slot 420 in the time domain. The control resource sets 401 and 402 may be configured in specific frequency resources 403 within a total UE BWP 410 in the frequency domain. The control resource set may be configured as one or a plurality of OFDM symbols in the time domain, which may be defined as a control resource set duration 404. With reference to the example illustrated in FIG. 4, the control resource set #1 401 may be configured as a control resource set duration of 2 symbols, and control resource set #2 402 may be configured as a control resource set duration of 1 symbol.

The above described resource control set in 5G may be configured in the UE by the BS through higher-layer signaling (for example, system information, a master information block (MIB), or radio resource control (RRC) signaling). Configuring the control resource set in the UE may indicate providing information such as a control resource set identity, a frequency location of the control resource set, and a symbol length of the control resource set. For example, the following information may be included.

TABLE 8

| ControlResourceSet ::= | SEQUENCE { |
|---|---|
| -- Corresponds to L1 parameter [symbol] | |
| controlResourceSetId | ControlResourceSetId, |
| ( [symbol] resource set identity ( [symbol] dentity)) | |
| frequencyDomain [symbol] | BIT STRING (SIZE [symbol] |
| (frequency domain resource allocation information) | |
| duration | INTEGER [symbol] |
| (time domain resource allocation information) | |
| [symbol] | CHOICE { |
| [symbol] | SEQUENCE { |
| reg-BundleSize | ENUMERATED [symbol] |
| [symbol] Granularity | ENUMERATED [symbol] |
| [symbol] | |
| interleaverSize | ENUMERATED [symbol] |
| shiftIndex | |
| INTEGER [symbol] | |
| OPTIONAL | |
| [symbol] | |
| }, | |
| [symbol] | NULL |
| }, | |
| [symbol] | SEQUENCE(SIZE [symbol] |
| Of TCI-StateId | OPTIONAL, |
| [symbol] | |
| tci-PresentInDCI | ENUMERATED [symbol] |

} [symbol]
indicates data missing or illegible when filed

In Table 8, tci-StatesPDCCH (hereinafter, referred to as a transmission configuration indication (TCI) state) configuration information may include information on one or a plurality of synchronization signal (SS)/physical broadcast channel (PBCH) block indexes or channel state information reference signal (CSI-RS) indexes having the quasi co-located (QCL) relationship with a DMRS transmitted in the corresponding CORESET.

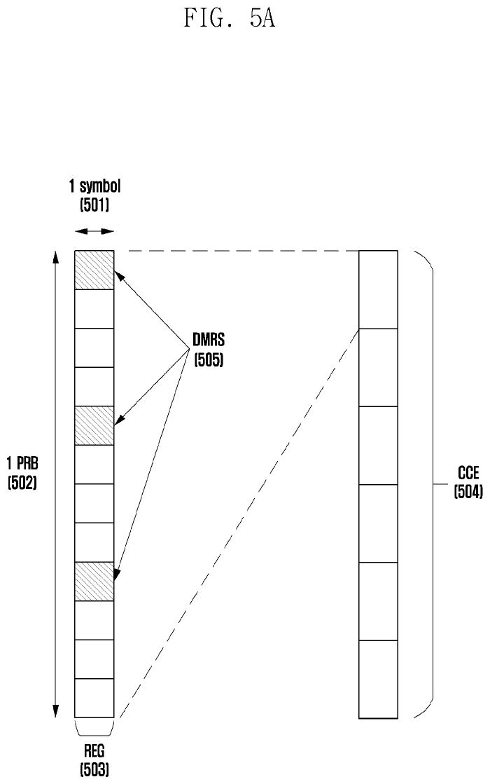

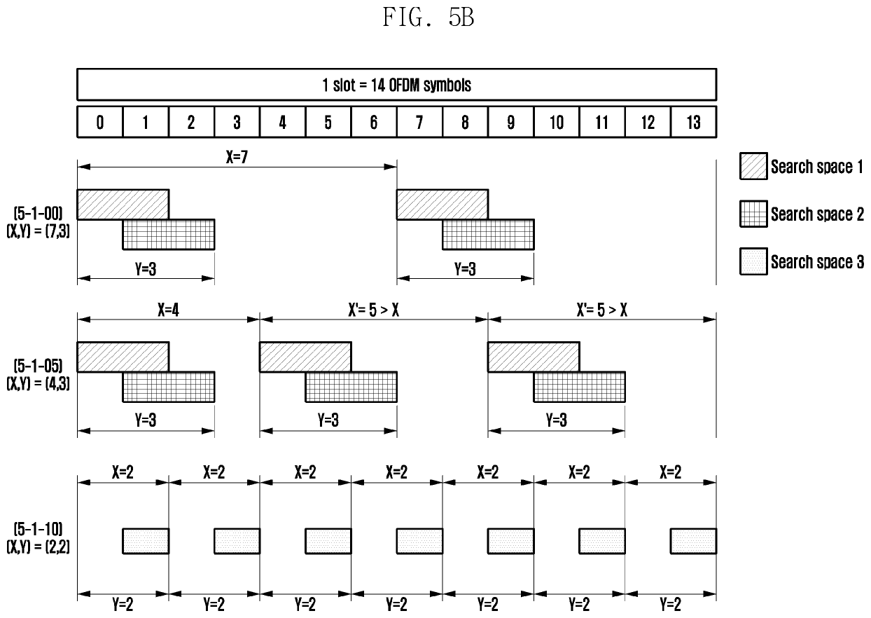

FIG. 5A is a diagram illustrating an example of a basic unit of time and frequency resources constituting a downlink control channel used in 5G. With reference to FIG. 5A, a basic unit of time and frequency resources constituting a control channel may be referred to as a resource element group (REG) 503, and the REG 503 may be defined as one OFDM symbol 501 in the time domain and one physical resource block (PRB) 502 in the frequency domain, that is, it may be defined as 12 subcarriers. The BS may constitute a downlink control channel allocation unit by concatenating the REG 503

As illustrated in FIG. 5A, in the case that the basic unit in which downlink control channels are allocated in 5G is a control channel element (CCE) 504, one CCE 504 may include a plurality of REGs 503. For example, the REG 503 illustrated in FIG. 5A may include 12 REs and, when 1 CCE 504 includes 6 REGs 503, 1 CCE 504 may include 72 REs. When a downlink control resource set is configured, the corresponding resource set may include a plurality of CCEs 504, and a specific downlink control channel may be mapped to one or a plurality of CCEs 504 according to an aggregation level (AL) within the control resource set and then transmitted. CCEs 504 within the control resource set may be distinguished by numbers and the numbers of the CCEs 504 may be assigned according to a logical mapping scheme.

The basic unit of the downlink control channel illustrated in FIG. 5A, that is, the REG 503, may include all of REs to which the DCI is mapped and the region to which a DMRS 505, which is a reference signal for decoding the REs, is mapped. As illustrated in FIG. 5A, 3 DMRSs 505 may be transmitted within 1 REG 503. The number of CCEs required to transmit the PDCCH may be 1, 2, 4, 8, or 16 according to the aggregation level (AL), and the different number of CCEs may be used to implement link adaptation of the downlink control channel. For example, in the case that AL=L, one downlink control channel may be transmitted through L CCEs. The UE needs to detect a signal in the state in which the UE is not aware of information on the downlink control channel, and a search space indicating a set of CCEs is defined for blind decoding. The search space is a set of downlink control channel candidates including CCEs for which the UE should attempt decoding at the given aggregation level, and there are several aggregation levels at which one set of CCEs is configured by 1, 2, 4, 8, and 16 CCEs, so that the UE may have a plurality of search spaces. The search space set may be defined as a set of search spaces at all configured aggregation levels.

The search space may be classified into a common search space and a UE-specific search space. UEs in a predetermined group or all UEs may search for a common search space of the PDCCH in order to receive cell-common control information such as dynamic scheduling for system information or paging messages. For example, PDSCH scheduling allocation information for transmission of an SIB including information on a service provider of a cell may be received by searching for a common-search space of the PDCCH. In the case of the common search space, UEs in a predetermined group or all UEs should receive the PDCCH, so that the common-search space may be defined as a set of pre-arranged CCEs. Scheduling allocation information for the UE-specific PDSCH or PUSCH may be received by searching for a UE-specific search space of the PDCCH. The UE-specific search space may be UE-specifically defined as a UE identity and a function of various system parameters.

In 5G, parameters for the PDCCH search space may be configured in the UE by the BS through higher-layer signaling (for example, SIB, MIB, or RRC signaling). For example, the BS may configure, in the UE, the number of PDCCH candidates at each aggregation level L, a monitoring period of the search space, a monitoring occasion in units of symbols within the slot for the search space, a search space type (a common search space or a UE-specific search space), a combination of a DCI format and an RNTI to be monitored in the corresponding search space, and a control resource set index for monitoring the search space. For example, the following information may be included.

TABLE 9

| | |
|---|---|
| SearchSpace ::= | SEQUENCE { |

```
  -- Identity of the search space [symbol]  SearchSpaceId = [symbol]  identifies the SearchSpace
    configured via PSCH (MIB) or ServingCellConfigCommon.
```

| | |
|---|---|
| searchSpaceId | SearchSpaceId, |

(search space identity)

| | |
|---|---|
| controlResourceSetId | ControlResourceSetId, |

(control resource set identity)

| | |
|---|---|
| monitoringSlotPeriodicityOffset | CHOICE { |

(monitoring slot level period)

| | |
|---|---|
| sl1 | NULL, |
| sl2 | INTEGER (0..1), |
| [symbol] | INTEGER (0..3), |
| [symbol] | INTEGER (0..4), |
| sl8 | INTEGER (0..7), |
| sl10 | INTEGER (0..9), |
| sl16 | INTEGER (0..15), |
| sl20 | INTEGER (0..19) |

}

| | |
|---|---|
| duration(monitoring duration) | INTEGER [symbol] |
| monitoringSymbolWithinSlot | BIT STRING (SIZE (14)) |

(monitoring symbol in slot)

| | |
|---|---|
| nrofCandidates | SEQUENCE { |

(number of PDCCH candidates for aggregation level)

| | |
|---|---|
| aggregationLevel1 | ENUMERATED (n0, n1, n2, n3, n4, n5, n6, n8), |
| aggregationLevel2 | ENUMERATED (n0, n1, n2, n3, n4, n5, n6, n8), |
| aggreagtionLevel4 | ENUMERATED (n0, n1, n2, n3, n4, n5, n6, n8), |
| aggregationLevel8 | ENUMERATED (n0, n1, n2, n3, n4, n5, n6, n8), |
| aggregationLevel16 | ENUMERATED (n0, n1, n2, n3, n4, n5, n6, |

```
    n8),
  },
```

| | |
|---|---|
| searchSpaceType | CHOICE { |

```
  (search space type)
    -- Configures this search space as common search space (CSS) and DCI formats
    to monitor.
```

| | |
|---|---|
| common | SEQUENCE { |

```
    (common search space)
      }
```

| | |
|---|---|
| ue-Specific | SEQUENCE { |

```
    (UE-specific search space)
      -- Indicates whether the UE monitors in this [symbol]  for DCI formats 0-0 and 1-0
    or for formats 0-1 and 1-1.
```

| | |
|---|---|
| formats | ENUMERATED (formats0-0-And-1-0, |

```
    formats0-1-And-1-1),
      ...
    } [symbol]
indicates data missing or illegible when filed
```

The BS may configure one or a plurality of search space sets in the UE according to configuration information. According to some embodiments, the BS may configure search space set 1 and search space set 2 in the UE, and the configuration may be performed such that DCI format A scrambled by an X-RNTI in search space set 1 is monitored in the common search space and DCI format B scrambled by a Y-RNTI in search space set 2 is monitored in the UE-specific search space.

According to configuration information, one or a plurality of search space sets may exist in the common search space or the UE-specific search space. For example, search space set #1 and search space set #2 may be configured as common search spaces, and search space set #3 and search space set #4 may be configured as UE-specific search spaces.

In the common search space, the following combinations of DCI formats and RNTIs may be monitored. It is apparent that the disclosure is not limited to the following examples.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

In the UE-specific search space, the following combinations of DCI formats and RNTIs may be monitored. It is apparent that the disclosure is not limited to the following examples.
DCI format 0_0/1_0 with CRC scrambled by C-RNTI, CS-RNTI, TC-RNTI
DCI format 1_0/1_1 with CRC scrambled by C-RNTI, CS-RNTI, TC-RNTI

The described RNTIs may follow the following definition and use.

C-RNTI (Cell RNTI): a use for scheduling UE-specific PDSCH

TC-RNTI (Temporary Cell RNTI): a use for scheduling UE-specific PDSCH

CS-RNTI (Configured Scheduling RNTI): a use for semi-statically configured UE-specific PDSCH scheduling

RA-RNTI (Random Access RNTI): a use for PDSCH scheduling at random access stage

P-RNTI (Paging RNTI): a use for PDSCH scheduling through which paging is transmitted

SI-RNTI (System Information RNTI): a use for PDSCH scheduling through which system information is transmitted

INT-RNTI (Interruption RNTI): a use for indicating whether puncturing is performed for PDSCH

TPC-PUSCH-RNTI (Transmit Power Control for PUSCH RNTI): a use for indicating PUSCH power control command

TPC-PUCCH-RNTI (Transmit Power Control for PUCCH RNTI): a use for indicating PUCCH power control command

TPC-SRS-RNTI (Transmit Power Control for SRS RNTI): a use for indicating SRS power control command

The above described DCI formats may follow definitions below.

TABLE 10

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and |
| | OFDM symbol(s) where UE may assume no |
| | transmission is intended for the UE |
| 2_2 | Transmission of TPC commands for PUCCH and |
| | PUSCH |
| 2_3 | Transmission of a group of TPC commands for |
| | SRS transmissions by one or more UEs |

In 5G, the search space of an aggregation level L in a control resource set p and a search space set s may be expressed as in Equation 2 below.

$$L \cdot \{ ( {Y}_{p , {n}_{s , f}^{μ}} + ⌊ \frac{{m}_{s , {n}_{CI}} \cdot {N}_{CCE , p}}{L \cdot {M}_{p , s , max}^{( L )}} ⌋ + {n}_{CI} ) mod ⌊ {N}_{C CE , p} / L ⌋ \} + i \qquad [ Equation 2 ]$$

L: Aggregation level
n_{CI}: Carrier index
N_{CCH,p}: Total number of CCEs in control resource set p
n^{μ}_{s,f}: Slot index
M^{(L)}p,s,max: The number of PDCCH candidates in aggregation level L
m_{s,nCI}=0, . . . , M^{(L)}p,s,max−1: PDCCH candidate index in aggregation level L
i=0, . . . , L−1
Y [symbol] =(Aₚ·Y [symbol] ) mod D, Y [symbol] =n_{scm}=0, A₀=39827, A₁=39829, A₂=39829, D=65537
n_{RNTI}=UE identity

The value Y_{p,n}_{_{s,f}}^{μ} may correspond to zero in the case of a common search space.

In the case of a UE-specific search space, the value Y_{p,n}_{_{s,f}}^{μ} may correspond to a value that varies depending on the UE identity (C-RNTI or an ID configured to the UE by the base station) and a time index.

In 5G, since a plurality of search space sets may be configured using different parameters (e.g., the parameters in Table 9), a set of search space sets monitored by the UE may differ at each time. For example, in the case that search space set #1 is configured in an X-slot periodicity, and search space set #2 is configured in a Y-slot periodicity, and X and Y are different, the UE may monitor both search space set #1 and search space set #2 in a specific slot, and may monitor one of search space set #1 and search space set #2 in a specific slot.

[Pdcch: Span]

The UE may perform reporting of UE capability for each subcarrier spacing in the case where there is a plurality of PDCCH monitoring occasions within a slot, and in this case, the concept of a span may be used. A span indicates consecutive symbols that the UE is able to monitor PDCCHs in a slot, and each PDCCH monitoring occasion is within one span. The span may be expressed as (X, Y), where X indicates the minimum number of symbols by which first symbols of two consecutive spans must be spaced apart from each other, and Y indicates the number of consecutive symbols capable of monitoring PDCCHs within one span. In this case, the UE may monitor PDCCHs in the period of Y symbols from the first symbol of the span in the span.

FIG. 5B is a diagram illustrating the case in which a UE has a plurality of PDCCH monitoring occasions within a slot through a span in a wireless communication system. Span (X, Y)=(7,3), (4,3), and (2,2) may be possible, and the three cases are expressed as (5-1-00), (5-1-05), and (5-1-10), respectively, in FIG. 5B. As an example, (5-1-00) represents the case in which two spans expressed as (7,3) exist in a slot. The spacing between first symbols of two spans is expressed as X=7, and PDCCH monitoring occasions may exist within a total of Y=3 symbols from the first symbol of each span, and search spaces 1 and 2 exist within Y=3 symbols. As another example, (5-1-05) represents the case where a total of three spans expressed as (4,3) exist in the slot and where the spacing between the second and third spans is X′=5 symbols greater than X=4.

[PDCCH: UE Capability Report]

The slot position in which the above-described common search space and UE-specific search space are located is indicated by the parameter “monitoringSymbolsWithinSlot” in Table 9, and the symbol position in the slot is indicated by a bitmap through the parameter “monitoringSymbolsWithinSlot” in Table 9. Meanwhile, the symbol position within a slot in which the UE is able to monitor the search space may be reported to the base station through the following UE capabilities.
UE capability 1 (hereinafter referred to as “FG 3-1”). This UE capability indicates, in the case where one monitoring occasion (MO) for common search spaces or UE-specific search spaces in type 1 and type 3 exists in the slot as shown in Table 11-1 below, the capability of monitoring the corresponding MO when the corresponding MO is positioned in the first three symbols in the slot. This UE capability is a mandatory capability that all UEs supporting NR must support, and whether or not to support this capability may not be explicitly reported to the BS.

TABLE 11-1

| | Feature | | Field name in |
|---|---|---|---|
| Index | group | Components | TS 38.331 |
| 3-1 | Basic DL | 1) One configured CORESET per BWP per cell in | n/a |
| | control | addition to CORESET0 | |
| | channel | CORESET resource allocation of 6RB bit-map and | |
| | | duration of 1-3 OFDM symbols for FR1 | |
| | | For type 1 CSS without dedicated RRC | |
| | | configuration and for type 0, 0A, and 2 CSSs, | |
| | | CORESET resource allocation of 6RB bit-map and | |
| | | duration 1-3 OFDM symbols for FR2 | |
| | | For type 1 CSS with dedicated RRC configuration | |
| | | and for type 3 CSS, UE specific SS, CORESET | |
| | | resource allocation of 6RB bit-map and duration 1-2 | |
| | | OFDM symbols for FR2 | |
| | | REG-bundle sizes of 2/3 RBs or 6 RBs | |
| | | Interleaved and non-interleaved CCE-to-REG | |
| | | mapping | |
| | | Precoder-granularity of REG-bundle size | |
| | | PDCCH DMRS scrambling determination | |
| | | TCI state(s) for a CORESET configuration | |
| | | 2) CSS and UE-SS configurations for unicast | |
| | | PDCCH transmission per BWP per cell | |
| | | PDCCH aggregation levels 1, 2, 4, 8, 16 | |
| | | UP to 3 search space sets in a slot for a scheduled | |
| | | SCell per BWP | |
| | | This search space limit is before applying all | |
| | | dropping rules. | |
| | | For type 1 CSS with dedicated RRC configuration, | |
| | | type 3 CSS, and UE-SS, the monitoring occasion is | |
| | | within the first 3 OFDM symbols of a slot | |
| | | For type 1 CSS without dedicated RRC | |
| | | configuration and for type 0, 0A, and 2 CSS, the | |
| | | monitoring occasion can be any OFDM symbol(s) of | |
| | | a slot, with the monitoring occasions for any of Type | |
| | | 1- CSS without dedicated RRC configuration, or | |
| | | Types 0, 0A, or 2 CSS configurations within a single | |
| | | span of three consecutive OFDM symbols within a | |
| | | slot | |
| | | 3) Monitoring DCI formats 0_0, 1_0, 0_1, 1_1 | |
| | | 4) Number of PDCCH blind decodes per slot with a | |
| | | given SCS follows Case 1-1 table | |
| | | 5) Processing one unicast DCI scheduling DL and | |
| | | one unicast DCI scheduling UL per slot per | |
| | | scheduled CC for FDD | |
| | | 6) Processing one unicast DCI scheduling DL and 2 | |
| | | unicast DCI scheduling UL per slot per scheduled | |
| | | CC for TDD | |

UE capability 2 (hereinafter referred to as “FG 3-2”). This UE capability indicates, in the case where one monitoring occasion (MO) for a common search space or a UE-specific search space exists in the slot as shown in Table 11-2 below, the capability of monitoring the MO, regardless of the location of the start symbol of the corresponding MO. This UE capability is selectively supported by the UE (optional), and whether or not to support this capability may be explicitly reported to the BS.

TABLE 11-2

| Index | Feature group | Components | Field name in TS 38.331 |
|---|---|---|---|
| 3-2 | PDCCH | For a given UE, all search | pdcchMonitoringSingleOccasion |
| | monitoring on any | space configurations are | |
| | span of up to 3 | within the same span of 3 | |
| | consecutive OFDM | consecutive OFDM | |
| | symbols of a slot | symbols in the slot | |

UE capability 3 (hereinafter referred to as “FG 3-5, 3-5a, or 3-5b”). This UE capability indicates, in the case where a plurality of monitoring occasions (MOs) for a common search space or a UE-specific search space exists in the slot as shown in Table 11-3 below, a pattern of the MO capable of being monitored by the UE. The above-described pattern is comprised of spacing X between start symbols of different MOs and a maximum symbol length Y for one MO. A combination of (X, Y) supported by the UE may be one or more of {(2, 2), (4, 3), (7, 3)}. This UE capability is selectively supported by the UE (optional), and whether or not to support this capability and the above-mentioned combination (X, Y) may be explicitly reported to the BS.

TABLE 11-3

| Index | Feature group | Components | Field name in TS 38.331 [2] |
|---|---|---|---|
| 3-5 | For type 1 | For type 1 CSS with dedicated RRC configuration, | pdcch-MonitoringAnyOccasions |
| | CSS with | type 3 CSS, and UE-SS, monitoring occasion can | { |
| | dedicated RRC | be any OFDM symbol(s) of a slot for Case 2 | 3-5. withoutDCI-Gap |
| | configuration, | | 3-5a. withDCI-Gap |
| | type 3 CSS, | | } |
| | and UE-SS, | | |
| | monitoring | | |
| | occasion can | | |
| | be any OFDM | | |
| | symbol(s) of a | | |
| | slot for Case 2 | | |
| 3-5a | For type 1 | For type 1 CSS with dedicated RRC configuration, | |
| | CSS with | type 3 CSS and UE-SS, monitoring occasion can be | |
| | dedicated RRC | any OFDM symbol(s) of a slot for Case 2, with | |
| | configuration, | minimum time separation (including the cross-slot | |
| | type 3 CSS, | boundary case) between two DL unicast DCIs, | |
| | and UE-SS, | between two UL unicast DCIs, or between a DL and | |
| | monitoring | an UL unicast DCI in different monitoring occasions | |
| | occasion can | where at least one of them is not the monitoring | |
| | be any OFDM | occasions of FG-3-1, for a same UE as | |
| | symbol(s) of a | 2 OFDM symbols for 15 kHz | |
| | slot for Case 2 | 4 OFDM symbols for 30 kHz | |
| | with a DCI gap | 7 OFDM symbols for 60 kHz with NCP | |
| | | 11 OFDM symbols for 120 kHz | |
| | | Up to one unicast DL DCI and up to one unicast UL | |
| | | DCI in a monitoring occasion except for the | |
| | | monitoring occasions of FG 3-1. | |
| | | In addition for TDD the minimum separation | |
| | | between the first two UL unicast DCIs within the first | |
| | | 3 OFDM symbols of a slot can be zero OFDM symbols. | |
| 3-5b | All PDCCH | PDCCH monitoring occasions of FG-3-1, plus | |
| | monitoring | additional PDCCH monitoring occasion(s) can be | |
| | occasion can | any OFDM symbol(s) of a slot for Case 2, and for any | |
| | be any OFDM | two PDCCH monitoring occasions belonging to | |
| | symbol(s) of a | different spans, where at least one of them is not the | |
| | slot for Case 2 | monitoring occasions of FG-3-1, in same or different | |
| | with a span gap | search spaces, there is a minimum time separation | |
| | | of X OFDM symbols (including the cross-slot | |
| | | boundary case) between the start of two spans, | |
| | | where each span is of length up to Y consecutive | |
| | | OFDM symbols of a slot. Spans do not overlap. | |
| | | Every span is contained in a single slot. The same | |
| | | span pattern repeats in every slot. The separation | |
| | | between consecutive spans within and across slots | |
| | | may be unequal but the same (X, Y) limit must be | |
| | | satisfied by all spans. Every monitoring occasion is | |
| | | fully contained in one span. In order to determine a | |
| | | suitable span pattern, first a bitmap b(I), 0 <= I <= 13 is | |
| | | generated, where b(I) = 1 if symbol I of any slot is part | |
| | | of a monitoring occasion, b(I) = 0 otherwise. The first | |
| | | span in the span pattern begins at the smallest I for | |
| | | which b(I) = 1. The next span in the span pattern | |
| | | begins at the smallest I not included in the previous | |
| | | span(s) for which b(I) = 1. The span duration is | |
| | | max{maximum value of all CORESET durations, | |
| | | minimum value of Y in the UE reported candidate | |
| | | value} except possibly the last span in a slot which | |
| | | can be of shorter duration. A particular PDCCH | |
| | | monitoring configuration meets the UE capability | |
| | | limitation if the span arrangement satisfies the gap | |
| | | separation for at least one (X, Y) in the UE reported | |
| | | candidate value set in every slot, including cross slot | |
| | | boundary. | |
| | | For the set of monitoring occasions which are within | |
| | | the same span: | |
| | | Processing one unicast DCI scheduling DL | |
| | | and one unicast DCI scheduling UL per scheduled | |
| | | CC across this set of monitoring occasions for FDD | |
| | | Processing one unicast DCI scheduling DL | |
| | | and two unicast DCI scheduling UL per scheduled | |
| | | CC across this set of monitoring occasions for TDD | |
| | | Processing two unicast DCI scheduling DL | |
| | | and one unicast DCI scheduling UL per scheduled | |
| | | CC across this set of monitoring occasions for TDD | |
| | | The number of different start symbol indices of spans | |
| | | for all PDCCH monitoring occasions per slot, | |
| | | including PDCCH monitoring occasions of FG-3-1, is | |
| | | no more than floor(14/X) (X is minimum among | |
| | | values reported by UE). | |
| | | The number of different start symbol indices of | |
| | | PDCCH monitoring occasions per slot including | |
| | | PDCCH monitoring occasions of FG-3-1, is no more | |
| | | than 7. | |
| | | The number of different start symbol indices of | |
| | | PDCCH monitoring occasions per half-slot including | |
| | | PDCCH monitoring occasions of FG-3-1 is no more | |
| | | than 4 in SCell. | |

The UE may report whether or not to support the above-described UE capability 2 and/or UE capability 3 and related parameters to the BS. The BS may perform resource allocation in the time domain for a common search space and a UE-specific search space, based on the reported UE capability. During the resource allocation, the BS may not assign the MO at the position where the UE is unable to monitor the same.

[Pdcch: BD/CCE Limit]

In the case where a plurality of search space sets is configured for the UE, the following conditions may be considered in a method for determining a search space set to be monitored by the UE.

If a value “monitoringCapabilityConfig-r16”, which is higher layer signaling, is configured as “r15 monitoringcapability”, the UE defines the maximum values of the number of PDCCH candidates capable of being monitored and the number of CCEs constituting the entire search space (here, the entire search space indicates an entire CCE set corresponding to the union area of a plurality of search space sets) for each slot, and if the value “monitoringCapabilityConfig-r16” is configured as “r16 monitoringcapability”, the UE defines the maximum values of the number of PDCCH candidates capable of being monitored and the number of CCEs constituting the entire search space (here, the entire search space indicates an entire CCE set corresponding to the union area of a plurality of search space sets) for each span.

[Condition 1: Limit of Maximum Number of PDCCH Candidates]

According to the configuration value of higher layer signaling described above, M, the maximum number of PDCCH candidates capable of being monitored by the UE, may be configured according to Table 12-1 below in the case that it is defined based on a slot, and may be configured according to Table 12-2 below in the case that it is defined based on a span, in a cell configured with a subcarrier spacing of 15·2^{μ} kHz.

TABLE 12-1

| | Maximum number of PDCCH candidates |
|---|---|
| μ | per slot and per serving cell (M^{μ}) |
| 0 | 44 |
| 1 | 36 |
| 2 | 22 |
| 3 | 20 |

TABLE 12-2

| | Maximum number M^{μ} of monitored PDCCH candidates per | | |
|---|---|---|---|
| | span for combination (X, Y) and per serving cell | | |
| μ | (2, 2) | (4, 3) | (7, 3) |
| 0 | 14 | 28 | 44 |
| 1 | 12 | 24 | 36 |

[Condition 2: Limit of Maximum Number of CCEs]

According to the configuration value of higher layer signaling described above, C^{μ}, the maximum number of CCEs constituting the entire search space (here, the entire search space indicates the entire CCE set corresponding to the union area of a plurality of search space sets), may be configured according to Table 12-3 below in the case that it is defined based on a slot, and may be configured according to Table 12-4 below in the case that it is defined based on a spa, in a cell configured with a subcarrier spacing of 15·2^{μ} kHz.

TABLE 12-3

| | Maximum number of CCEs per |
|---|---|
| μ | slot and per serving cell (C^{μ}) |
| 0 | 56 |
| 1 | 56 |
| 2 | 48 |
| 3 | 32 |

TABLE 12-4

| | Maximum number C^{μ} of non-overlapped CCEs per | | |
|---|---|---|---|
| | span for combination (X, Y) and per serving cell | | |
| μ | (2, 2) | (4, 3) | (7, 3) |
| 0 | 18 | 36 | 56 |
| 1 | 18 | 36 | 56 |

For convenience of explanation, a situation that satisfies both conditions 1 and 2 at a specific time is defined as “condition A”. Therefore, a situation that does not satisfy condition A may indicate that the situation does not satisfy at least one of conditions 1 and 2 above.

[PDCCH: Overbooking]

Condition A may not be satisfied at a specific time depending on the configuration of search space sets by the BS. In the case that condition A is not satisfied at a specific time, the UE may select and monitor only some of the search space sets configured to satisfy condition A at that time, and the BS may transmit a PDCCH to the selected search space sets.

Selection of some search spaces from among the overall configured search space sets may be performed according to the following methods.

In the case that condition A for a PDCCH is not satisfied at a specific time (slot), the UE (or the BS) may preferentially select the search space set in which the search space type is configured as a common search space from among the search space sets existing at the corresponding time, instead of the search space set in which the search space type is configured as a UE-specific search space.

In the case that all search space sets configured as a common search space are selected (e.g., in the case that condition A is satisfied even after selecting all search spaces configured as a common search space), the UE (or the BS) may select the search space sets configured as a UE-specific search space. In this case, in the case that there are a plurality of search space sets configured as a UE-specific search space, the search space set having a lower search space set index may have a higher priority. The UE may select UE-specific search space sets within a range in which condition A is satisfied in consideration of priority.

[QCL, TCI State]

In a wireless communication system, one or more different antenna ports (these may be replaced with one or more channels, signals, and a combination thereof, and will be collectively referred to as different antenna ports in the description of the disclosure below for convenience) may be associated with each other by quasi co-location (QCL) configuration as shown in Table 13 below. The TCI state is intended to announce the QCL relationship between a PDCCH (or a PDCCH DMRS) and another RS or channel, and the case where a certain reference antenna port A (reference RS #A) and another target antenna port B (target RS #B) are QCLed indicates that the UE is allowed to apply some or all of large-scale channel parameters estimated from the antenna port A to measurement of a channel from the antenna port B. QCL is required to associate different parameters depending on the situation, such as 1) time tracking affected by average delay and delay spread, 2) frequency tracking affected by Doppler shift and Doppler spread, 3) radio resource management (RRM) affected by average gain, 4) beam management (BM) affected by spatial parameters, and the like. Accordingly, NR supports four types of QCL relationships as shown in Table 13 below.

TABLE 13

| QCL | |
|---|---|
| type | Large-scale characteristics |
| A | Doppler shift, Doppler spread, average delay, delay spread |
| B | Doppler shift, Doppler spread |
| C | Doppler shift, average delay |
| D | Spatial Rx parameter |

The spatial RX parameters may refer to some or a of various parameters such as angle of arrival (AoA), power angular spectrum (PAS) of AoA, angle of departure (AoD), PAS of AoD, transmit/receive channel correlation, transmit/receive beamforming, spatial channel correlation, and the like. The QCL relationship may be configured for the UE through an RRC parameter TCI-State and QCL-Info as shown in Table 14 below. With reference to Table 14, the BS may configure one or more TC states for the UE and inform the UE of up to two QCL relationships (qcl-Type1 and qcl-Type2) about the RS with reference to the ID of the TC state, that is, the target RS. In this case, each piece of QCL information (QCL-Info) included in each TCI state includes a serving cell index and a BWP index of the reference RS indicated by the QCL information, the type and ID of the reference RS, and the QCL type shown in Table 13 above.

| | |
|---|---|
| TCI-State ::= | SEQUENCE { |
| tci-StateId | TCI-StateId, |

(ID of corresponding TCI state)

| | |
|---|---|
| qcl-Type1 | QCL-Info, |

(QCL information of first reference RS of RS (target RS) referring to corresponding TCI state ID)

| | | |
|---|---|---|
| qcl-Type2 | QCL-Info | OPTIONAL, -- Need S |

```
  (QCL information of second reference RS of RS (target RS) referring to corresponding TCI state ID)
  ...

[symbol]

```

| QCL-Info ::= | SEQUENCE { | |
|---|---|---|
| cell | ServCellIndex | OPTIONAL, [symbol] |

(serving cell index of reference RS indicated by corresponding QCL information)

| | | |
|---|---|---|
| bwp-Id | BWP-Id | OPTIONAL, [symbol] |

(BWP index of reference RS indicated by corresponding QCL information)

| | |
|---|---|
| referenceSignal | CHOICE { |
| csi-rs | NZP-CSI-RS-ResourceId, |
| ssb | SSB-Index |

(One of CSI-RS ID or SSB ID indicated by corresponding QCL information)

[symbol]

| | |
|---|---|
| qcl-Type | ENUMERATED [symbol] |

...

[symbol]

[symbol]

indicates data missing or illegible when filed

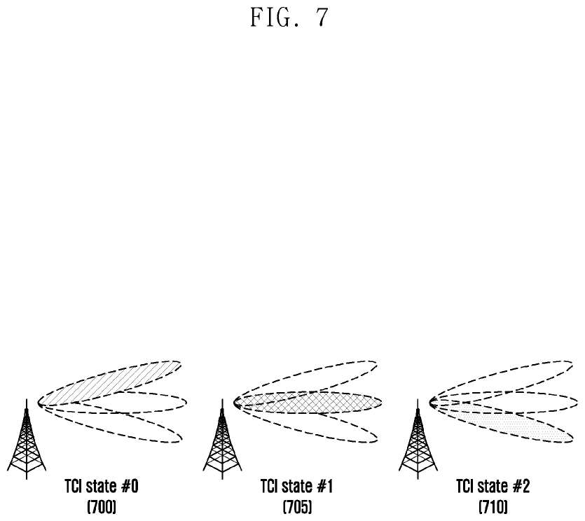

FIG. 7 is a diagram illustrating an example of beam allocation of abase station according to configuration of a TC state.

With respect to FIG. 7, the BS may transmit information about N different beams to the UE through N different TCI states. For example, in the case of N=3 as shown in FIG. 7, the BS may configure a parameter qcl-Type2 included in three TCI states 700, 705, and 710 as being associated with CSI-RSs or SSBs corresponding to different beams and as being QCL type D, thereby informing that the antenna ports with reference to the different TCI states 700, 705, and 710 are associated with different spatial Rx parameters, that is, different beams.

Tables 15-1 to 15-5 below show valid TCI state configurations according to target antenna port types.

Table 15-1 shows valid TCI state configurations in the case that the target antenna port is a CSI-RS for tracking (TRS). The TRS indicates an NZP CSI-RS in which a repetition parameter is not configured and in which trs-Info is configured as true, among the CSI-RSs. Configuration 3 in Table 15-1 may be used for aperiodic TRS.

TABLE 15-1
Valid TCI state configuration in the case that target
antenna port is CSI-RS for tracking (TRS)

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | SSB | QCL-TypeC | SSB | QCL-TypeD |
| 2 | SSB | QCL-TypeC | CSI-RS (BM) | QCL-TypeD |
| 3 | TRS | QCL-TypeA | TRS (same | QCL-TypeD |
| | (periodic) | | as DL RS 1) | |

Table 15-2 shows valid TCI state configurations in the case that the target antenna port is a CSI-RS for CSI. The CSI-RS for CSI indicates an NZP CSI-RS in which a parameter indicating repetition (e.g., a repetition parameter) is not configured and in which trs-Info is not configured as true, among the CSI-RSs.

TABLE 15-2
Valid TCI state configuration in the case
that target antenna port is CSI-RS for CSI

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | TRS | QCL-TypeA | SSB | QCL-TypeD |
| 2 | TRS | QCL-TypeA | CSI-RS for BM | QCL-TypeD |
| 3 | TRS | QCL-TypeA | TRS (same | QCL-TypeD |
| | | | as DL RS 1) | |
| 4 | TRS | QCL-TypeB | | |

Table 15-3 shows valid TCI state configurations in the case that the target antenna port is a CSI-RS for beam management (BM, the same as a CSI-RS for L1 RSRP reporting). The CSI-RS for BM indicates an NZP CSI-RS in which a repetition parameter is configured to have a value of On or Off and in which trsInfo is not configured as true, among the CSI-RS.

TABLE 15-3
Valid TCI state configuration in the case that target
antenna port is CSI-RS for BM (for L1 RSRP reporting)

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | TRS | QCL-TypeA | TRS (same | QCL-TypeD |
| | | | as DL RS 1) | |
| 2 | TRS | QCL-TypeA | CSI-RS (BM) | QCL-TypeD |
| 3 | SS/PBCH | QCL-TypeC | SS/PBCH Block | QCL-TypeD |
| | Block | | | |

Table 15-4 shows valid TCI state configurations in the case that the target antenna port is a PDCCH DMRS.

TABLE 15-4
Valid TCI state configuration in the case
that target antenna port is PDCCH DMRS

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | TRS | QCL-TypeA | TRS (same | QCL-TypeD |
| | | | as DL RS 1) | |
| 2 | TRS | QCL-TypeA | CSI-RS (BM) | QCL-TypeD |
| 3 | CSI-RS | QCL-TypeA | CSI-RS (same | QCL-TypeD |
| | (CSI) | | as DL RS 1) | |

Table 15-5 shows valid T (state configurations in the case that the target antenna port is a PDSCH DMRS.

TABLE 15-5
Valid TCI state configuration in the case
that target antenna port is PDSCH DMRS

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | CSI-RS (CSI) | QCL-TypeD |
| | (CSI) | | | |

A typical QCL configuration method according to Tables 15-1 to 15-5 is configuring the target antenna port and the reference antenna port for respective steps as “SSB”→“TRS”→“CSI-RS for CSI, CSI-RS for BM, PDCCH DMRS, or PDSCH DMRS” and operating the same. Through this, the statistical characteristics, which are measurable from the SSB and the TRS, may be associated with the respective antenna ports, thereby assisting the UE with a reception operation.

[PDCCH: In Relation to TCI State]

Specifically, combinations of TCI states applicable to the PDCCH DMRS antenna port are shown in Table 16 below. The fourth row in Table 16 is a combination assumed by the UE before RRC configuration, and is unable to be configured after RRC.

TABLE 16

| Valid TCI | | | | |
|---|---|---|---|---|
| state | | | DL RS 2 | qcl-Type2 |
| Configuration | DL RS 1 | qcl-Type1 | (if configured) | (if configured) |
| 1 | TRS | QCL-TypeA | TRS | QCL-TypeD |
| 2 | TRS | QCL-TypeA | CSI-RS (BM) | QCL-TypeD |
| 3 | CSI-RS | QCL-TypeA | | |
| | (CSI) | | | |
| 4 | SS/PBCH | QCL-TypeA | SS/PBCH | QCL-TypeD |
| | Block | | Block | |

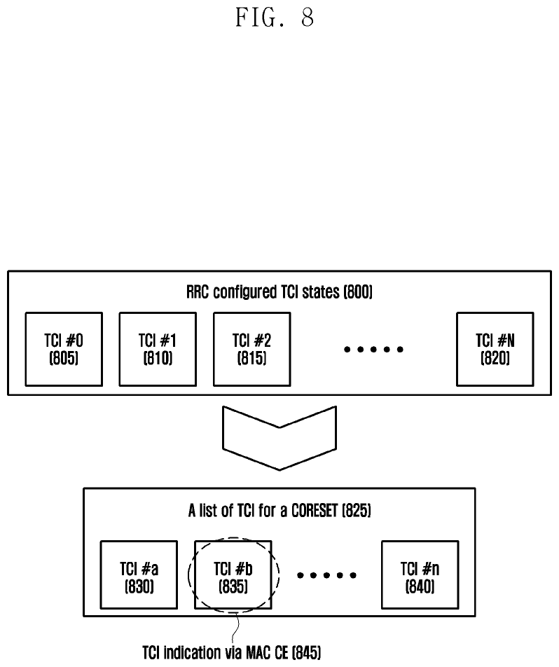

NR supports a hierarchical signaling method shown in FIG. 8 for dynamic allocation for a PDCCH beam. With reference to FIG. 8, the BS may configure N TCI states 805, 810, 815, . . . , 820 for the UE through RRC signaling 800, and some of them may be configured as TCI states for CORESET (825). Thereafter, the BS may indicate one of the TCI states 830, 835, and 840 for CORESET to the UE through MAC CE signaling (845). Thereafter, the UE receives a PDCCH, based on beam information included in the TCI state indicated by the MAC CE signaling.

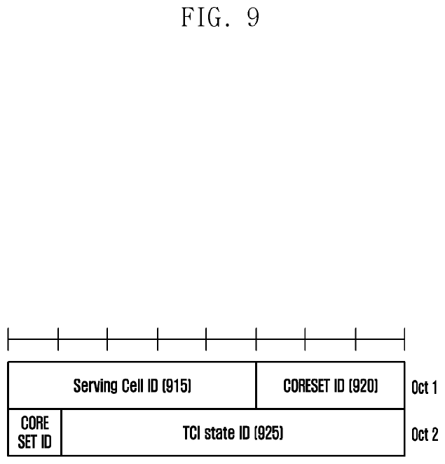

FIG. 9 is a diagram illustrating a TCI indication MAC CE signaling structure for the PDCCH DMRS. With reference to FIG. 9, TCI indication MAC CE signaling for a PDCCH DMRS is comprised of 2 bytes (16 bits) and includes a serving cell ID 915 of 5 bits, a CORESET ID 920 of 4 bits, and a TCI state ID 925 of 7 bits.

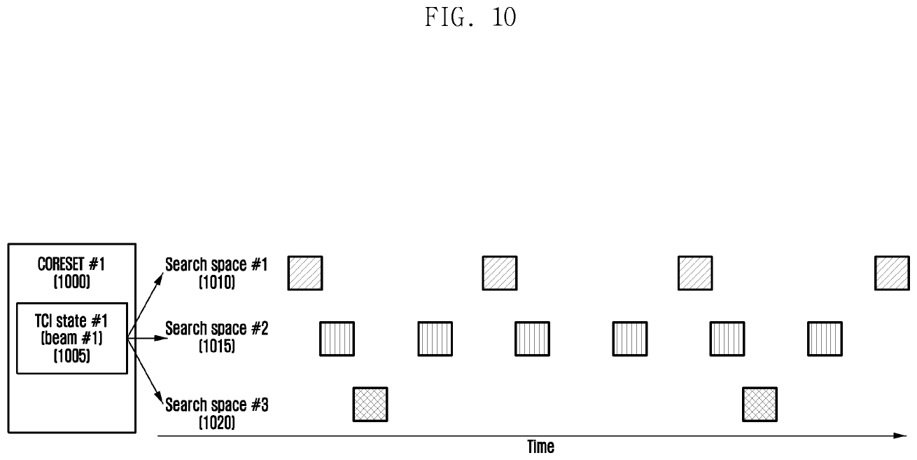

FIG. 10 is a diagram illustrating an example of a control resource set (CORESET) and beam configuration of search spaces according to the above description. With reference to FIG. 10, the BS may indicate one TCI state among the TCI state list included in the configuration of CORESET 1000 through MAC CE signaling (1005). After that, the UE considers that the same QCL information (beam #1, 1005) is applied to one or more search spaces 1010, 1015, and 1020 connected to the CORESET until another TCI state is indicated to the corresponding CORESET through another MAC CE signaling. The above-described PDCCH beam allocation method has a difficulty in indicating a beam change faster than the MAC CE signaling delay and has a disadvantage of collectively applying the same beam to all CORESETs, irrespective of search space characteristics, so it is difficult to perform a flexible operation of PDCCH beams. Hereinafter, embodiments of the disclosure provide a more flexible PDCCH beam configuration and operation method. Hereinafter, although several distinct examples will be provided to describe an example embodiment for convenience of description, these are not mutually exclusive and may be applied by appropriately combining with each other according to circumstances.

The base station may configure one or more TCI states for the UE with respect to a specific control resource set, and may activate one of the configured TCI states through a MAC CE activation command. For example, in the case where {TCI state #0, TCI state #1, TCI state #2} are configured, as TCI states, for control resource set #1, the base station may transmit, to the UE, a command for activating TCI state #0 for control resource set #1 through a MAC CE. Based on the activation command for the TCI state received through the MAC CE, the UE may correctly receive a DMRS of the corresponding control resource set, based on QCL information in the activated TCI state.

For the control resource set configured with an index 0 (control resource set #0), if the UE fails to receive a MAC CE activation command for the TCI state of control resource set #0, the UE may assume that the DMRS transmitted in control resource set #0 is QCLed with the SS/PBCH block that is identified in the initial access procedure or in the non-contention-based random access procedure that is not triggered by a PDCCH command.

For the control resource set configured with an index other than 0 (control resource set #X), if the UE fails to receive a configuration of the TCI state for control resource set #X, or if the UE receives a configuration of one or more TCI states but fails to receive a MAC CE activation command for activating one of them, the UE may assume that the DMRS transmitted in control resource set #X is QCLed with the SS/PBCH block that is identified in the initial access process.

[PDCCH: In Relation to QCL Prioritization Rule]

Hereinafter, a QCL prioritization operation for a PDCCH will be described in detail.

In the case where the UE operates as carrier aggregation in a single cell or band and where a plurality of control resource sets existing in an activated bandwidth part in a single or multiple cells has the same or different QCL-TypeD characteristics in a specific PDCCH monitoring period and overlaps in time, the UE may select a specific control resource set according to the QCL prioritization operation, and monitor control resource sets having the same QCL-TypeD characteristic as the corresponding control resource set. That is, in the case where a plurality of control resource sets overlaps in time, only one QCL-TypeD characteristic may be received. In this case, the criteria for determining the QCL priority may be as follows.
Criterion 1. The control resource set connected to a common search space having the lowest index in a cell corresponding to the lowest index, among the cells including common search spaces
Criterion 2. The control resource set connected to a UE-specific search space having the lowest index in a cell corresponding to the lowest index, among the cells including UE-specific search spaces

As described above, in the case that each of the above criteria is not met, the following criteria may be applied. For example, in the case that control resource sets overlap in time in a specific PDCCH monitoring occasion, and if all control resource sets are connected to a UE-specific search space, instead of a common search space, that is, if criterion 1 is not met, the UE may omit application of criterion 1 and apply criterion 2.

In the case of selecting control resource sets according to the above-mentioned criteria, the UE may further consider the following two items in relation to QCL information configured in the control resource set. First, in the case where control resource set 1 has CSI-RS 1 as a reference signal having a QCL-TypeD relationship, where a reference signal with which CSI-RS 1 has a QCL-TypeD relationship is SSB 1, and where a reference signal with which control resource set 2 has a QCL-TypeD relationship is SSB 1, the UE may consider that the two control resource sets 1 and 2 have different QCL-TypeD characteristics. Second, in the case where control resource set 1 has CSI-RS 1 configured in cell 1 as a reference signal having a QCL-TypeD relationship, where a reference signal with which CSI-RS 1 has a QCL-TypeD relationship is SSB 1, where control resource set 2 has CSI-RS 2 configured in cell 2 as a reference signal having a QCL-TypeD relationship, and where a reference signal with which CSI-RS 2 has a QCL-TypeD relationship is SSB 1, the UE may consider that the two control resource sets have the same QCL-TypeD characteristic.

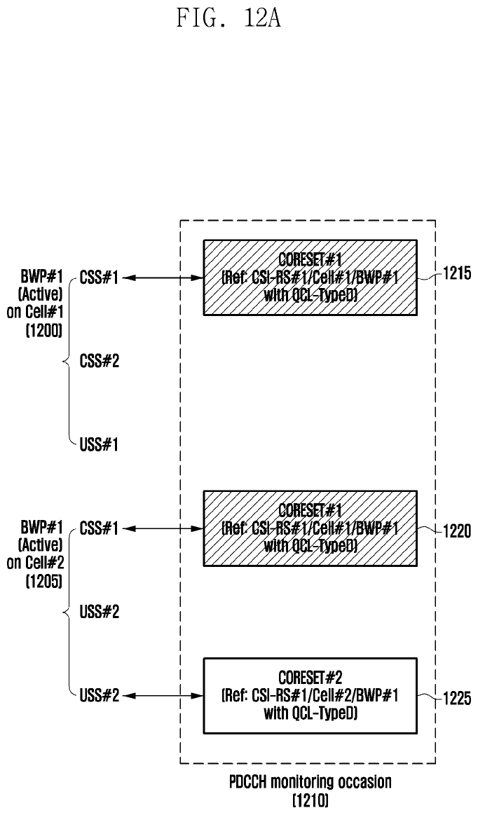

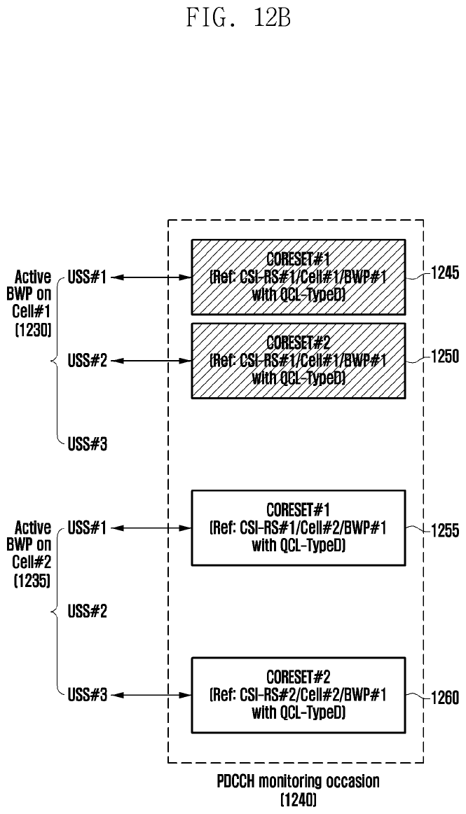

FIG. 12 is a diagram illustrating a method for a UE to select a receivable control resource set in consideration of priority when receiving a downlink control channel in a wireless communication system according to an example embodiment.

As an example, referring to FIG. 12A, the UE may be configured to receive a plurality of control resource sets overlapping in time in a specific PDCCH monitoring occasion 1210, and the plurality of control resource sets may be connected to common search spaces or UE-specific search spaces in a plurality of cells. In the corresponding PDCCH monitoring occasion, a first control resource set 1215 connected to a first common search space may exist within a first bandwidth part 1200 of a first cell, and a first control resource set 1220 connected to a first common search space and a second control resource set 1225 connected to a second UE-specific search space may exist in a first bandwidth part 1205 of a second cell. The control resource sets 1215 and 1220 may have a QCL-TypeD relationship with a first CSI-RS resource configured in the first bandwidth part of the first cell, and the control resource set 1225 may have a QCL-TypeD relationship with a first CSI-RS resource configured in the first bandwidth part of the second cell. Therefore, if criterion 1 is applied to the corresponding PDCCH monitoring occasion 1210, all other control resource sets having the same QCL-TypeD reference signal as the first control resource set 1215 may be received. Accordingly, the UE may receive the control resource sets 1215 and 1220 in the corresponding PDCCH monitoring occasion 1210.

As another example, referring to FIG. 12B, the UE may be configured to receive a plurality of control resource sets overlapping in time in a specific PDCCH monitoring occasion 1240, and the plurality of control resource sets may be connected to common search spaces or UE-specific search spaces in a plurality of cells. In the corresponding PDCCH monitoring occasion, a first control resource set 1245 connected to a first UE-specific search space and a second control resource set 1250 connected to a second UE-specific search space may exist within a first bandwidth part 1230 of a first cell, and a first control resource set 1255 connected to a first UE-specific search space and a second control resource set 1260 connected to a third UE-specific search space may exist in a first bandwidth part 1235 of a second cell. The control resource sets 1245 and 1250 may have a QCL-TypeD relationship with a first CSI-RS resource configured in the first bandwidth part of the first cell, the control resource set 1255 may have a QCL-TypeD relationship with a first CSI-RS resource configured in the first bandwidth part of the second cell, and the control resource set 1260 may have a QCL-TypeD relationship with a second CSI-RS resource configured in the first bandwidth part of the second cell. However, if criterion 1 is applied to the corresponding PDCCH monitoring occasion 1240, there is no common search space, so the next criterion 2 may be applied. If criterion 2 is applied to the corresponding PDCCH monitoring occasion 1240, all other control resource sets having the same QCL-TypeD reference signal as the control resource set 1245 may be received. Accordingly, the UE may receive the control resource sets 1245 and 1250 in the corresponding PDCCH monitoring occasion 1240.

[In Relation to Rate Matching/Puncturing]

Hereinafter, a rate matching operation and a puncturing operation will be described in detail.

In the case where time-and-frequency resources A to transmit arbitrary symbol sequences A overlaps arbitrary time-and-frequency resources B, a rate matching or puncturing operation may be considered as a transmission/reception operation of a channel A in consideration of a resource C of the area where the resources A and the resources B overlap. A detailed operation may be as follows.

Rate Matching Operation
The base station may map the channel A only to the remaining resource areas, excluding the resource C corresponding to the area overlapping the resources B, among all the resources A for transmitting the symbol sequences A to the UE, and transmit the same. For example, in the case where the symbol sequences A is comprised of {symbol #1, symbol #2, symbol #3, symbol #4}, where the resources A are {resource #1, resource #2, resource #3, resource #4}, and where the resources B are {resource #3, resource #5}, the base station may sequentially map the symbol sequences A to the remaining resources {resource #1, resource #2, resource #4}, excluding {resource #3} corresponding to the resource C, among the resources A, and transmit the same. As a result, the base station may map the symbol sequences {symbol #1, symbol #2, symbol #3} to {resource #1, resource #2, resource #4}, respectively, and transmit the same.

The UE may determine the resources A and the resources B from scheduling information for the symbol sequences A from the base station and determine the resource C, which is an area where the resources A and the resources B overlap, according thereto. The UE may receive the symbol sequences A, assuming that the symbol sequences A are mapped and transmitted in the remaining areas, excluding the resource C, among all the resources A. For example, in the case where the symbol sequences A are comprised of {symbol #1, symbol #2, symbol #3, symbol #4}, where the resources A are {resource #1, resource #2, resource #3, resource #4}, where the resources B are {resource #3, resource #5}, the UE may receive the symbol sequences A, assuming that the symbol sequences A are sequentially mapped to the remaining resources {resource #1, resource #2, resource #4}, excluding {resource #3} corresponding to the resource C, among the resources A. As a result, the UE may perform a series of subsequent reception operations, assuming that the symbol sequences {symbol #1, symbol #2, symbol #3} are mapped to the resources {resource #1, resource #2, resource #4} and transmitted.

Puncturing Operation

In the case that there is a resource C corresponding to the area overlapping the resources B, among all the resources A for transmitting the symbol sequences A to the UE, the base station may map the symbol sequences A to all the resources A and transmit only the remaining resource areas, excluding the resource C from among the resources A, instead of transmitting the resource area corresponding to the resource C. For example, in the case where the symbol sequences A are comprised of {symbol #1, symbol #2, symbol #3, symbol 4}, where the resources A are {resource #1, resource #2, resource #3, resource #4}, and where the resources B are {resource #3, resource #5}, the base station may map the symbol sequences A {symbol #1, symbol #2, symbol #3, symbol #4} to the resources A {resource #1, resource #2, resource #3, resource #4}, respectively, and transmit only the symbol sequence {symbol #1, symbol #2, symbol #4} corresponding to {resource #1, resource #2, resource #4}, which are the remaining resources excluding {resource #3} corresponding to resource C from among the resources A, instead of transmitting {symbol #3} mapped to {resource #3} corresponding to the resource C. As a result, the base station may map the symbol sequences {symbol #1, symbol #2, symbol #4} to {resource #1, resource #2, resource #4}, respectively, and transmit the same.

The UE may determine the resources A and the resources B from scheduling information for the symbol sequences A from the base station and determine the resource C, which is an area where the resources A and the resources B overlap, according thereto. The UE may receive the symbol sequence A, assuming that the symbol sequences A are mapped to all the resources A but transmitted only in the remaining areas, excluding the resource C from among the resource areas A. For example, in the case where the symbol sequences A are comprised of {symbol #1, symbol #2, symbol #3, symbol #4}, where the resources A are {resource #1, resource #2, resource #3, resource #4}, where the resources B are {resource #3, resource #5}, the UE may receive the symbol sequences A, assuming that the symbol sequences A {symbol #1, symbol #2, symbol #3, symbol #4} are mapped to the resources A {resource #1, resource #2, resource #3, resource #4}, respectively, but {symbol #3} mapped to {resource #3} corresponding to resource C is not transmitted, and assuming that the symbol sequences {symbol #1, symbol #2, symbol #4} corresponding to the remaining resources {resource #1, resource #2, resource #4}, excluding {resource #3} corresponding to the resource C from among the resources A, are mapped and transmitted. As a result, the UE may perform a series of subsequent reception operations, assuming that the symbol sequences {symbol #1, symbol #2, symbol #4} are mapped to the resources {resource #1, resource #2, resource #4}, respectively, and transmitted.

Hereinafter, a method for configuring a rate matching resource for the purpose of rate matching in a 5G communication system will be described. Rate matching indicates that the magnitude of a signal is adjusted in consideration of the number of resources capable of transmitting the signal. For example, rate matching of a data channel may indicate that the amount of data is adjusted by not mapping and transmitting a data channel for a specific time-and-frequency resource area.

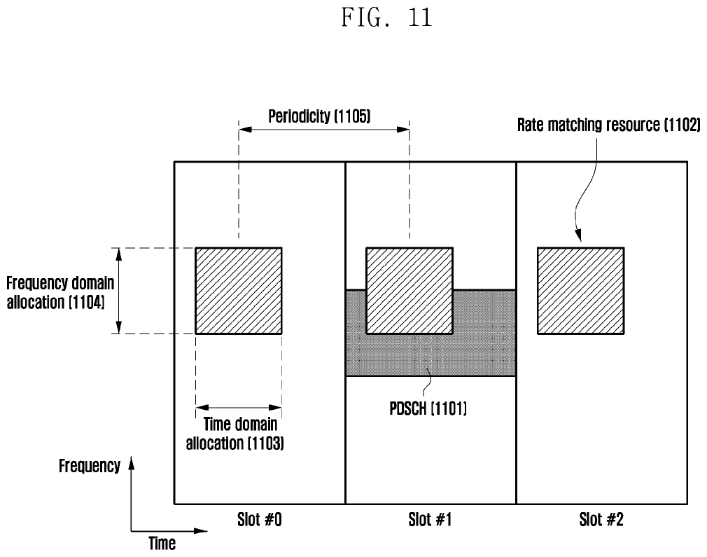

FIG. 11 is a diagram illustrating a method for a base station and a user equipment to transmit/receive data in consideration of a downlink data channel and a rate matching resource.

FIG. 11 shows a downlink data channel (PDSCH) 1101 and rate matching resources 1102. The base station may configure one or more rate matching resources 1102 for the UE through higher layer signaling (e.g., RRC signaling). Configuration information of the rate matching resource 1102 may include time domain resource allocation information 1103, frequency domain resource allocation information 1104, and periodicity information 1105. In the following description, the bitmap corresponding to the frequency domain resource allocation information 1104 will be referred to as a “first bitmap”, the bitmap corresponding to the time domain resource allocation information 1103 will be referred to as a “second bitmap”, and the bitmap corresponding to the periodicity information 1105 will be referred to as a “third bitmap”. In the case where all or some of the time and frequency resources of the scheduled data channel 1101 overlap the configured rate matching resources, the base station may rate-match the data channel 1101 in the rate matching resource 1102 part and transmit the same, and the UE may perform reception and decoding, assuming that the data channel 1101 is rate-matched in the rate matching resource 1102 part.

The base station may dynamically notify the UE through DCI of whether or not to rate-match the data channel in the configured rate matching resource part by additional configuration (this corresponds to a “rate matching indicator” in the DCI format described above). Specifically, the base station may select some of the configured rate matching resources to group them into a rate matching resource group, and indicate whether or not to rate-match the data channel for each rate matching resource group to the UE through DCI in a bitmap manner. For example, in the case where four rate matching resources, RMR #1, RMR #2, RMR #3, and RMR #4, are configured, the base station may configure RMG #1={RMR #1, RMR #2} and RMG #2={RMR #3, RMR #4} as rate matching groups and may indicate whether or not to rate-match the data channel in RMG #1 and RMG #2, respectively, to the UE through a bitmap using 2 bits in the DCI field. For example, the case that requires rate-matching may be indicated as 1, and the case that does not require rate-matching may be indicated as 0.

5G supports the granularity of an “RB symbol level” and an “RE level” as a method for configuring the above-described rate matching resources for the UE. More specifically, the following configuration method may be provided.

RB Symbol Level

The UE may receive a configuration of up to four RateMatchPatterns for each bandwidth part through higher layer signaling, and one RateMatchPattern may include the following.
As a reserved resource within the bandwidth part, a resource in which a time and frequency resource area of the corresponding reserved resource is configured by a combination of a bitmap of an RB level and a bitmap of a symbol level in the frequency domain may be included. The reserved resource may have a span corresponding to one or two slots. A time domain pattern (periodicityAndPattern) in which time and frequency domains comprised of a pair of RB level and symbol level bitmaps are repeated may be further configured.
A time and frequency domain resource area configured as a control resource set in the bandwidth part and a resource area corresponding to a time domain pattern configured as the corresponding resource areas repeated by a search space may be included.

RE Level

The UE may receive configurations below through higher layer signaling.
As configuration information (lte-CRS-ToMatchAround) for an RE corresponding to an LTE CRS (cell-specific reference signal or common reference signal) pattern, the number of LTE CRS ports (nrofCRS-Ports), an LTE-CRS-vshift(s) value (v-shift), center subcarrier location information (carrierFreqDL) of an LTE carrier from a reference frequency point (e.g., reference point A), information on the bandwidth size of an LTE carrier (carrierBandwidthDL), subframe configuration information (mbsfn-SubframConfigList) corresponding to a multicast-broadcast single-frequency network (MBSFN), and the like may be included. The UE may determine the location of the CRS in the NR slot corresponding to an LTE subframe, based on the above-described information.
Configuration information on a resource set corresponding to one or more ZP (Zero Power) CSI-RS within the bandwidth part may be included.

[In Relation to LTE CRS Rate Match]

Next, the rate matching process for the above-described LTE CRS will be described in detail. For the coexistence of LTE (Long-Term Evolution) and NR (New RAT), NR may configure an NR UE with a function of configuring a CRS (cell-specific reference signal) pattern of LTE. More specifically, the CRS pattern may be provided by RRC signaling including at least one parameter in “ServingCellConfig” IE (information element) or “ServingCellConfigCommon” IE. Examples of the parameter may include “lte-CRS-ToMatchAround”, “lte-CRS-PatternList1-r16”, “lte-CRS-PatternList2-r16”, “crs-RateMatch-PerCORESETPoolIndex-r16”, and the like.

In Rel-15 NR, one CRS pattern may be configured in each serving cell through the parameter lte-CRS-ToMatchAround. In Rel-16 NR, the function has been extended to enable configuring of a plurality of CRS patterns for each serving cell. More specifically, one CRS pattern per one LTE carrier may be configured in a single-TRP (transmission and reception point)-configured UE, and two CRS patterns per one LTE carrier may be configured in a multi-TRP-configured UE. For example, it is possible to configure up to three CRS patterns per serving cell in the single-TRP-configured UE through the parameter lte-CRS-PatternList1-r16. As another example, a CRS may be configured for each TRP in the multi-TRP-configured UE. That is, a CRS pattern for TRP1 may be configured through a parameter lte-CRS-PatternList1-r16, and a CRS pattern for TRP2 may be configured through a parameter lte-CRS-PatternList2-r16. Meanwhile, in the case where two TRPs are configured as described above, whether or not to apply both the CRS patterns of TRP1 and TRP2 to a specific PDSCH or whether or not to apply only the CRS pattern for one TRP thereto is determined through a parameter crs-RateMatch-PerCORESETPoolIndex-r16, and if the parameter crs-RateMatch-PerCORESETPoolIndex-r16 is configured to be enabled, the CRS pattern for only one TRP is applied, otherwise, the CRS patterns for both TRPs are applied.

Table 17 shows a ServingCellConfig IE including the CRS pattern, and Table 18 shows a RateMatchPatternLTE-CRS IE including at least one parameter for the CRS pattern.

TABLE 17

| | |
|---|---|
| ServingCellConfig ::= | SEQUENCE { |
| tdd-UL-DL-ConfigurationDedicated | TDD-UL-DL-ConfigDedicated |

| | |
|---|---|
| OPTIONAL, | -- Cond TDD |

| | |
|---|---|
| initialDownlinkBWP | BWP-DownlinkDedicated |

| | |
|---|---|
| OPTIONAL, | -- Need M |

| | |
|---|---|
| downlinkBWP-ToReleaseList | SEQUENCE (SIZE (1..maxNrofBWPs)) OF BWP-Id |

| | |
|---|---|
| OPTIONAL, | -- Need N |

| | |
|---|---|
| downlinkBWP-ToAddModList | SEQUENCE (SIZE (1..maxNrofBWPs)) OF BNP-Downlink |

| | |
|---|---|
| OPTIONAL, | -- Need N |

| | |
|---|---|
| firstActiveDownlinkBWP-Id | BWP-Id |

| | |
|---|---|
| OPTIONAL, | -- Cond SyncAndCellAdd |

| | |
|---|---|
| bwp-InactivityTimer | ENUMERATED {ms2, ms3, ms4, ms5, ms6, ms8, ms10, ms20, ms30, |
| | ms40,ms50, ms60, ms80,ms100, ms200,ms300, ms500, |
| | ms750, ms1280, ms1920, ms2560, spare10, spare9, |

spare8,

spare7, spare6, spare5, spare4, spare3, spare2,

| | | |
|---|---|---|
| spare1 } | OPTIONAL, | --Need R |

| | |
|---|---|
| defaultDownlinkBP-Id | BWP-Id |

| | |
|---|---|
| OPTIONAL, | -- Need S |

| | |
|---|---|
| uplinkConfig | UplinkConfig |

| | |
|---|---|
| OPTIONAL, | -- Need M |

| | |
|---|---|
| supplementaryUplink | UplinkConfig |

| | |
|---|---|
| OPTIONAL, | -- Need M |

| | |
|---|---|
| pdcch-ServingCellConfig | SetupRelease { PDCCH-ServingCellConfig } |

| | |
|---|---|
| OPTIONAL, | -- Need M |

| | |
|---|---|
| pdsch-ServingCellConfig | SetupRelease { PDSCH-ServingCellConfig } |

| | |
|---|---|
| OPTIONAL, | -- Need M |

| | |
|---|---|
| csi-MeasConfig | SetupRelease { CSI-MeasConfig } |

| | |
|---|---|
| OPTIONAL, | -- Need M |

| | |
|---|---|
| sCellDeactivationTimer | ENUMERATED {ms20, ms40, ms80, ms160, ms200, ms240, |
| | ms320, ms400, ms480, ms520, ms640, ms720, |
| | ms840, ms1280, spare2, spare1} OPTIONAL, -- |

Cond ServingCellWithoutPUCCH

| | |
|---|---|
| crossCarrierSchedulingConfig | CrossCarrierSchedulingConfig |

| | |
|---|---|
| OPTIONAL, | -- Need M |

| | |
|---|---|
| tag-Id | TAG-Id, |
| dummy | ENUMERATED {enabled} |

| | |
|---|---|
| OPTIONAL, | -- Need R |

| | |
|---|---|
| pathlossReferenceLinking | ENUMERATED {spCell, sCell} |

| | |
|---|---|
| OPTIONAL, | -- Cond SCellOnly |

| | |
|---|---|
| servingCellMO | MeasObjectId |

| | |
|---|---|
| OPTIONAL, | -- Cond MeasObject |

```
    ...,
    [[
```

| | |
|---|---|
| lte-CRS-ToMatchAround | SetupRelease { RateMatchPatternLTE-CRS } |

| | |
|---|---|
| OPTIONAL, | -- Need M |

| rateMatchPatternToAddModList | | SEQUENCE (SIZE (1..maxNrofRateMatchPatterns)) OF |
|---|---|---|
| RateMatchPattern | OPTIONAL, | -- Need N |
| rateMatchPatternToReleaseList | | SEQUENCE (SIZE (1..maxNrofRateMatchPatterns)) OF |
| RateMatchPatternId | OPTIONAL, | -- Need N |

| | |
|---|---|
| downlinkChannelBW-PerSCS-List | SEQUENCE (SIZE (1..maxSCSs)) OF SCS-SpecificCarrier |

| | |
|---|---|
| OPTIONAL | -- Need S |

```
    ]],
    [[
```

| | |
|---|---|
| supplementaryUplinkRelease | ENUMERATED {true} |

| | |
|---|---|
| OPTIONAL, | -- Need N |

| | |
|---|---|
| tdd-UL-DL-ConfigurationDedicated-IAB-MT-r16 | TDD-UL-DL-ConfigDedicated-IAB-MT-r16 |

| | |
|---|---|
| OPTIONAL, | -- Cord TDD_IAB |

| | |
|---|---|
| dormantBWP-Config-r16 | SetupRelease { DormantBWP-Config-r16 } |

| | |
|---|---|
| OPTIONAL, | -- Need M |

| | |
|---|---|
| ca-SlotOffset-r16 | CHOICE { |
| refSCS15kHz | INTEGER (−2..2), |
| refSCS30KHz | INTEGER (−5..5), |
| refSCS60KHz | INTEGER (−10..10), |
| refSCS120KHz | INTEGER (−20..20) |

}

| | |
|---|---|
| OPTIONAL, | -- Cond AsyncCA |

| | |
|---|---|
| channelAccessConfig-r16 | SetupRelease { ChannelAccessConfig-r16 } |

| | |
|---|---|
| OPTIONAL, | -- Need M |

| | |
|---|---|
| intraCellGuardBandsDL-List-r16 | SEQUENCE (SIZE (1..maxSCSs)) OF |
| IntraCellGuardBandsPerSCS-r16 | OPTIONAL, -- Need S |
| intraCellGuardBandsUL-List-r16 | SEQUENCE (SIZE (1..maxSCSs)) OF |
| IntraCellGuardBandsPerSCS-r16 | OPTIONAL, -- Need S |
| csi-RS-ValidationWith-DCI-r16 | ENUMERATED {enabled} |

| | |
|---|---|
| OPTIONAL, | -- Need R |

| | |
|---|---|
| lte-CRS-PatternList1-r16 | SetupRelease { LTE-CRS-PatternList-r16 } |

| | |
|---|---|
| OPTIONAL, | -- Need M |

| | |
|---|---|
| lte-CRS-PatternList2-r16 | SetupRelease { LTE-CRS-PatternList-r16 } |

| | |
|---|---|
| OPTIONAL, | -- Need M |

crs-RateMatch-PerCORESETPoolIndex-r16 ENUMERATED {enabled}

| | |
|---|---|
| OPTIONAL, | -- Need R |

| | |
|---|---|
| enableTwoDefaultTCI-States-r16 | ENUMERATED {enabled} |

| | |
|---|---|
| OPTIONAL, | -- Need R |

| | |
|---|---|
| enableDefaultICI-StatePerCoresetPoolIndex-r16 | ENUMERATED {enabled} |

| | |
|---|---|
| OPTIONAL, | -- Need R |

| | |
|---|---|
| enableBeamSwitchTiming-r16 | ENUMERATED {true} |

| | |
|---|---|
| OPTIONAL, | -- Need R |

| | |
|---|---|
| cbg-TxDiffTBsProcessingType1-r16 | ENUMERATED {enabled} |

| | |
|---|---|
| OPTIONAL, | -- Need R |

| | |
|---|---|
| cbg-TxDiffTBsProcessingType2-r16 | ENUMERATED {enabled} |

| | |
|---|---|
| OPTIONAL | -- Need R |

```
      ]]
  }
```

```
TABLE 18
    - RateMatchPatternLTE-CRS
The IE RateMatchPatternLTE-CRS is used to configure a pattern to rate match
around LTE CRS. See TS 38.214 [19], clause 5.1.4.2.
      RateMatchPatternLTE-CRS information element
-- ASN1START
-- TAG-RATEMATCHPATTERNLTE-CRS-START
```

| | |
|---|---|
| RateMatchPatternLTE-CRS ::= | SEQUENCE { |
| carrierFreqDL | INTEGER (0..16383), |
| carrierBandwidthDL | ENUMERATED {n6, n15, n25, n50, n75, n100, spare2, spare1}, |
| mbsfn-SubframeConfigList | EUTRA-MBSFN-SubframeConfigList |

OPTIONAL, -- Need M

| | |
|---|---|
| nrofCRS-Ports | ENUMERATED {n1, n2, n4}, |
| v-Shift | ENUMERATED {n0, n1, n2, n3, n4, n5} |

}

| | |
|---|---|
| LTE-CRS-PatternList-r16 ::= | SEQUENCE (SIZE (1..maxLTE-CRS-Patterns-r16)) OF |
| RateMatchPatternLTE-CRS | |

-- TAG-RATEMATCHPATTERNLTE-CRS-STOP
-- ASN1STOP
RateMatchPatternLTE-CRS field descriptions
carrierBandwidthDL
BW of the LTE carrier in number of PRBs (see TS 38.214 [19], clause 5.1.4.2).
carrierFreqDL
Center of the LTE carrier (see TS 38.214 [19], clause 5.1.4.2).
mbsfn-SubframeConfigList
LTE MBSFN subframe configuration (see TS 38.214 [19], clause 5.1.4.2).
nrofCRS-Ports
Number of LTE CRS antenna portto rate-match around (see TS 38.214 [19], clause 5.1.4.2).
v-Shift
Shifting value v-shift in LTE to rate match around LTE CRS (see TS 38.214 [19], clause 5.1.4.2).

[PDSCH: In Relation to Frequency Resource Allocation]

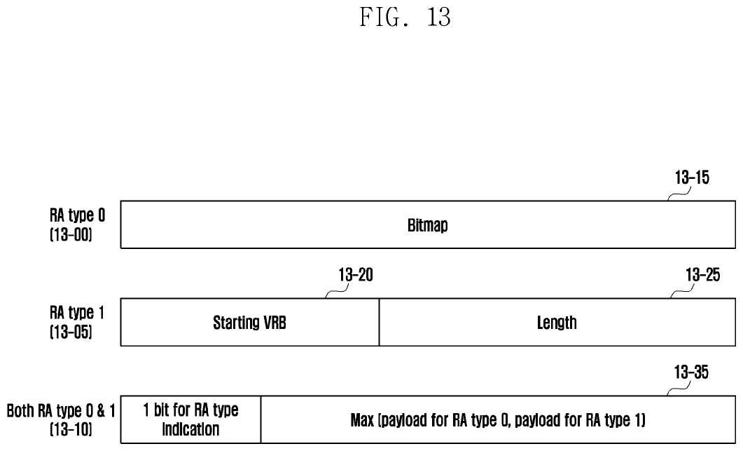

FIG. 13 is a diagram illustrating an example of allocating resources on a frequency domain of a PDSCH in a wireless communication system according to an example embodiment.

FIG. 13 is a diagram showing three frequency domain resource assignment methods of type 0(13-00), type 1(13-05), and dynamic switch (13-10) that may be configured through a higher layer in an NR wireless communication system.

With reference to FIG. 13, in the case where the UE is configured to use only resource type 0 through higher layer signaling 13-00, some downlink control information (DCI) for allocating a PDSCH to the UE includes a bitmap of NRBG bits. The conditions for this will be described later. In this case, NRBG indicates the number of RBGs (resource block groups) determined as shown in Table 19 below according to a BWP size allocated by a BWP indicator and a higher layer parameter rbg-Size, and data is transmitted in the RBG indicated as 1 by a bitmap.

TABLE 19

| Bandwidth Part Size | Configuration 1 | Configuration 2 |
|---|---|---|
| 1-36 | 2 | 4 |
| 37-72 | 4 | 8 |
| 73-144 | 8 | 16 |
| 145-275 | 16 | 16 |

In the case where the UE is configured to use only resource type 1 through higher layer signaling 13-05, some DC for allocating a PDSCH to the UE includes frequency domain resource assignment information of ┌log 2(N_{RB}^{DL,BWP}(N_{RB}^{DL,BWP}+1)/2┐ bits. The conditions for this will be described later. The base station may configure a starting VRB 13-20 according thereto and the length 13-25 of a frequency domain resource assignment subsequent thereto.

In the case where the UE is configured to use both resource type 0 and resource type 1 through higher layer signaling 13-10, some DCI for allocating a PDSCH to the UE includes frequency domain resource assignment information of bits corresponding to a larger value 13-35 of a payload 13-15 for configuring resource type 0 and payloads 13-20 and 13-25 for configuring resource type 1. The conditions for this will be described later. In this case, one bit may be added to the foremost part (MSB) of the frequency domain resource assignment information in DCI, and in the case where the bit has a value 0, it may indicate that resource type 0 is used, and in the case where the bit has a value 1, it may indicate that resource type 1 is used.

[PDSCH/PUSCH: In Relation to Time Resource Allocation]

A time domain resource assignment method for a data channel in a next-generation mobile communication system (5G or NR system) will be described below.

The base station may configure time domain resource allocation information (e.g., a form of a table) on a downlink data channel (PDSCH) and an uplink data channel (PUSCH) for the UE using higher layer signaling (e.g., RRC signaling). Time domain resource allocation information (or a resource allocation table) constituted as up to maxNrofDL-Allocations=16 entries may be configured for a PDSCH, and time domain resource allocation information (or a resource allocation table) constituted as up to maxNrofUL-Allocations=16 entries may be configured for a PUSCH. In an embodiment, the time domain resource allocation information may include PDCCH-to-PDSCH slot timing (corresponding to the time interval in slot units between the time at which a PDCCH is received and the time at which a PDSCH scheduled by the received PDCCH is transmitted, and denoted by K0), PDCCH-to-PUSCH slot timing (corresponding to the time interval in slot units between the time at which a PDCCH is received and the time at which a PUSCH scheduled by the received PDCCH is transmitted, and denoted by K2), information about the position and length of a start symbol in which the PDSCH or PUSCH is scheduled in the slot, a mapping type of a PDSCH or PUSCH, and the like. For example, information shown in Table 20 or Table 21 below may be transmitted from the base station to the UE.

TABLE 20
PDSCH-TimeDomainResourceAllocationListinformation element

| | |
|---|---|
| PDSCH-TimeDomainResourceAllocationList ::= | SEQUENCE |

(SIZE(1..maxNrofDL-Allocations)) OF PDSCH-TimeDomainResourceAllocation

| | |
|---|---|
| PDSCH-TimeDomainResourceAllocation ::= | SEQUENCE { |
| k0 | INTEGER(0..32) |

OPTIONAL, -- Need S
(PDCCH-to-PDSCH timing, slot unit)

| | |
|---|---|
| mappingType | ENUMERATED {typeA, typeB}, |

(PDSCH mapping type)

| | |
|---|---|
| startSymbolAndLength | INTEGER(0..127) |

```
  (PDSCH start symbol and length)
  }
```

TABLE 21
PUSCH-TimeDomainResourceAllocation information element

| | |
|---|---|
| PUSCH-TimeDomainResourceAllocationList ::= | SEQUENCE |

(SIZE(1..maxNrofUL-Allocations)) OF PUSCH-TimeDomainResourceAllocation

| | |
|---|---|
| PUSCH-TimeDomainResourceAllocation ::= | SEQUENCE { |
| k2 | INTEGER(0..32) OPTIONAL, -- Need S |

(PDCCH-to-PUSCH timing, slot unit)

| | |
|---|---|
| mappingType | ENUMERATED {typeA, typeB}, |

(PUSCH mapping type)

| | |
|---|---|
| startSymbolAndLength | INTEGER(0..127) |

```
    (PUSCH start symbol and length)
  }
```

The base station may notify the UE of one of the entries in the table for the time domain resource allocation information described above through L1 signaling (e.g., DCI) (for example, it may be indicated by a time domain resource allocation field in DCI). The UE may obtain time domain resource allocation information for the PDSCH or PUSCH, based on the DCI received from the base station.

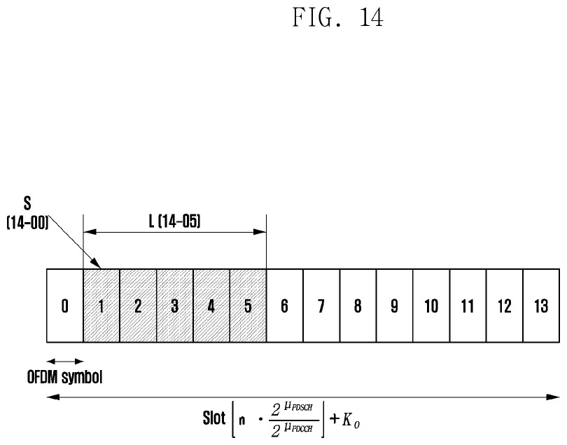

FIG. 14 is a diagram illustrating an example of time domain resource allocation of a PDSCH in a wireless communication system according to an example embodiment.

With reference to FIG. 14, the base station may indicate the time domain location of a PDSCH resource according to the subcarrier spacing (SCS) (μ_{PDSCH}, μ_{PDCCH}) of a data channel and a control channel configured using a higher layer, a scheduling offset value (K0), a starting position 14-00 of OFDM symbols within one slot dynamically indicated through DCI, and the length 14-05 thereof.

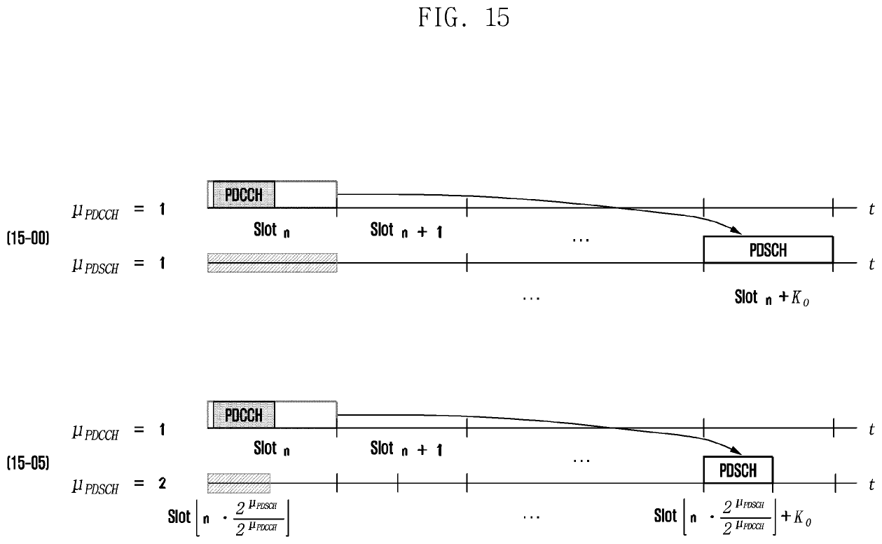

FIG. 15 is a diagram illustrating an example of time domain resource allocation depending on subcarrier spacing of a data channel and a control channel in a wireless communication system according to an example embodiment.

With reference to FIG. 15, in the case where the subcarrier spacing of the data channel is the same as the subcarrier spacing of the control channel 15-00 (μ_{PDSCH}, μ_{PDCCH}), the slot numbers for the data and the control are the same, so the base station and the UE may produce a scheduling offset according to a predetermined slot offset K0. On the other hand, in the case where the subcarrier spacing of the data channel is different from the subcarrier spacing of the control channel 15-05 (μ_{PDSCH}≠μ_{PDCCH}), the slot numbers for the data and the control are different from each other, so the base station and the UE may produce a scheduling offset according to a predetermined slot offset K0, based on the subcarrier spacing of the PDCCH.

[PDSCH: Processing Procedure Time]

Next, a PDSCH processing procedure time will be described. In the case where the base station performs scheduling to transmit a PDSCH using DCI format 1_0, 1_1, or 1_2, to the UE, the UE may require a PDSCH processing procedure time to receive the PDSCH by applying a transmission method indicated through DCI (modulation/demodulation and coding indication index (MCS), demodulation reference signal-related information, time-and-frequency resource allocation information, etc.). In NR, a PDSCH processing procedure time is defined in consideration thereof. The PDSCH processing procedure time of the UE may follow Equation 3 below.

T_{proc,1}=(N₁+d_{1,1}+d₂)(2048+144)K2^{-μ}T_{c}+Tₑₓₜ [Equation 3]

Variables in T_{proc,1} described by Equation 3 may have the following definitions.
N₁: The number of symbols determined according to UE processing capability 1 or 2 according to the UE capability and numerology p. This may have the values shown in Table 22 in the case where UE processing capability 1 is reported according to the capability report of the UE, and may have the values shown in Table 23 in the case where UE processing capability 2 is reported and where UE processing capability 2 is configured to be available through higher layer signaling. Numerology μ may correspond to a minimum value among μ_{PDCCH}, μ_{PDSCH}. and μ_{UL} so as to maximize the T_{proc,1}, and μ_{PDCCH}, μ_{PDSCH}, and μ_{UL} may indicate numerology of a PDCCH scheduling a PDSCH, numerology of the scheduled PDSCH, and numerology of an uplink channel through which HARQ-ACK is to be transmitted, respectively.

TABLE 22
PDSCH processing time in case of PDSCH processing capability 1

| | PDSCH decoding time N₃ [symbols] | |
|---|---|---|
| | | In case of dmrs-AdditionalPosition ≠ |
| | In case of dmrs-AdditionalPosition = | pos0 in DMRS-DownlinkConfig, which |
| | pos0 in DMRS-DownlinkConfig, which | is higher layer signaling for both PDSCH |
| | is higher layer signaling for both | mapping types A and B, or in case where |
| μ | PDSCH mapping types A and B | higher layer parameter is not configured |
| 0 | 8 | N_{1, 0} |
| 1 | 10 | 13 |
| 2 | 17 | 20 |
| 3 | 20 | 24 |

TABLE 23
PDSCH processing time in case of PDSCH processing capability 2

| | PDSCH decoding time N₁ [symbols] |
|---|---|
| | In case of dmrs-AdditionalPosition = pos0 |
| | in DMRS-DownlinkConfig, which is higher layer |
| μ | signaling for both PDSCH mapping typed A and B |
| 0 | 3 |
| 1 | 4.5 |
| 2 | 9 for frequency range 1 |

κ: 64
Tₜₑₓₜ: In the case where the UE uses a shared spectrum channel access method, the UE may calculate Tₑₓₜ and apply the same to the PDSCH processing procedure time. Otherwise, Tₑₓₜ is assumed to be 0.
If 1₁ indicating the PDSCH DMRS position value is 12, N_{1,0} in Table 22 has a value of 14, otherwise it has a value of 13.
For the PDSCH mapping type A, if the last symbol of the PDSCH is the ith symbol in the slot in which the PDSCH is transmitted, and if i<7, d_{1,1} is 7−i, otherwise d_{1,1} is 0.
d₂: In the case where the PUCCH having a high priority index and the PUCCH or PUSCH having a low priority index overlap in time, d₂ of the PUCCH having a high priority index may be configured as a value reported by the UE. Otherwise, d₂ is 0.
In the case where the PDSCH mapping type B is used for UE processing capability 1, the value d_{1,1} may be determined according to L indicating the number of symbols of the scheduled PDSCH, and d indicating the number of overlapping symbols between the PDCCH scheduling the PDSCH and the scheduled PDSCH as follows.

If L≥7,d_{1,1}=0.

If L≥4 and if L≤6,d_{1,1}=7−L.

If L=3,d_{1,1}=min(d,1).

If L=2,d_{1,1}=3+d.
In the case where the PDSCH mapping type B is used for UE processing capability 2, the value d_{1,1} may be determined according to L indicating the number of symbols of the scheduled PDSCH, and d indicating the number of overlapping symbols between the PDCCH scheduling the PDSCH and the scheduled PDSCH as follows.

If L≥7,d_{1,1}=0.

If L≥4 and if L≤6,d_{1,1}=7−L.
In the case of L=2,
In the case where the scheduling PDCCH exists in a CORESET comprised of three symbols, and where the corresponding CORESET and the scheduled PDSCH have the same start symbol, d_{1,1}=3.
Otherwise, d_{1,1}=d.
In the case of a UE supporting capability 2 in a given serving cell, the PDSCH processing procedure time according to UE processing capability 2 may be applied in the case that processingType2 Enabled of the UE, which is higher layer signaling, is configured to be enable for the cell.

If the position of a first uplink transmission symbol of a PUCCH including HARQ-ACK information (this position may consider K₁, which is defined as a transmission time of HARQ-ACK, a PUCCH resource used for HARQ-ACK transmission, and a timing advance effect) is not earlier than a first uplink transmission symbol after a time of T_{proc,1} from the last symbol of the PDSCH, the UE must transmit a valid HARQ-ACK message. That is, the UE must transmit the PUCCH including the HARQ-ACK only in the case where the PDSCH processing procedure time is sufficient. Otherwise, the UE is unable to provide the base station with valid HARQ-ACK information corresponding to the scheduled PDSCH. The T_{proc,1} may be used for both normal and extended CPs. In the case of a PDSCH comprised of two PDSCH transmission positions in one slot, d_{1,1} is calculated based on the first PDSCH transmission position in the corresponding slot.

[PDSCH: Reception Preparation Time for Cross-Carrier Scheduling]

The following will describe a PDSCH reception preparation time, N_{pdsch}, of a UE in which the time interval between a PDCCH and a PDSCH is defined in the case where the cross-carrier scheduling of the numerology μ_{PDCCH} for transmitting a scheduling PDCCH is different from the cross-carrier scheduling of the numerology μ_{PDSCH} for transmitting a PDSCH scheduled through the corresponding PDCCH.

In the case of μ_{PDCCH}<μ_{PDSCH}, the scheduled PDSCH cannot be transmitted earlier than a first symbol of a slot appearing after N_{pdsch} symbols from the last symbol of the PDCCH having scheduled the PDSCH. A transmission symbol of the corresponding PDSCH may include a DM-RS.

In the case of μ_{PDCCH}>μ_{PDSCH}, the scheduled PDSCH may be transmitted after N_{pdsch} symbols from the last symbol of the PDCCH having scheduled the PDSCH. A transmission symbol of the corresponding PDSCH may include a DM-RS.

TABLE 24
N_{pdsch} according to scheduled PDCCH subcarrier spacing

| μ_{PDCCH} | N_{pdsch} [symbols] |
|---|---|
| 0 | 4 |
| 1 | 5 |
| 2 | 10 |
| 3 | 14 |

[PDSCH: TCI State Activation MAC-CE]

Next, a beam configuration method for a PDSCH will be described.

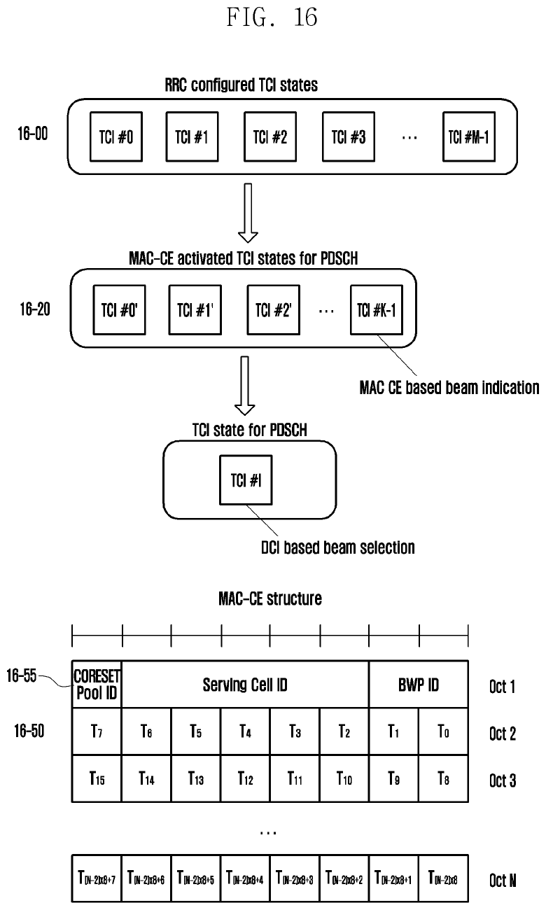

FIG. 16 illustrates a procedure for beam configuration and activation of a PDSCH. A list of TCI states for a PDSCH may be indicated through a higher layer list such as RRC or the like 16-00. The list of TCI states may be indicated by, for example, tci-StatesToAddModList and/or tci-StatesToReleaseList in a PDSCH-Config IE for each BWP. Next, some of the TCI states in the list may be activated through a MAC-CE 16-20. The maximum number of activated TCI states may be determined according to the capability reported by the UE. Reference numeral 16-50 shows an example of a MAC-CE structure for PDSCH TCI state activation/deactivation.

Definitions of respective fields in the MAC-CE and available values for respective fields are as follows.

Serving Cell ID: This field indicates the identity of the Serving Cell for which the MAC CE
applies. The length of the field is 5 bits. If the indicated Serving Cell is configured as part of a
simultaneousTCI-UpdateList1 or simultaneousTCI-UpdateList2 as specified in TS 38.331 [5], this MAC CE
applies to all the Serving Cells configured in the set simultaneousTCI-UpdateList1 or
simultaneousTCI-UpdateList2 respectively;
BWP ID: This field indicates a DL BWP for which the MAC CE applies as the
codepoint of the DCI bandwidth part indicator field as specified in TS 38.212 [9]. The length of the BWP ID
field is 2 bits. This field is ignored if this MAC CE applies to a set of Serving Cells;
Ti: If there is a TCI state with TCI-StateId i as specified in TS 38.331 [5], this field
indicates the activation/deactivation status of the TCI state with TCI-StateId i, otherwise MAC entity shall
ignore the Ti field. The Ti field is set to 1 to indicate that the TCI state with TCI-StateId i shall be activated
and mapped to the codepoint of the DCI Transmission Configuration Indication field, as specified in TS
38.214 [7]. The Ti field is set to 0 to indicate that the TCI state with TCI-StateId i shall be deactivated and is
not mapped to the codepoint of the DCI Transmission Configuration Indication field. The codepoint to which
the TCI State is mapped is determined by its ordinal position among all the TCI States with Ti field set to 1,
i.e. the first TCI State with Ti field set to 1 shall be mapped to the codepoint value 0, second TCI State with
Ti field set to 1 shall be mapped to the codepoint value 1 and so on. The maximum number of activated TCI
states is 8;
CORESET Pool ID: This field indicates that mapping between the activated
TCI states and the codepoint of the DCI Transmission Configuration Indication set by field Ti is specific to
the ControlResourceSetId configured with CORESET Pool ID as specified in TS 38.331 [5]. This field set to
1 indicates that this MAC CE shall be applied for the DL transmission scheduled by CORESET with the
CORESET pool ID equal to 1, otherwise, this MAC CE shall be applied for the DL transmission scheduled
by CORESET pool ID equal to 0. If the coresetPoolIndex is not configured for any CORESET, MAC entity
shall ignore the CORESET Pool ID field in this MAC CE when receiving the MAC CE. If the Serving Cell in
the MAC CE is configured in a cell list that contains more than one Serving Cell, the CORESET Pool ID field
shall be ignored when receiving the MAC CE.

[In Relation to SRS]

Next, an uplink channel estimation method using sounding reference signal (SRS) transmission of the UE will be described. The base station may configure at least one SRS configuration for each uplink BWP in order to transmit configuration information for transmitting an SRS to the UE, and also configure at least one SRS resource set for each SRS configuration. For example, the base station and the UE may exchange higher layer signaling information below in order to transmit information for the SRS resource set.
srs-ResourceSetId: SRS resource set index
srs-ResourceIdList: a set of SRS resource indexes referenced in the SRS resource set
resourceType: This is a time domain transmission configuration of the SRS resource referenced in the SRS resource set, and may be configured as one of periodic, semi-persistent, and aperiodic. In the case where it is configured as periodic or semi-persistent, associated CSI-RS information may be provided depending on the usage of the SRS resource set. In the case where it is configured as aperiodic, an aperiodic SRS resource trigger list and slot offset information may be provided, and associated CSI-RS information may be provided depending on the usage of the SRS resource set.
usage: This is configuration for the usage of the SRS resource referenced in the SRS resource set, and may be configured as one of beamManagement, codebook, nonCodebook, and antennaSwitching.
alpha, p0, pathlossReferenceRS, srs-PowerControlAdjustmentStates: These provide parameter configurations for adjusting the transmission power of the SRS resource referenced in the SRS resource set.

The UE may understand that the SRS resources included in a set of SRS resource indexes referenced in the SRS resource set follow the information configured in the SRS resource set.

In addition, the base station and the UE may transmit and receive higher layer signaling information to transmit individual configuration information for the SRS resources. For example, the individual configuration information for the SRS resources may include time-frequency domain mapping information in the slot of the SRS resource, which may include information about intra-slot or inter-slot frequency hopping of the SRS resource. In addition, the individual configuration information of the SRS resource may include a time domain transmission configuration of the SRS resource, and may be configured as one of periodic, semi-persistent, and aperiodic. This may be limited to have the same time domain transmission configuration as the SRS resource set including the SRS resource. In the case where the time domain transmission configuration of the SRS resource is configured as periodic or semi-persistent, an SRS resource transmission period and a slot offset (e.g., periodicityAndOffset) may be further included in the time domain transmission configuration.

The base station may activate, deactivate, or trigger SRS transmission to the UE through higher layer signaling including RRC signaling or MAC CE signaling, or L1 signaling (e.g., DCI). For example, the base station may activate or deactivate periodic SRS transmission to the UE through higher layer signaling. The base station may instruct to activate an SRS resource set in which “resourceType” is configured as periodic through higher layer signaling, and the UE may transmit an SRS resource referenced in the activated SRS resource set. The time-frequency domain resource mapping of the transmitted SRS resource in the slot follows the resource mapping information configured in the SRS resource, and the slot mapping including a transmission period and a slot offset follow periodicityAndOffset configured in the SRS resource. In addition, a spatial domain transmission filter applied to the SRS resource to be transmitted may refer to spatial relation info configured in the SRS resource, or may refer to associated CSI-RS information configured in the SRS resource set including the SRS resource. The UE may transmit the SRS resource within the uplink BWP activated for the periodic SRS resource activated through higher layer signaling.

For example, the base station may activate or deactivate semi-persistent SRS transmission to the UE through higher layer signaling. The base station may instruct to activate the SRS resource set through MAC CE signaling, and the UE may transmit the SRS resource referenced in the activated SRS resource set. The SRS resource set activated through MAC CE signaling may be limited to the SRS resource in which resourceType is configured as semi-persistent. The time-frequency domain resource mapping of the SRS resource to be transmitted in the slot follows the resource mapping information configured in the SRS resource, and the slot mapping including a transmission period and a slot offset follows periodicityAndOffset configured in the SRS resource. In addition, a spatial domain transmission filter applied to the SRS resource to be transmitted may refer to spatial relation info configured in the SRS resource, or may refer to associated CSI-RS information configured in the SRS resource set including the SRS resource. In the case where spatial relation info is configured in the SRS resource, the spatial domain transmission filter may be determined with reference to configuration information on spatial relation info transmitted through MAC CE signaling that activates semi-persistent SRS transmission, instead of following the same. The UE may transmit the SRS resource within the uplink BWP activated for the semi-persistent SRS resource activated through higher layer signaling.

For example, the base station may trigger aperiodic SRS transmission to the UE through DCI. The base station may indicate one of aperiodic SRS resource triggers (aperiodicSRS-ResourceTrigger) through an SRS request field of DCI. The UE may understand that the SRS resource set including the aperiodic SRS resource trigger indicated through DCI in the aperiodic SRS resource trigger list, among the configuration information of the SRS resource set, is triggered. The UE may transmit the SRS resource referenced in the triggered SRS resource set. The time-frequency domain resource mapping the transmitted SRS resource in the slot follows the resource mapping information configured in the SRS resource. In addition, the slot mapping of the transmitted SRS resource may be determined through a slot offset between a PDCCH including DCI and the SRS resource, which may refer to the value(s) included in the slot offset set configured for the SRS resource set. Specifically, as the slot offset between the PDCCH including DCI and the SRS resource, a value indicated in the time domain resource assignment field of DCI, among the offset value(s) included in the slot offset set configured in the SRS resource set, may be applied. In addition, a spatial domain transmission filter applied to the transmitted SRS resource may refer to spatial relation info configured in the SRS resource, or may refer to associated CSI-RS information configured in the SRS resource set including the SRS resource. The UE may transmit the SRS resource within the uplink BWP activated for the aperiodic SRS resource triggered through DCI.

In the case where the base station triggers aperiodic SRS transmission to the UE through DCI, in order for the UE to transmit the SRS by applying configuration information on the SRS resource, a minimum time interval between a PDCCH including DCI triggering the aperiodic SRS transmission and the transmitted SRS may be required. The time interval for SRS transmission of the UE may be defined as the number of symbols between the last symbol of a PDCCH including DCI triggering aperiodic SRS transmission and a first symbol to which the SRS resource transmitted first, among the SRS resource(s) to be transmitted, is mapped. The minimum time interval may be determined with reference to the PUSCH preparation procedure time required for the UE to prepare for PUSCH transmission. In addition, the minimum time interval may have different values depending on the usage of the SRS resource set including the transmitted SRS resource. For example, the minimum time interval may be determined as N2 symbols defined in consideration of the UE processing capability according to the UE capability with reference to the PUSCH preparation procedure time of the UE. In addition, in consideration of the usage of the SRS resource set including the transmitted SRS resource, in the case where the usage of the SRS resource set is configured as codebook or antennaSwitching, the minimum time interval may be configured as N2 symbols, and in the case where the usage of the SRS resource set is configured as nonCodebook or beamManagement, the minimum time interval may be configured as (N2+14) symbols. In the case where the time interval for aperiodic SRS transmission is greater than or equal to the minimum time interval, the UE may transmit aperiodic SRSs, and in the case where the time interval for aperiodic SRS transmission is less than the minimum time interval, the UE may ignore DCI triggering the aperiodic SRS.

TABLE 25

| | |
|---|---|
| SRS-Resource ::= | SEQUENCE { |
| srs-ResourceId | SRS-ResourceId, |
| nrofSRS-Ports | ENUMERATED {port1, ports2, |

ports4},

| | |
|---|---|
| ptrs-PortIndex | ENUMERATED {n0, n1 } |

OPTIONAL, -- Need R

| | |
|---|---|
| transmissionComb | CHOICE { |
| n2 | SEQUENCE { |
| combOffset-n2 | INTEGER (0..1), |
| cyclicShift-n2 | INTEGER (0..7) |

},

| | |
|---|---|
| n4 | SEQUENCE { |
| combOffset-n4 | INTEGER (0..3), |
| cyclicShift-n4 | INTEGER (0..11) |

```
    }
  },
```

| | |
|---|---|
| resourceMapping | SEQUENCE { |
| startPosition | INTEGER (0..5), |
| nrofSymbols | ENUMERATED {n1, n2, |

n4},

| | |
|---|---|
| repetitionFactor | ENUMERATED {n1, n2, n4} |

},

| | |
|---|---|
| freqDomainPosition | INTEGER (0..67), |
| freqDomainShift | INTEGER (0..268), |
| freqHopping | SEQUENCE { |
| c-SRS | INTEGER (0..63), |
| b-SRS | INTEGER (0..3), |
| b-hop | INTEGER (0..3) |

},

| | |
|---|---|
| groupOrSequenceHopping | ENUMERATED { neither, |

groupHopping, sequenceHopping },

| | |
|---|---|
| resourceType | CHOICE { |
| aperiodic | SEQUENCE { |

```
      ...
    },
```

| | |
|---|---|
| semi-persistent | SEQUENCE { |
| periodicityAndOffset-sp | SRS- |

```
PeriodicityAndOffset,
      ...
    },
```

| | |
|---|---|
| periodic | SEQUENCE { |
| periodicityAndOffset-p | SRS- |

```
PeriodicityAndOffset,
      ...
    }
  },
```

| | |
|---|---|
| sequenceId | INTEGER (0..1023), |
| spatialRelationInfo | SRS-SpatialRelationInfo |

OPTIONAL, -- Need R
...
}

The configuration information spatialRelationInfo in Table 25 is intended to apply beam information of the reference signal to the beam used in transmission of the corresponding SRS with reference to one reference signal. For example, the configuration of spatialRelationInfo may include information shown in Table 26 below.

TABLE 26

| SRS-SpatialRelationInfo ::= | SEQUENCE { |
|---|---|
| servingCellId | ServCellIndex |
| OPTIONAL, -- Need S | |
| referenceSignal | CHOICE { |
| ssb-Index | SSB-Index, |
| csi-RS-Index | NZP-CSI-RS-ResourceId, |
| srs | SEQUENCE { |
| resourceId | SRS-ResourceId, |
| uplinkBWP | BWP-Id |

```
    }
  }
}
```

With reference to the above spatialRelationInfo configuration, an SS/PBCH block index, a CSI-RS index, or an SRS index may be configured as an index of a reference signal to be referenced in order to use beam information of a specific reference signal. The higher layer signaling referenceSignal is configuration information indicating which reference signal beam information is to be referred to for the corresponding SRS transmission, ssb-Index indicates the index of the SS/PBCH block, csi-RS-Index indicates the index of the CSI-RS, and srs indicates the index of the SRS. If the higher layer signaling referenceSignal value is configured as ssb-Index, the UE may apply the reception beam used when receiving the SS/PBCH block corresponding to the ssb-Index as a transmission beam of the corresponding SRS transmission. If the higher layer signaling referenceSignal value is configured as csi-RS-Index, the UE may apply the reception beam used when receiving the CSI-RS corresponding to the csi-RS-Index as a transmission beam of the corresponding SRS transmission. If the higher layer signaling referenceSignal value is configured as srs, the UE may apply the transmission beam used when transmitting the SRS corresponding to the srs as a transmission beam of the corresponding SRS transmission.

[PUSCH: In Relation to Transmission Method]

Next, a scheduling method of PUSCH transmission will be described. PUSCH transmission may be dynamically scheduled by a UL grant in DCI, or may be operated by configured grant Type 1 or Type 2. Dynamic scheduling indication for PUSCH transmission may be performed through DCI format 0_0 or 0_1.

PUSCH transmission in the configured grant Type 1 may be semi-statically configured through reception of configuredGrantConfig including “rrc-ConfiguredUplinkGrant” in Table 27 using higher layer signaling without receiving a UL grant in DCI. PUSCH transmission in the configured grant Type 2 may be semi-continuously scheduled by a UL grant in DCI after reception of configuredGrantConfig that does not include rrc-ConfiguredUplinkGrant in Table 27 through higher layer signaling. In the case where PUSCH transmission is operated by a configured grant, parameters applied to PUSCH transmission are applied through the higher layer signaling configuredGrantConfig in Table 27, excluding dataScramblingIdentityPUSCH, txConfig, codebookSubset, maxRank, and scaling of UCI-OnPUSCH, which are provided through the higher layer signaling pusch-Config in Table 28. If the UE is provided with transformPrecoder in configuredGrantConfig, which is the higher layer signaling in Table 27, the UE applies tp-pi2 BPSK in pusch-Config of Table 28 to PUSCH transmission operated by a configured grant.

TABLE 27

| | |
|---|---|
| ConfiguredGrantConfig ::= | SEQUENCE { |
| frequencyHopping | ENUMERATED {intraSlot, interSlot} |

OPTIONAL, -- Need S,

| | |
|---|---|
| cg-DMRS-Configuration | DMRS-UplinkConfig, |
| mcs-Table | ENUMERATED {qam256, |
| qam64LowSE} | OPTIONAL, -- |

Need S

| | |
|---|---|
| mcs-TableTransformPrecoder | ENUMERATED {qam256, |
| qam64LowSE} | OPTIONAL, -- |

Need S

| | |
|---|---|
| uci-OnPUSCH | SetupRelease { CG-UCI- |
| OnPUSCH } | OPTIONAL, -- |

Need M

| | |
|---|---|
| resourceAllocation | ENUMERATED |

{ resourceAllocationType0, resourceAllocationType1, dynamicSwitch },

| | |
|---|---|
| rbg-Size | ENUMERATED {config2} |

OPTIONAL, -- Need S

| | |
|---|---|
| powerControlLoopToUse | ENUMERATED {n0, n1}, |
| p0-PUSCH-Alpha | P0-PUSCH-AlphaSetId, |
| transformPrecoder | ENUMERATED {enabled, disabled} |

OPTIONAL, -- Need S

| | |
|---|---|
| nrofHARQ-Processes | INTEGER(1..16), |
| repK | ENUMERATED {n1, n2, n4, n8}, |
| repK-RV | ENUMERATED {s1-0231, s2-0303, |
| s3-0000} | OPTIONAL, -- Need R |
| periodicity | ENUMERATED { |
| | sym2, sym7, sym1x14, |

sym2x14, sym4x14, sym5x14, sym8x14, sym10x14, sym16x14, sym20x14,

sym32x14, sym40x14,

sym64x14, sym80x14, sym128x14, sym160x14, sym256x14, sym320x14, sym512x14,

sym640x14, sym1024x14,

sym1280x14, sym2560x14, sym5120x14,

sym6, sym1x12, sym2x12,

sym4x12, sym5x12, sym8x12, sym10x12, sym16x12, sym20x12, sym32x12,

sym40x12, sym64x12,

sym80x12, sym128x12, sym160x12, sym256x12, sym320x12, sym512x12,
sym640x12,

sym1280x12, sym2560x12

},

| | |
|---|---|
| configuredGrantTimer | INTEGER (1..64) |

OPTIONAL, -- Need R

| | |
|---|---|
| rrc-ConfiguredUplinkGrant | SEQUENCE { |
| timeDomainOffset | INTEGER (0..5119), |
| timeDomainAllocation | INTEGER (0..15), |
| frequencyDomainAllocation | BIT STRING (SIZE(18)), |
| antennaPort | INTEGER (0..31), |
| dmrs-SeqInitialization | INTEGER (0..1) |

OPTIONAL, -- Need R

| | |
|---|---|
| precodingAndNumberOfLayers | INTEGER (0..63), |
| srs-ResourceIndicator | INTEGER (0..15) |

OPTIONAL, -- Need R

| | |
|---|---|
| mcsAndTBS | INTEGER (0..31), |
| frequency HoppingOffset | INTEGER (1.. |
| maxNrofPhysicalResourceBlocks-1) | OPTIONAL, -- Need R |
| pathlossReferenceIndex | INTEGER |

```
(0..maxNrofPUSCH-PathlossReferenceRSs-1),
    ...
  }
OPTIONAL, -- Need R
  ...
}
```

Next, a PUSCH transmission method will be described. A DMRS antenna port for PUSCH transmission is the same as an antenna port for SRS transmission. PUSCH transmission may be performed by a codebook-based transmission method or a non-codebook-based transmission method depending on whether a value txConfig in pusch-Config of Table 28, which is higher layer signaling, is codebook or nonCodebook.

As described above, PUSCH transmission may be dynamically scheduled through DCI format 0_0 or 0_1, and may be semi-statically configured by a configured grant. If the UE receives a notification of scheduling for PUSCH transmission through DCI format 0_0, the UE performs beam configuration for PUSCH transmission using pucch-spatialRelationInfoD corresponding to a UE-specific PUCCH resource corresponding to the minimum ID within the uplink BWP activated in the serving cell, and in this case, PUSCH transmission is based on a single antenna port. The UE does not expect scheduling for PUSCH transmission through DCI format 0_0 within the BWP in which the PUCCH resource including “pucch-spatialRelationInfo” is not configured. If the UE does not receive a configuration of txConfig in pusch-Config of Table 28, the UE does not expect scheduling through DCI format 0_1.

TABLE 28

| | |
|---|---|
| PUSCH-Config ::= | SEQUENCE { |
| dataScramblingIdentityPUSCH | INTEGER (0..1023) |

OPTIONAL, -- Need S

| | |
|---|---|
| txConfig | ENUMERATED {codebook, |
| nonCodebook} | OPTIONAL, -- Need S |
| dmrs-UplinkForPUSCH-MappingTypeA | SetupRelease { DMRS- |
| UplinkConfig } | OPTIONAL, -- Need M |
| dmrs-UplinkForPUSCH-MappingTypeB | SetupRelease { DMRS- |
| UplinkConfig } | OPTIONAL, -- Need M |
| pusch-PowerControl | PUSCH-PowerControl |

OPTIONAL, -- Need M

| | |
|---|---|
| frequency Hopping | ENUMERATED {intraSlot, |
| interSlot} | OPTIONAL, -- Need S |
| frequency HoppingOffsetLists | SEQUENCE (SIZE (1..4)) OF |

INTEGER (1.. maxNrofPhysicalResourceBlocks-1)
OPTIONAL, -- Need M

| | |
|---|---|
| resourceAllocation | ENUMERATED |

{ resourceAllocationType0, resourceAllocationType1, dynamicSwitch},

| | |
|---|---|
| pusch-TimeDomainAllocationList | SetupRelease { PUSCH- |
| TimeDomainResourceAllocationList } | OPTIONAL, -- Need M |
| pusch-AggregationFactor | ENUMERATED { n2, n4, n8 } |

OPTIONAL, -- Need S

| | |
|---|---|
| mcs-Table | ENUMERATED {qam256, |
| qam64LowSE} | OPTIONAL, -- Need |

S

| | |
|---|---|
| mcs-TableTransformPrecoder | ENUMERATED {qam256, |
| qam64LowSE} | OPTIONAL, -- Need |

S

| | |
|---|---|
| transformPrecoder | ENUMERATED {enabled, |
| disabled} | OPTIONAL, -- Need S |
| codebookSubset | ENUMERATED |

{fullyAndPartialAndNonCoherent, partialAndNonCoherent,nonCoherent}
OPTIONAL, -- Cond codebookBased

| | |
|---|---|
| maxRank | INTEGER (1..4) |

OPTIONAL, -- Cond codebookBased

| | |
|---|---|
| rbg-Size | ENUMERATED { config2} |

OPTIONAL, -- Need S

| | |
|---|---|
| uci-OnPUSCH | SetupRelease { UCI- |
| OnPUSCH} | OPTIONAL, -- Need M |
| tp-pi2BPSK | ENUMERATED {enabled} |

OPTIONAL, -- Need S
...
}

Next, codebook-based PUSCH transmission will be described. Codebook-based PUSCH transmission may be dynamically scheduled through DCI format 0_0 or 01, and may be operated semi-statically by a configured grant. If a codebook-based PUSCH is dynamically scheduled by DCI format 0_1 or is semi-statically configured by a configured grant, the UE determines a precoder for PUSCH transmission, based on an SRS resource indicator (SRI), a transmission precoding matrix indicator (TPMI), and a transmission rank (the number of PUSCH transmission layers).

In this case, the SRI may be given through a field SRS resource indicator in DCI or may be configured through srs-ResourceIndicator, which is higher layer signaling. At least one SRS resource may be configured for the UE during the codebook-based PUSCH transmission, and up to two SRS resources may be configured. In the case where the UE is provided with the SRI through DCI, the SRS resource indicated by the SRI indicates an SRS resource corresponding to the SRI, among the SRS resources transmitted prior to the PDCCH including the SRI. In addition, the TPMI and the transmission rank may be given through precoding information fields and number of layers in DCI, or may be configured through higher layer signaling, precodingAndNumberOfLayers. The TPMI is used to indicate a precoder applied to PUSCH transmission. If one SRS resource is configured for the UE, the TPMI is used to indicate the precoder to be applied in the configured one SRS resource. If a plurality of SRS resources is configured for the UE, the TPMI is used to indicate a precoder to be applied in the SRS resource indicated through the SRI.

A precoder to be used for PUSCH transmission is selected from an uplink codebook having the same number of antenna ports as the value nrofSRS-Ports in the higher layer signaling, SRS-Config. In the codebook-based PUSCH transmission, the UE determines a codebook subset, based on the TPMI and codebookSubset in the higher layer signaling, pusch-Config. CodebookSubset in the higher layer signaling, pusch-Config, may be configured as one of fully AndPartialAndNonCoherent, partialAndNonCoherent, or noncoherent, based on the UE capability reported by the UE to the base station. If the UE reports partialAndNonCoherent as UE capability, the UE does not expect that the value of the higher layer signaling, codebookSubset, will be configured as fully AndPartialAndNonCoherent. In addition, if the UE reports noncoherent as UE capability, the UE does not expect that the value of the higher layer signaling, codebookSubset, will be configured as fully AndPartialAndNonCoherent or partialAndNonCoherent. In the case where nrofSRS-Ports in the higher layer signaling, SRS-ResourceSet, indicates two SRS antenna ports, the UE does not expect that the value of the higher layer signaling, codebookSubset, will be configured as partialAndNonCoherent.

One SRS resource set in which the value of usage in the higher layer signaling, SRS-ResourceSet, is configured as codebook may be configured for the UE, and one SRS resource may be indicated through SRI in the corresponding SRS resource set. If several SRS resources are configured in the SRS resource set in which the value of usage in the higher layer signaling, SRS-ResourceSet, is configured as codebook, the UE expects that the value of nrofSRS-Ports in the higher layer signaling, SRS-Resource, has is the same value for all SRS resources.

The UE transmits, to the base station, one or more SRS resources included in the SRS resource set in which the value of usage is configured as codebook according to higher layer signaling, and the base station selects one of the SRS resources transmitted by the UE and instructs the UE to perform PUSCH transmission using transmission beam information of the corresponding SRS resource. In this case, in the codebook-based PUSCH transmission, the SRI is used as information for selecting an index of one SRS resource and is included in DCI. Additionally, the base station includes information indicating the TPMI and rank to be used by the UE for PUSCH transmission in DCI. The UE performs PUSCH transmission by using the SRS resource indicated by the SRI and applying the precoder indicated by the rank and TPMI indicated based on the transmission beam of the SRS resource.

Next, non-codebook-based PUSCH transmission will be described. Non-codebook-based PUSCH transmission may be dynamically scheduled through DCI format 0_0 or 0_1 and may be semi-statically operated by a configured grant. In the case where at least one SRS resource is configured in the SRS resource set in which the value of usage in the higher layer signaling, SRS-ResourceSet, is configured as nonCodebook, the UE may receive a notification of scheduling for non-codebook-based PUSCH transmission through DCI format 0_1.

For the SRS resource set in which the value of usage in the higher layer signaling, SRS-ResourceSet, is configured as nonCodebook, the UE may receive a configured of one connected NZP CSI-RS resource (non-zero power CSI-RS). The UE may perform a calculation for the precoder for SRS transmission by measuring the NZP CSI-RS resource connected to the SRS resource set. If the difference between the last reception symbol of the aperiodic NZP CSI-RS resource connected to the SRS resource set and the first symbol of aperiodic SRS transmission in the UE is less than 42 symbols, the UE does not expect that the information on the precoder for SRS transmission will be updated.

If the value resourceType in the higher layer signaling, SRS-ResourceSet, is configured as aperiodic, the connected NZP CSI-RS is indicated by a SRS request, which is a field in DCI format 0_1 or 1_1. In this case, if the connected NZP CSI-RS resource is an aperiodic NZP CSI-RS resource, it indicates that a connected NZP CSI-RS exists in the case where the value of the SRS request field in DCI format 0_1 or 1_1 is not 00. In this case, the corresponding DCI must not indicate cross carrier or cross BWP scheduling. In addition, if the value of the SRS request indicates the existence of an NZP CSI-RS, the corresponding NZP CSI-RS is located in the slot in which a PDCCH including the SRS request field is transmitted. In this case, the TCI states configured in the scheduled subcarrier are not configured as QCL-TypeD.

If a periodic or semi-persistent SRS resource set is configured, a connected NZP CSI-RS may be indicated through associatedCSI-RS in the higher layer signaling, SRS-ResourceSet. For non-codebook-based transmission, the UE does not expect that both spatialRelationInfo, which is higher layer signaling for the SRS resource, and associatedCSI-RS in the higher layer signaling, SRS-ResourceSet, will be configured.

In the case where a plurality of SRS resources are configured for the UE, the UE may determine a precoder and a transmission rank to be applied to PUSCH transmission, based on the SRI indicated by the base station. In this case, the SRI may be indicated through a SRS resource indicator field in DCI or may be configured through srs-ResourceIndicator, which is higher layer signaling. Like the above-described codebook-based PUSCH transmission, in the case where the UE is provided with an SRI through DCI, an SRS resource indicated by the SRI indicates the SRS resource corresponding to the SRI, among the SRS resources transmitted prior to a PDCCH including the SRI. The UE may use one or more SRS resources for SRS transmission, and the maximum number of SRS resources and the maximum number of SRS resources that can be simultaneously transmitted in the same symbol in one SRS resource set are determined by the UE capability reported by the UE to the base station. In this case, the SRS resources simultaneously transmitted by the UE occupy the same RB. The UE configures one SRS port for each SRS resource. Only one SRS resource set in which the value of usage in the higher layer signaling, SRS-ResourceSet, is configured as nonCodebook may be configured, and up to four SRS resources may be configured for non-codebook-based PUSCH transmission.

The base station transmits one NZP-CSI-RS connected to the SRS resource set to the UE, and the UE calculates a precoder to be used for transmission of one or more SRS resources in the corresponding SRS resource set, based on a result measured upon receiving the NZP-CSI-RS. The UE applies the calculated precoder when transmitting one or more SRS resources in the SRS resource set in which the usage is configured as nonCodebook to the base station, and the base station selects one or more of the received one or more SRS resources. In this case, in the non-codebook-based PUSCH transmission, the SRI indicates an index capable of representing one SRS resource or a combination of a plurality of SRS resources, and the SRI is included in the DCI. In this case, the number of SRS resources indicated by the SRI transmitted by the base station may be the number of transmission layers of the PUSCH, and the UE transmits the PUSCH by applying a precoder applied to SRS resource transmission to each layer.

[PUSCH: Preparation Procedure Time]

Next, a PUSCH preparation procedure time will be described. In the case where the base station schedules the UE to transmit a PUSCH using DCI format 0_0, 0_1, or 0_2, the UE may require a PUSCH preparation procedure time for transmitting a PUSCH by applying the transmission method indicated through DCI (a transmission precoding method of SRS resources, the number of transmission layers, and a spatial domain transmission filter). In NR, a PUSCH preparation procedure time is defined in consideration of this. The PUSCH preparation procedure time of the UE may follow Equation 4 below.

T_{proc,2}=max((N₂+d_{2,1}+d₂)(2048+144)K2^{-μ}T_{c}+Tₑₓₜ+T_{switch},d_{2,2}) [Equation 4]

Respective variables in T_{proc,2} described in Equation 4 may have the following definitions.
N₂: The number of symbols determined according to UE processing capability 1 or 2 according to the UE capability and numerology p. This may have the values shown in Table 29 in the case where UE processing capability 1 is reported according to the capability report of the UE, and may have the values shown in Table 30 in the case where UE processing capability 2 is reported and where UE processing capability 2 is configured to be available through higher layer signaling.

TABLE 29

| | PUSCH preparation time N₂ |
|---|---|
| μ | [symbols] |
| 0 | 10 |
| 1 | 12 |
| 2 | 23 |
| 3 | 36 |

TABLE 30

| | PUSCH preparation time N₂ |
|---|---|
| μ | [symbols] |
| 0 | 5 |
| 1 | 5.5 |
| 2 | 11 for frequency range 1 |

d_{2,1}: The number of symbols configured as 0 in the case where all resource elements of the first OFDM symbol of PUSCH transmission are configured as only DM-RSs, otherwise configured as 1.
κ: 64
μ: μ_{DL} or μ_{UL}, which increases T_{proc,2}. μ_{DL} indicates a numerology of a downlink in which a PDCCH including DCI for scheduling a PUSCH is transmitted, and
μ_{UL} indicates a numerology of an uplink in which a PUSCH is transmitted.
T_{c}: This has 1/Δfₘₐₓ·N_{f}),Δfₘₐₓ=480·10³ Hz, N_{f}=4096
d_{2,2}: This follows a BWP switching time in the case where the DCI scheduling a PUSCH indicates BWP switching, otherwise this has 0.
d₂: In the case where OFDM symbols of a PUCCH, a PUSCH having a high priority index, and a PUCCH having a low priority index overlap in time, the value d₂ of the PUSCH having a high priority index is used. Otherwise, d₂ is 0.
Tₑₓₜ: In the case where the UE uses a shared spectrum channel access method, the UE may calculate Tₑₓₜ and apply the same to the PUSCH preparation procedure time. Otherwise, Tₑₓₜ is assumed to be 0.
T_{switch}: In the case where an uplink switching interval is triggered, T_{switch} is assumed to be a switching interval time. Otherwise, it is assumed to be 0.

Considering the influence of the timing advance between time domain resource mapping information of a PUSCH scheduled through DCI and the uplink-downlink, in the case where the first symbol of a PUSCH starts earlier than the first uplink symbol in which CP starts after T_{proc,2} from the last symbol of a PDCCH including DCI scheduling the PUSCH, the base station and the UE determine that the PUSCH preparation procedure time is not sufficient. Otherwise, the base station and the UE determine that the PUSCH preparation procedure time is sufficient. The UE may transmit a PUSCH only in the case where the PUSCH preparation procedure time is sufficient, and ignore DCI scheduling a PUSCH in the case where the PUSCH preparation procedure time is not sufficient.

[PUSCH: In Relation to Repetitive Transmission]

Hereinafter, repetitive transmission of an uplink data channel in a 5G system will be described in detail. A 5G system supports two types of repetitive transmission methods of an uplink data channel, e.g., repetitive PUSCH transmission type A and repetitive PUSCH transmission type B. One of repetitive PUSCH transmission type A or B may be configured for the UE through higher layer signaling.

Repetitive PUSCH Transmission Type A
As described above, the symbol length and the position of a start symbol of an uplink data channel may be determined by a time domain resource allocation method in one slot, and the base station may notify the UE of the number of repetitive transmissions through higher layer signaling (e.g., RRC signaling) or L1 signaling (e.g., DCI).
The UE may repetitively transmit an uplink data channel having the same length and start symbol as the configured uplink data channel, based on the number of repetitive transmissions received from the base station in continuous slots. In the case where at least one symbol among the slot configured as downlink for the UE by the base station or among the symbols of the uplink data channel configured for the UE is configured as downlink, the UE omits uplink data channel transmission, but counts the number of repetitive transmissions of the uplink data channel.

Repetitive PUSCH Transmission Type B
As described above, the symbol length and the position of a start symbol of an uplink data channel may be determined by a time domain resource allocation method in one slot, and the base station may notify the UE of the number of repetitive transmissions, numberofrepetitions, through higher layer signaling (e.g., RRC signaling) or L1 signaling (e.g., DCI).
Based on the start symbol and length of the configured uplink data channel, the nominal repetition of the uplink data channel is determined as follows. The slot where the n^{th} nominal repetition starts is given by

$${K}_{s} + ⌊ \frac{S + n \cdot L}{{N}_{s y m b}^{slot}} ⌋$$

and the symbol starting from that slot is given by mod(S+n·L, N^{slot}_{symb}) The slot where the n^{th} nominal repetition ends is given by

$${K}_{s} + ⌊ \frac{S + ( n + 1 ) \cdot L - 1}{{N}_{s y m b}^{slot}} ⌋$$

and the symbol ending at that slot is given by mod(S+(n+1)·L−1, N^{slot}_{symb}). Here, n=0, . . . , numberofrepetitions−1, S represents the start symbol of the configured uplink data channel, and L represents the symbol length of the configured uplink data channel. Kₛ represents a slot in which PUSCH transmission starts, and N^{slot}_{symb} represents the number of symbols per slot.
The UE determines invalid symbols for repetitive PUSCH transmission type B. The symbol configured as downlink by tdd-UL-DL-ConfigurationCommon or tdd-UL-DL-ConfigurationDedicated is determined as an invalid symbol for repetitive PUSCH transmission type B. Additionally, invalid symbols may be configured in higher layer parameters (e.g., InvalidSymbolPattern). A higher layer parameter (e.g., InvalidSymbolPattern) may provide a symbol-level bitmap over one or two slots, thereby configuring invalid symbols. In the bitmap, 1 represents an invalid symbol. Additionally, a period and pattern of the bitmap may be configured through a higher layer parameter (e.g., periodicityAndPattern). If a higher layer parameter (e.g., InvalidSymbolPattern) is configured and if a parameter, InvalidSymbolPatternIndicator-ForDCIFormat0_1 or InvalidSymbolPatternWndicator-ForDCIFormat0_2 indicates 1, the UE applies an invalid symbol pattern, and if the parameter indicates 0, the UE does not apply the invalid symbol pattern. If a higher layer parameter (e.g., InvalidSymbolPattern) is configured and if a parameter, InvalidSymbolPatternIndicator-ForDCIFormat0_1, or InvalidSymbolPatternWndicator-ForDCIFormat0_2 is not configured, the UE applies an invalid symbol pattern.

After the invalid symbol is determined, for each nominal repetition, the UE may consider symbols, other than the invalid symbol, as valid symbols. If one or more valid symbols are included in each nominal repetition, the nominal repetition may include one or more actual repetitions. Each of the actual repetitions includes a set of consecutive valid symbols that may be used for repetitive PUSCH transmission type B in one slot.

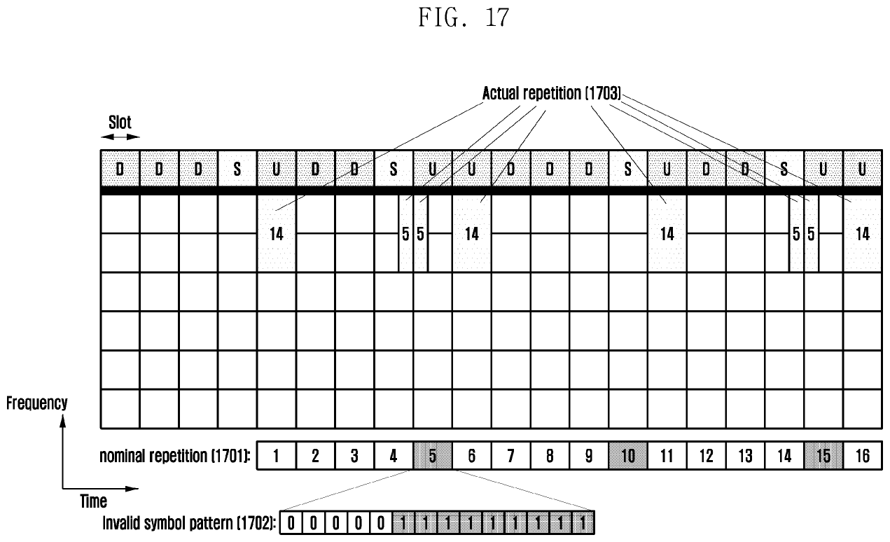

FIG. 17 is a diagram illustrating an example of repetitive PUSCH transmission type B in a wireless communication system according to an example embodiment.

For example, for the UE, a start symbol S of an uplink data channel may be configured as 0, the length L of the uplink data channel may be configured as 14, and the number of repetitive transmissions may be configured as 16. In this case, nominal repetition indicates that repetitive PUSCH transmission can be performed in 16 consecutive slots 1701. Thereafter, the UE may determine that the symbol configured as a downlink symbol in each nominal repetition 1701 is an invalid symbol. In addition, the UE determines the symbols configured as 1 in the invalid symbol pattern 1702 to be invalid symbols. In each nominal repetition, in the case where the valid symbols, other than the invalid symbols, are comprised of one or more consecutive symbols in one slot, the actual repetition 1703 is configured and transmitted.

In addition, for repetitive PUSCH transmission, the following methods may be further defined for UL grant-based PUSCH transmission and configured grant-based PUSCH transmission beyond a slot boundary.
Method 1 (mini-slot level repetition): Two or more repetitive PUSCH transmissions are scheduled within one slot or beyond the boundary of consecutive slots through one UL grant. In addition, for Method 1, the time domain resource assignment information in DCI indicates the first repetitive transmission resource. In addition, time domain resource information of the remaining repetitive transmissions may be determined according to the time domain resource information of the first repetitive transmission and the uplink or downlink direction determined for each symbol of each slot. Each repetitive transmission occupies consecutive symbols.
Method 2 (multi-segment transmission): Two or more repetitive PUSCH transmissions are scheduled in consecutive slots through one UL grant. In this case, one transmission is designated for each slot, and different starting points or different repetition lengths may be provided between the respective transmissions. In addition, in Method 2, the time domain resource assignment information in DCI indicates the starting points and repetition lengths of all repetitive transmissions. In addition, in the case of performing repetitive transmission within a single slot by Method 2, if multiple bundles of consecutive uplink symbols exist in the corresponding slot, each repetitive transmission is performed for each bundle of uplink symbols. If a single bundle of consecutive uplink symbols exists in the slot, one repetitive PUSCH transmission is performed according to the method of NR Release 15.
Method 3: Two or more repetitive PUSCH transmissions are scheduled in consecutive slots through two or more UL grants. In this case, one transmission is designated for each slot, and the n^{th} UL grant may be received before PUSCH transmission scheduled by the (n−1)th UL grant is finished.
Method 4: One or more repetitive PUSCH transmissions in a single slot, or two or more repetitive PUSCH transmissions across the boundaries of consecutive slots may be supported by one UL grant or one configured grant. The number of repetitions indicated by the base station to the UE is only a nominal value, and the number of repetitive PUSCH transmissions actually performed by the UE may be greater than the nominal number of repetitions. The time domain resource allocation information in DCI or in the configured grant indicates the resource of the first repetitive transmission indicated by the base station. The time domain resource information of the remaining repetitive transmissions may be determined with reference to at least the resource information of the first repetitive transmission and the uplink or downlink directions of the symbols. If the time domain resource information of the repetitive transmission indicated by the base station covers the slot boundary or includes an uplink/downlink switching point, the corresponding repetitive transmission may be divided into a plurality of repetitive transmissions. In this case, one repetitive transmission may be included for each uplink period in one slot.

[PUSCH: Frequency Hopping Process]

Hereinafter, frequency hopping of an uplink data channel (physical uplink shared channel; PUSCH) in a 5G system will be described in detail.

5G supports two frequency hopping methods of an uplink data channel for each repetitive PUSCH transmission type. Intra-slot frequency hopping and inter-slot frequency hopping are supported for repetitive PUSCH transmission type A, and inter-repetition frequency hopping and inter-slot frequency hopping are supported for repetitive PUSCH transmission type B.

The intra-slot frequency hopping method supported for repetitive PUSCH transmission type A is a method in which the UE changes the allocated resource in the frequency domain by a configured frequency offset in two hops within one slot, and transmits the same. A start RB of each hop in the intra-slot frequency hopping may be expressed through Equation 5.

$$R {B}_{start} = \{ \begin{matrix}R {B}_{start} & i = 0 \\ ( R {B}_{start} + R {B}_{offset} ) mod {N}_{BWP}^{size} & i = 1\end{matrix} \qquad [ Equation 5 ]$$

In Equation 5, i=0 and i=1 represent the first hop and the second hop, respectively, and RBₛₜₐᵣₜ represents a start RB in the UL BWP and is calculated by a frequency resource allocation method. RB_{offset} represents a frequency offset between two hops through a higher layer parameter. The number of symbols of the first hop may be represented by └N_{symb}^{PUSCH,s}/2┘, and the number of symbols of the second hop may be represented by N_{symb}^{PUSCH,s}−└└N_{symb}^{PUSCH,s}/2┘. N_{symb}^{PUSCH,s} is the length of PUSCH transmission in one slot, and is indicated by the number of OFDM symbols.

Next, the inter-slot frequency hopping method supported for repetitive PUSCH transmission types A and B is a method in which the UE changes the allocated resource of the frequency domain by a configured frequency offset for each slot and transmits the same. A start RB during slots in the inter-slot frequency hopping may be expressed through Equation 6.

$$R {B}_{start} ( {n}_{s}^{μ} ) = \{ \begin{matrix}R {B}_{start} & {n}_{s}^{μ} mod 2 = 0 \\ ( R {B}_{start} + R {B}_{offset} ) mod {N}_{BWP}^{size} & {n}_{s}^{μ} mod 2 = 1\end{matrix} \qquad [ Equation 6 ]$$

In Equation 6, nₛ^{μ} represents a current slot number in multi-slot PUSCH transmission, and RBₛₜₐᵣₜ represents a start RB in the UL BWP and is calculated by a frequency resource allocation method. RB_{offset} represents a frequency offset between two hops through a higher layer parameter.

Next, the inter-repetition frequency hopping method supported for repetitive PUSCH transmission type B is to shift the allocated resource in the frequency domain for one or more actual repetitions of each nominal repetition by a configured frequency offset and transmit the same. RBₛₜₐᵣₜ(n), which is the index of a start RB in the frequency domain for one or more actual repetitions within the n^{th} nominal repetition, may follow Equation 7 below.

$$R {B}_{start} ( n ) = \{ \begin{matrix}R {B}_{s t a r t} & n mod 2 = 0 \\ ( R {B}_{s t a r t} + R {B}_{offset} ) mod {N}_{B W P}^{s i z e} & n mod 2 = 1\end{matrix} \qquad [ Equation 7 ]$$

In Equation 7, n represents an index of nominal repetition, and RB_{offset} represents an RB offset between two hops through a higher layer parameter.

[In Relation to UE Capability Report]

In LTE and NR, the UE may perform a procedure of reporting capability supported by the UE to a serving base station while being connected, directly or indirectly, to the same. This will be referred to as UE capability report in the following description.

The base station may transmit a UE capability enquiry message requesting capability reporting to the UE in a connected state. The message may include a request for UE capability for each RAT (radio access technology) type by the base station. The request for each RAT type may include information on a supported frequency band combination. In addition, the UE capability inquiry message may request UE capability for a plurality of RAT types through a single RRC message container transmitted by the base station, and the base station may include a plurality of UE capability inquiries in a message including the UE capability request for respective RAT types and transmit the same to the UE. That is, a UE capability inquiry may be repeated multiple times in a single message, and the UE may configure a UE capability information message corresponding thereto and report the same multiple times. In the next-generation mobile communication system, a request for UE capability may be performed for MR-DC (multi-RAT dual connectivity), as well as NR, LTE, and EN-DC (E-UTRA-NR dual connectivity). In addition, the UE capability inquiry message is generally transmitted in the initial stage after the UE is connected to the base station, but the base station is able to request the UE capability under any condition as necessary.

In the above step, the UE receiving the request for reporting UE capability from the base station constitutes UE capability according to the RAT type and the band information requested by the base station. A method for configuring the UE capability by the UE in an NR system will be summarized below.

1. If the UE receives a list of LTE and/or NR bands through a UE capability request from the base station, the UE constitutes a band combination (BC) for EN-DC and NR standalone (SA). That is, the UE constitutes a list of BC candidates for EN-DC and NR SA, based on the bands requested by the base station using FreqBandList. In addition, the bands have priority in the order as described in FreqBandList.

2. In the case where the base station requests a UE capability report by configuring “eutra-nr-only” flag or “eutra” flag, the UE completely removes the NR SA BCs from the constituted list of BC candidates. This operation may be performed only in the case where an LTE base station (eNB) requests “eutra” capability.

3. Thereafter, the UE removes fallback BCs from the list of BC candidates constituted in the above step. The fallback BC indicates a BC that may be obtained by removing a band corresponding to at least one SCell from a certain BC, and may be omitted because the BC before removing a band corresponding to at least one SCell is capable of covering the fallback BC. This step is also applied to MR-DC, e.g., LTE bands. The remaining BCs after this step is a final “candidate BC list”.

4. The UE selects the BCs to be reported, which conform to the requested RAT type, from the final “candidate BC list”. In this step, the UE constitutes supportedBandCombinationList in a predetermined order. In other words, the UE constitutes the BCs and UE capability to be reported according to a preconfigured order of the RAT types (nr-eutra-nr-eutra). In addition, the UE constitutes featureSetCombination for the constituted supportedBandCombinationList and constitutes a list of “candidate feature set combinations” from the candidate BC list from which the list of fallback BCs (including capabilities in the equal or lower level) is removed. The “candidate feature set combination” may include the feature set combinations for BCs both of NR and EUTRA-NR, and may be obtained from the feature set combinations of the UE-NR-Capabilities and UE-MRDC-Capabilities containers.

5. In addition, if the requested RAT type is eutra-nr and has influences, featureSetCombinations is included in both containers of UE-MRDC-Capabilities and UE-NR-Capabilities. However, the feature set of NR is included only in UE-NR-Capabilities.

After the UE capability is constituted, the UE transmits a UE capability information message including the UE capability to the base station. Then, the base station performs appropriate scheduling and transmission/reception management for the UE, based on the UE capability received from the UE.

[In Relation to CA/DC]

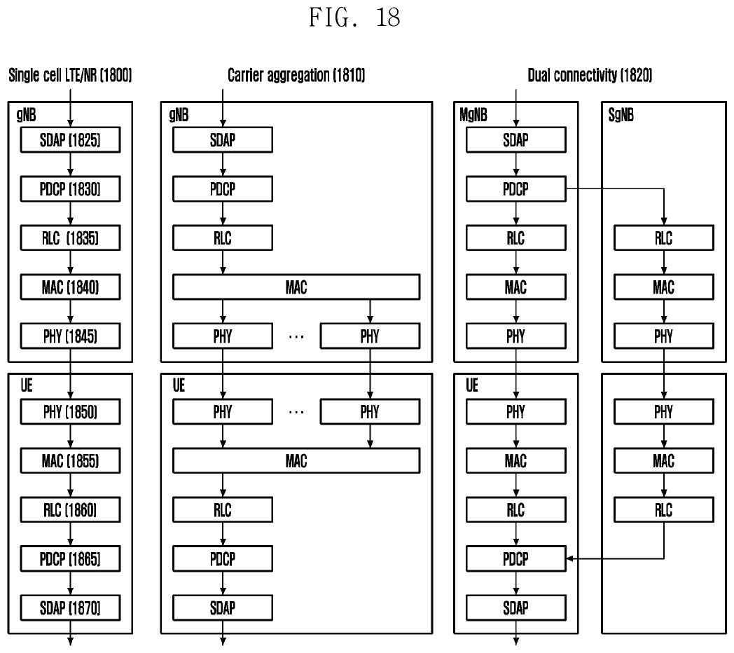

FIG. 18 is a diagram illustrating a radio protocol structure of a base station and a UE in a single cell, carrier aggregation, and dual connectivity situation according to an example embodiment.

With reference to FIG. 18, the radio protocol of the next-generation mobile communication system is comprised of NR SDAP (service data adaption protocol) 1825 or 1870, NR PDCP (packet data convergence protocol) 1830 or 1865, NR RLC (radio link control) 1835 or 1860, and NR MAC (medium access control) 1840 or 1855 in a UE and an NR base station, respectively.

The primary functions of the NR SDAP 1825 or 1870 may include some of the following functions.
Transfer function of user data (transfer of user plane data)
Mapping function between QoS flow and data bearer for both DL and UL (mapping between a QoS flow and a DRB for both DL and UL)
Marking function of QoS flow ID in both DL and UL (marking QoS flow ID in both DL and UL packets)
Mapping function of reflective QoS flow to data bearer for UL SDAP PDUs (reflective QoS flow to DRB mapping for the UL SDAP PDUs).

With regard to the SDAP layer device, the UE may receive a configuration indicating whether or not to use a header of the SDAP layer device or whether or not to use functions of the SDAP layer device for each PDCP layer device, for each bearer, or for each logical channel through an RRC message. In the case where the SDAP header is configured, a one-bit NAS reflective QoS configuration indicator and a one-bit AS reflective QoS configuration indicator of the SDAP header may instruct the UE to update or reconfigure mapping information between the QoS flow and the data bearers in the uplink and downlink. The SDAP header may include QoS flow ID information indicating QoS. The QoS information may be used as data processing priority, scheduling information, or the like in order to support effective services.

The primary functions of the NR PDCP 1830 or 1865 may include some of the following functions.
Header compression and decompression functions (Header compression and decompression: ROHC only)
Transfer function of user data (Transfer of user data)
In-sequence delivery function (In-sequence delivery of upper layer PDUs)
Out-of-sequence delivery function (Out-of-sequence delivery of upper layer PDUs)
Sequence reordering function (PDCP PDU reordering for reception)
Duplication detection function (Duplicate detection of lower layer SDUs)
Retransmission function (Retransmission of PDCP SDUs)
Ciphering and deciphering functions (Ciphering and deciphering)
Timer-based SDU discard function (Timer-based SDU discard in uplink.)

The sequence reordering function of the NR PDCP device denotes a function of reordering PDCP PDUs received from a lower layer, based on a PDCP sequence number (SN), which may include a function of transmitting data to a higher layer in the reordered order. Alternatively, the sequence reordering function of the NR PDCP device may include a function of directly transmitting data without consideration of an order, include a function of reordering the sequence and recording lost PDCP PDUs, include a function of sending a status report of the lost PDCP PDUs to a transmitting end, and include a function of making a request for retransmission of the lost PDCP PDUs.

The primary functions of the NR RLC 1835 or 1860 may include some of the following functions.
Data transfer function (Transfer of upper layer PDUs)
In-sequence delivery function (In-sequence delivery of upper layer PDUs)
Out-of-sequence delivery function (Out-of-sequence delivery of upper layer PDUs)
ARQ function (Error Correction through ARQ)
Concatenation, segmentation, reassembly functions (Concatenation, segmentation and reassembly of RLC SDUs)
Re-segmentation function (Re-segmentation of RLC data PDUs)
Sequence reordering function (Reordering of RLC data PDUs)
Duplication detection function (Duplicate detection)
Error detection function (Protocol error detection)
RLC SDU discard function (RLC SDU discard)
RLC re-establishment function (RLC re-establishment)

The in-sequence delivery function of the NR RLC device denotes a function of transferring RLC SDUs received from a lower layer to a higher layer in sequence. The in-sequence delivery function of the NR RLC device may include a function of, in the case where one original RLC SDU is divided into a plurality of RLC SDUs and received, reassembling and transmitting the same, include a function of reordering the received RLC PDUs, based on an RLC SN (sequence number) or a PDCP SN (sequence number), include a function of reordering the sequence and recording lost RLC PDUs, include a function of sending a status report of the lost RLC PDUs to a transmitting end, and include a function of making a request for retransmission of the lost RLC PDUs. The in-sequence delivery function of the NR RLC device may include a function of, in the case where there is a lost RLC SDU, transmitting only the RLC SDUs prior to the lost RLC SDU to a higher layer in sequence, or include a function of, in the case where a predetermined timer expires even though there is a lost RLC SDU, transmitting all RLC SDUs received before the timer starts to a higher layer in sequence. Alternatively, the in-sequence delivery function of the NR RLC device may include a function of, if a predetermined timer expires even though there is a lost RLC SDU, transmitting all RLC SDUs received until the present to a higher layer in sequence. In addition, the RLC PDUs may be processed in the order of reception (in the order of arrival regardless of a serial number or a sequence number thereof), and transmitted to the PDCP device in an out-of-sequence delivery manner. In the case of segments, the segments, which are stored in the buffer or will be received later, may be received and reconstituted into one complete RLC PDU, and the RLC PDU may be processed and transmitted to the PDCP device. The NR RLC layer may not include a concatenation function, which may be performed in the NR MAC layer or replaced with a multiplexing function of the NR MAC layer.

The out-of-sequence delivery of the NR RLC device denotes a function of directly transmitting RLC SDUs received from a lower layer to a higher layer regardless of sequence, which may include a function of, in the case where one original RLC SDU is divided into a plurality of RLC SDUs and is received, reassembling and transmitting the same, and include a function of storing and ordering RLC SNs or PDCP SNs of the received RLC PDUs, thereby recording the lost RLC PDUs.

The NR MAC 1840 or 1855 may be connected, directly or indirectly, to a plurality of NR RLC devices comprised in a single UE, and the primary functions of the NR MAC may include some of the following functions.
Mapping function (Mapping between logical channels and transport channels)
Multiplexing and demultiplexing functions (Multiplexing/demultiplexing of MAC SDUs)
Scheduling information reporting function (Scheduling information reporting)
HARQ function (Error correction through HARQ)
Priority handling function between logical channels (Priority handling between logical channels of one UE)
Priority handling function between UEs (Priority handling between UEs by means of dynamic scheduling)
MBMS service identification function (MBMS service identification)
Transport format selection function (Transport format selection)
Padding function (Padding)

The NR PHY layer device 1845 or 1850 may perform operations of channel-coding and modulating higher layer data into OFDM symbols and transmitting the same through a radio channel, or operations of demodulating and channel-decoding the OFDM symbols received through a radio channel and transmitting the same to a higher layer.

The detailed structures of the radio protocol may be changed in various ways depending on a carrier (or cell) operating scheme. For example, in the case where the base station transmits data to the UE, based on a single carrier (or cell), the base station and the UE use a single protocol structure for the respective layers as shown in 1800. On the other hand, in the case where the base station transmits data to the UE, based on carrier aggregation (CA) using multiple carriers in a single TRP, the base station and the UE use a protocol structure in which a single structure is provided until the RLC and in which the PHY layer is multiplexed through the MAC layer as shown in 1810. As another example, in the case where the base station transmits data to the UE, based on dual connectivity (DC) using multiple carriers in multiple TRPs, the base station and the UE use a protocol structure in which a single structure is provided until the RLC and in which the PHY layer is multiplexed through the MAC layer as shown in 1820.

With reference to the above descriptions of PDCCH and beam configuration, repetitive PDCCH transmission is not currently supported in Rel-15 and Rel-16 NR, so it is difficult to attain the required reliability in scenarios requiring high reliability, such as URLLC. The disclosure provides a repetitive PDCCH transmission method through multiple transmission and reception points (TRPs) to improve PDCCH reception reliability of the UE. A method thereof will be described in detail in the following embodiments.

Hereinafter, embodiments of the disclosure will be described in detail with reference to the accompanying drawings. The disclosure is applicable to FDD and TDD systems. Hereinafter, higher signaling (or higher layer signaling) in the disclosure is a signal transmission method in which signals are transmitted from a base station to a UE using a downlink data channel of a physical layer or from a UE to a base station using an uplink data channel of a physical layer, and may be referred to as RRC signaling, PDCP signaling, or MAC (medium access control) control element (MAC CE).

Hereinafter, in the disclosure, the UE may determine whether or not to apply cooperative communication using various methods such as the case where the PDCCH(s) for allocating a PDSCH to which cooperative communication is applied has a specific format, the case where the PDCCH(s) for allocating a PDSCH to which the cooperative communication is applied includes a specific indicator indicating whether or not cooperative communication is applied, the case where the PDCCH(s) for allocating a PDSCH to which cooperative communication is applied is scrambled by a specific RNTI, the case where cooperative communication is assumed to be applied in a specific section indicated by a higher layer, or the like. Hereinafter, the case where the UE receives a PDSCH to which cooperative communication is applied based on conditions similar to the above will be referred to as an NC-JT case for convenience of description.

Hereinafter, in the disclosure, determining the priority between A and B may be variously construed such as selecting one having a higher priority according to a predetermined priority rule and performing an operation corresponding thereto or omitting or dropping an operation on one having a lower priority.

Although the examples will be described through a plurality of embodiments in the disclosure, these are not independent and one or more embodiments may be applied simultaneously or in combination.

[In Relation to NC-JT]

According to an example embodiment, non-coherent joint transmission (NC-JT) may be used for the UE to receive PDSCHs from a plurality of TRPs.

Unlike the existing communication systems, a 5G wireless communication system may support both a service having a very short transmission delay and a service requiring a high connection density, as well as a service requiring a high transmission rate. In a wireless communication network including a plurality of cells, transmission and reception points (TRPs), or beams, cooperative communication (coordinated transmission) between cells, TRPs, and/or beams may satisfy various service requirements by increasing the strength of a signal received by the UE or efficiently controlling interference between cells, TRPs, and/or beams.

Joint transmission (JT) is a representative transmission technology for the above-mentioned cooperative communication, which may increase the strength or throughput of a signal received by the UE by transmitting signals to one UE through a number of different cells, TRPs. and/or beams. In this case, the characteristics of the channel between the cells, TRPs, or beams and the UE may be significantly different, and in particular, non-coherent joint transmission (NC-JT) supporting non-coherent precoding between the cells, TRPs, and/or beams may require individual precoding, MCS, resource allocation, TCI indication, etc. depending on the channel characteristics for each link between the cells, TRPs, and/or beams.

The above-described NC-JT transmission may be applied to at least one of a downlink data channel (PDSCH: physical downlink shared channel), a downlink control channel (PDCCH: physical downlink control channel), an uplink data channel (PUSCH: physical uplink shared channel), and an uplink control channel (PUCCH: physical uplink control channel). Transmission information such as precoding, MCS, resource allocation, TCI, and the like is indicated by DL DCI when transmitting a PDSCH, and the transmission information must be independently indicated for each cell, TRP, and/or beam for NC-JT transmission. This is a major factor that increases a payload required for DL DCI transmission, which may adversely affect reception performance of a PDCCH transmitting DCI. Therefore, it is necessary to carefully design a tradeoff between the amount of DCI information and the control information reception performance to support the PDSCH JT.

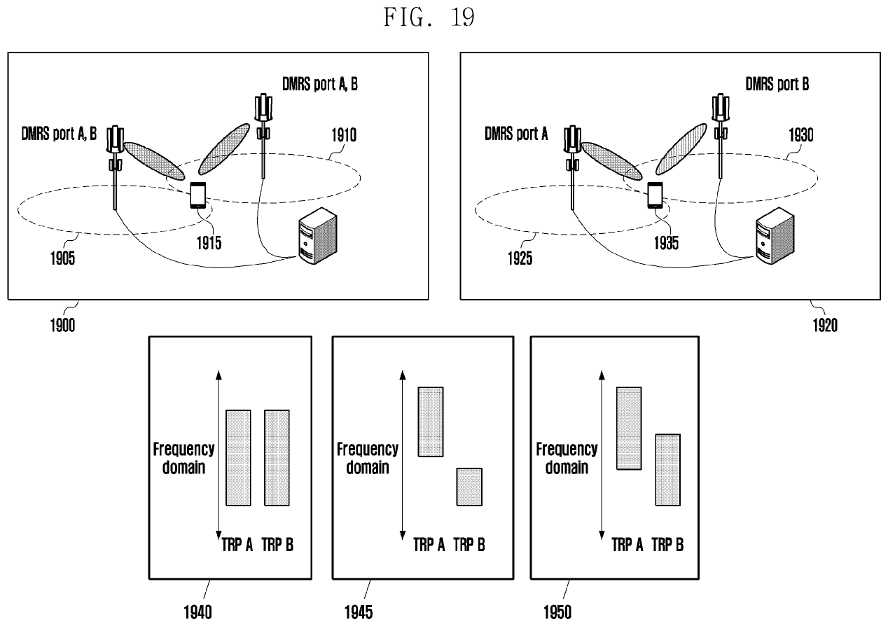

FIG. 19 is a diagram illustrating an example of antenna port configuration and resource allocation for transmitting a PDSCH using cooperative communication in a wireless communication system according to an example embodiment.

With reference to FIG. 19, examples of PDSCH transmission are described according to techniques of joint transmission (JT), and examples of allocating radio resources for each TRP are shown.

With reference to FIG. 19, an example 1900 of coherent joint transmission (C-JT) supporting coherent precoding between cells, TRPs and/or beams is shown.

In the case of C-JT, TRP A 1905 and TRP B 1910 may transmit a single piece of data (PDSCH) to a UE 1915, and a plurality of TRPs may perform joint precoding. This may indicate that a DMRS are transmitted through the same DMRS ports so that TRP A 1905 and TRP B 1910 transmit the same PDSCH. For example, TRP A 1905 and TRP B 1910 may transmit the DRMS to the UE through DMRS port A and DMRS port B, respectively. In this case, the UE may receive one piece of DCI information for receiving one PDSCH demodulated based on the DMRS transmitted through DMRS port A and DMRS port B.

FIG. 19 illustrates an example 1920 of non-coherent joint transmission (NC-JT) supporting non-coherent precoding between cells, TRPs, and/or beams for PDSCH transmission.

In the case of NC-JT, each cell, TRP, and/or beam may transmit a PDSCH to the UE 1935, and individual precoding may be applied to each PDSCH. The respective cells, TRPs, and/or beams may transmit different PDSCHs or different PDSCH layers to the UE, thereby improving throughput, compared to single-cell, TRP, and/or beam transmission. In addition, it is possible to improve reliability, compared to single-cell, TRP, and/or beam transmission, by repeatedly transmitting the same PDSCH to the UE by the respective cells, TRPs, and/or beams. For convenience of description, the cell, the TRP, and/or the beam is hereinafter collectively referred to as a “TRP”.

Various radio resource allocation cases may be considered, such as the case where the frequency and time resources used by a plurality of TRPs for PDSCH transmission are all the same 1940, the case where the frequency and time resources used by a plurality of TRPs do not overlap at all 1945, and the case where the frequency and time resources used by the plurality of TRPs partially overlap 1950.

For support of NC-JT, in order to allocate a plurality of PDSCHs to one UE at the same time, DCI of various types, structures, and relationships may be considered.

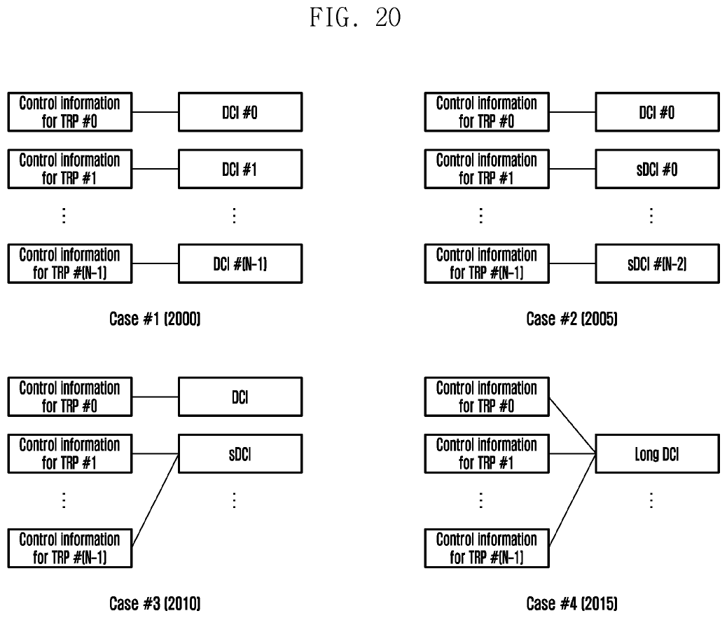

FIG. 20 is a diagram illustrating an example of a constitution of downlink control information (DCI) for NC-JT in which respective TRPs transmit different PDSCHs or different PDSCH layers to a UE in a wireless communication system according to an example embodiment.

With reference to FIG. 20, Case #1 2000 is an example in which (N−1) different PDSCHs are transmitted from (N−1) additional TRPs {TRP #1 to TRP #(N−1)} in addition to a serving TRP (TRP #0) used in single PDSCH transmission and in which control information on the PDSCHs transmitted from the (N−1) additional TRPs is transmitted independently of control information on the PDSCH transmitted from the serving TRP. That is, the UE may obtain control information on the PDSCHs transmitted from different TRPs {TRP #0 to TRP #(N−1)} through independent DCI {DCI #0 to DC1 #(N−1)}. The formats of the independent DCI may be the same or different from each other, and the payloads of the DCI may also be the same or different from each other. In Case #1 described above, although control or allocation freedom of respective PDSCHs may be completely guaranteed, transmission of DCI from different TRPs may cause a difference in coverage between DCI, thereby degrading the reception performance.

Case #2 2005 shows an example in which (N−1) different PDSCHs are transmitted from (N−1) additional TRPs {TRP #1 to TRP #(N−1)} in addition to a serving TRP (TRP #0) used in single PDSCH transmission, in which control information (DCI) on the PDSCHs of the (N−1) additional TRPs is transmitted, respectively, and in which the DCI thereof is dependent on control information on the PDSCH transmitted from the serving TRP.

For example, although DCI #0, which is control information on the PDSCH transmitted from the serving TRP (TRP #0), may include all information elements of DCI format 1_0, DCI format 1_1, and DCI format 1_2, shortened DCI (hereinafter, “sDCI”) {sDCI #0 to sDCI #(N−2)}, which is control information on the PDSCHs transmitted from the cooperative TRPs {TRP #1 to TRP #(N−1)}, may include some of the information elements of DCI format 1_0, DCI format 1_1, and DCI format 1_2. Accordingly, sDCI transmitting control information on the PDSCHs transmitted from the cooperative TRPs has a smaller payload than normal DCI (nDCI) transmitting control information related to the PDSCH transmitted from the serving TRP, so sDCI may include reserved bits, compared to nDCI.

In Case #2 described above, although control or allocation freedom of respective PDSCHs may be restricted depending on the content of information elements included in sDCI, the reception performance of sDCI is superior to that of nDCI, thereby reducing the probability of occurrence of a coverage difference between respective DCI.

Case #3 2010 shows an example in which (N−1) different PDSCHs are transmitted from (N−1) additional TRPs {TRP #1 to TRP #(N−1)} in addition to a serving TRP (TRP #0) used in single PDSCH transmission, in which a single piece of control information on the PDSCHs of the (N−1) additional TRPs is transmitted, respectively, and in which the DCI thereof is dependent on control information on the PDSCH transmitted from the serving TRP.

For example, DCI #0, which is control information on the PDSCH transmitted from the serving TRP (TRP #0), may include all information elements of DCI format 1_0, DCI format 1_1, and DCI format 1_2, and in the case of control information on the PDSCHs transmitted from the cooperative TRPs {TRP #1 to TRP #(N−1)}, some of the information elements of DCI format 1_0, DCI format 1_1, and DCI format 1_2 may be collected in one piece of secondary DCI (sDCI) and transmitted. For example, sDCI may include at least one piece of information among HARQ-related information, such as frequency domain resource assignment, time domain resource assignment, and MCS of the cooperative TRPs. In addition, information, which is not included in sDCI, such as a bandwidth part (BWP) indicator, a carrier indicator, or the like, may follow DCI (DCI #0, normal DCI, nDCI) of the serving TRP.

In Case #3 2010, although control or allocation freedom of respective PDSCHs may be restricted depending on the content of information elements included in sDCI, it is possible to control the reception performance of sDCI, and the DCI blind decoding complexity of the UE may be reduced, compared to Case #1 2000 or Case #2 2005.

Case #4 2015 shows an example in which (N−1) different PDSCHs are transmitted from (N−1) additional TRPs {TRP #1 to TRP #(N−1)} in addition to a serving TRP (TRP #0) used in single PDSCH transmission and in which control information on the PDSCHs transmitted from the (N−1) additional TRPs are transmitted in the same DCI (long DCI) as control information on the PDSCH transmitted from the serving TRP. That is, the UE may obtain control information on the PDSCHs transmitted from different TRPs {TRP #0 to TRP #(N−1)} through a single piece of DCI. In the case of Case #4 2015, although the DCI blind decoding complexity of the UE may not increase, control or allocation freedom of PDSCHs may be lowered such that the number of cooperative TRPs may be restricted according to restriction of a long DCI payload and the like.

In the following description and embodiments, sDCI may refer to various auxiliary DCI, such as shortened DCI, secondary DCI, or normal DCI (DCI formats 1_0 to 1_1 described above) including PDSCH control information transmitted from the cooperative TRPs, and a description thereof may be applied to various auxiliary DCI in a similar manner in the case where specific restrictions are not specified.

In the following description and embodiments, Case #1 2000, Case #2 2005, and Case #3 2010 described above in which one or more pieces of DCI (PDCCHs) are used to support NC-JT will be differentiated as multiple PDCCH-based NC-JT, and Case #4 2015 described above in which a single piece of DCI (PDCCH) is used to support NC-JT will be differentiated as single-PDCCH-based NC-JT. In the multiple PDCCH-based PDSCH transmission, the CORESET in which DCI of the serving TRP (TRP #0) is scheduled may be differentiated from the CORESET in which DCI of the cooperative TRPs {TRP #1 to TRP #(N−1)} is scheduled. As a method of differentiating the CORESETs, a method for differentiating the CORESETs through a higher layer indicator for each CORESET, a method for differentiating the CORESETs through beam configuration for each CORESET, and the like may be provided. In addition, in the single-PDCCH-based NC-JT, a single piece of DCI may schedule a single PDSCH having a plurality of layers, instead of scheduling a plurality of PDSCHs1), and the plurality of layers described above may be transmitted from a plurality of TRPs. In this case, a connection relationship between a layer and a TRP transmitting the corresponding layer may be indicated through a transmission configuration indicator (TCI) for a layer.

“Cooperative TRP” in the embodiments of the disclosure may be replaced with various terms such as “cooperative panel” or “cooperative beam” when applied in practice.

In the embodiments of the disclosure, although “the case to which NC-JT is applied” may be variously construed depending on the situation, such as “the case where the UE simultaneously receives one or more PDSCHs in one BWP”, “the case where the UE simultaneously receives PDSCHs, based on two or more TCIs (transmission configuration indicators) in one BWP”, “the case where the PDSCH received by the UE is associated with one or more DMRS port groups”, and the like, one expression is used for convenience.

In the disclosure, the wireless protocol structure for NC-JT may be used in various ways according to the TRP deployment scenario. For example, in the case where there is no or small backhaul delay between the cooperative TRPs, a method using the structure based on MAC layer multiplexing (a CA-like method), similarly to 1810 in FIG. 18, is possible. On the other hand, in the case where the backhaul delay between the cooperative TRPs is too large to ignore (e.g., the case where information exchange of CSI, scheduling, HARQ-ACK, etc. between the cooperative TRPs requires a time of 2 ms or more), a method for securing a characteristic resistant to delay using an independent structure for each TRP from the RLC layer (a DC-like method), similarly to 1820 in FIG. 18, is possible.

The UE supporting C-JT/NC-JT may receive C-JT/NC-JT-related parameters or setting values and the like from the higher layer configuration and set RRC parameters of the UE, based on the same. The UE may utilize UE capability parameters, for example, tci-StatePDSCH, for the higher layer configuration. Here, the UE capability parameter, for example, tci-StatePDSCH, may define the TCI states for the purpose of PDSCH transmission, and the number of TCI states may be configured as 4, 8, 16, 32, 64, and 128 in FR1 and as 64 and 128 in FR2, and up to 8 states that may be indicated by 3 bits of TCI field in DCI through a MAC CE message may be configured, among the configured numbers. The maximum value 128 indicates the value indicated by maxNumberConfiguredTCIstatesPerCC in the parameters tci-StatePDSCH included in the UE capability signaling. As described above, a series of configuration procedures from the higher layer configuration to the MAC CE configuration may be applied to beamforming indication or beamforming switching command for at least one PDSCH in one TRP.

[Multi-DCI-Based Multi-TRP]

As an example embodiment, a multi-DCI-based multi-TRP transmission method will be described. In the multi-DCI-based multi-TRP transmission method, a downlink control channel for NC-JT transmission may be configured based on multiple PDCCHs.

NC-JT based on multiple PDCCHs may have CORESETs or search spaces divided for each TRP when transmitting DCI for scheduling PDSCHs of the respective TRPs. The CORESET or search space for each TRP may be configured as at least one of the following cases.

Index configuration for each CORESET: CORESET configuration information configured by a higher layer may include an index value, and the TRP transmitting a PDCCH in the corresponding CORESET may be differentiated by the index value configured for each CORESET. That is, a set of CORESETs having the same index value may be considered that the same TRP transmits a PDCCH or that a PDCCH scheduling the PDSCH of the same TRP is transmitted. The index value for each CORESET described above may be named as CORESETPoolIndex, and a PDCCH may be regarded as being transmitted from the same TRP for CORESETs in which the same value of CORESETPoolIndex is configured. In the case of CORESET in which the value CORESETPoolIndex is not configured, it may be considered that a default value of CORESETPoolIndex is configured, and the default value may be 0.
In the disclosure, in the case where the number of types of CORESETPoolIndex provided in each of the plurality of CORESETs included in the higher layer signaling, PDCCH-Config, exceeds one, that is, in the case where the respective CORESETs have different CORESETPoolIndex, the UE may consider that the base station may use a multi-DCI-based multi-TRP transmission method.
Alternatively, in the disclosure, if the number of types of CORESETPoolIndex provided in each of the plurality of CORESETs included in the higher layer signaling, PDCCH-Config, is one, that is, in the case where all the CORESETs have the same CORESETPoolIndex of 0 or 1, the UE may consider that the base station performs transmission using a single TRP, instead of using the multi-DCI-based multi-TRP transmission method.
Multi-PDCCH-Config configuration: a plurality of PDCCH-Configs may be configured in one BWP, and each PDCCH-Config may include PDCCH configuration for each TRP. That is, a list of CORESETs for each TRP and/or a list of search spaces for each TRP may be configured in one PDCCH-Config, and one or more CORESETs and one or more search spaces included in one PDCCH-Config may be regarded as corresponding to a specific TRP.
CORESET beam/beam group configuration: A TRP corresponding to the corresponding CORESET may be differentiated through a beam or a beam group configured for each CORESET. For example, in the case where the same TCI state is configured in a plurality of CORESETs, the CORESETs may be regarded as being transmitted through the same TRP, or the PDCCH scheduling a PDSCH of the same TRP may be regarded as being transmitted from the corresponding CORESET.
Search space beam/beam group configuration: A beam or beam group may configured for each search space, and TRPs may be differentiated for the respective search spaces through the same. For example, in the case where the same beam/beam group or TCI state is configured in a plurality of search spaces, it may be considered that the same TRP transmits a PDCCH in the corresponding search space or that the PDCCH scheduling a PDSCH of the same TRP is transmitted in the corresponding search space.

By differentiating CORESETs or search spaces for respective TRPs as described above, PDSCHs and HARQ-ACK information may be classified for each TRP, and thus it is possible to independently produce HARQ-ACK codebooks and to independently use PUCCH resources for each TRP.

The above configuration may be independent for each cell or each BWP. For example, while two different CORESETPoolIndex values may be configured in the PCell, the CORESETPoolIndex value may not be configured in a specific SCell. In this case, it may be considered that NC-JT transmission is configured in the PCell, whereas NC-JT transmission is not configured in the SCell in which the CORESETPoolIndex value is not configured.

A PDSCH TCI state activation/deactivation MAC-CE applicable to the multi-DCI-based multi-TRP transmission method may follow FIG. 16. In the case where CORESETPoolIndex is not configured in each of all CORESETs in the higher layer signaling PDCCH-Config for the UE, the UE may ignore the CORESET Pool ID field 16-55 in the corresponding MAC-CE 16-50. In the case where the UE is able to support the multi-DCI-based multi-TRP transmission method, that is, in the case where the UE has different CORESETPoolIndex values for the respective CORESETs in the higher layer signaling, PDCCH-Config, the UE may activate the TCI state in DCI included in the PDCCHs transmitted from the CORESETs having the same CORESETPoolIndex value as the CORESET Pool ID field 16-55 value in the corresponding MAC-CE 16-50. For example, if the value of the CORESET Pool ID field 16-55 in the corresponding MAC-CE 16-50 is 0, the TCI state in DCI included in the PDCCHs transmitted from the CORESETs having a CORESETPoolIndex value of 0 may follow activation information of the corresponding MAC-CE.

In the case where the UE is configured to use the multi-DCI-based multi-TRP transmission method from the base station, that is, in the case where the number of types of CORESETPoolIndex of each of the plurality of CORESETs included in the higher layer signaling, PDCCH-Config, exceeds one, or in the case where the respective CORESETs have different CORESETPoolIndex values, the UE may recognize the following restrictions for PDSCHs scheduled from the PDCCHs in the respective CORESETs having two different CORESETPoolIndex values.
1) In the case where PDSCHs indicated by the PDCCHs in the respective CORESETs having two different CORESETPoolIndex values entirely or partially overlap, the UE may apply the TCI states indicated by the respective PDCCHs to different CDM groups. That is, two or more TCI states may not be applied to one CDM group.
2) In the case where PDSCHs indicated by the PDCCHs in the respective CORESETs having two different CORESETPoolIndex values entirely or partially overlap, the UE may expect that the actual number of front loaded DMRS symbols, the actual number of additional DMRS symbols, the actual positions of the DMRS symbols, the DMRS types of the PDSCHs will not be different from each other.
3) The UE may expect that the bandwidth parts indicated from the PDCCHs in the respective CORESETs having two different CORESETPoolIndex values will be the same and that the subcarrier spacings thereof will also be the same.
4) The UE may expect that the respective PDCCHs will completely include information on the PDSCHs scheduled from the PDCCHs in the respective CORESETs having two different CORESETPoolIndex values.

[Single-DCI-Based Multi-TRP]

As an example embodiment, a single-DCI-based multi-TRP transmission method will be described. The single-DCI-based multi-TRP transmission method may configure a downlink control channel for NC-JT transmission, based on a single PDCCH.

In the single-DCI-based multi-TRP transmission method, PDSCHs transmitted by a plurality of TRPs may be scheduled with one piece of DCI. The number of TCI states may be used as a method for indicating the number of TRPs transmitting the corresponding PDSCH. That is, if the number of TCI states indicated in DCI scheduling the PDSCH is two, it may be regarded as single-PDCCH-based NC-JT transmission, and if the number of TCI states is one, it may be regarded as single-TRP transmission. The TCI states indicated in DCI may correspond to one or two TCI states among the TCI states activated by a MAC-CE. In the case where the TCI states of DCI correspond to two TCI states activated by a MAC-CE, a correspondence relationship between the TCI codepoint indicated in the DCI and the TCI states activated by the MAC-CE may be established, and two TCI states may be indicated based on the TCI codepoint.

As another example, in the case where at least one codepoint among all the codepoints of a TCI state field in DCI indicates two TCI states, the UE may consider that the base station may perform transmission based on the single-DCI-based multi-TRP method. In this case, at least one codepoint indicating two TCI states in the TCI state field may be activated through an enhanced PDSCH TCI state activation/deactivation MAC-CE.

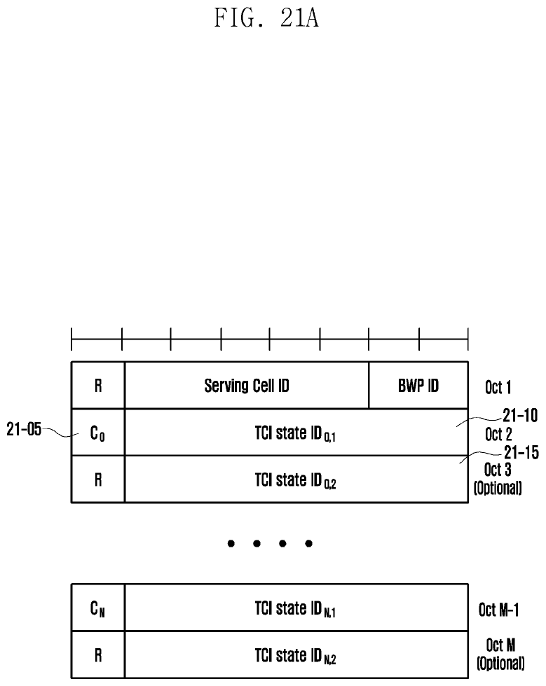

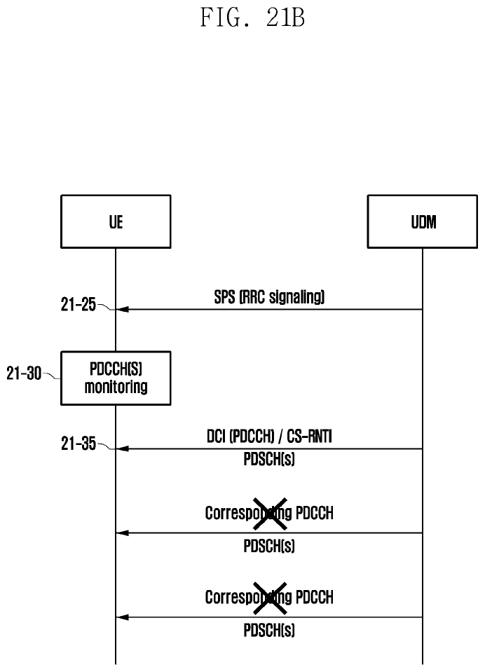

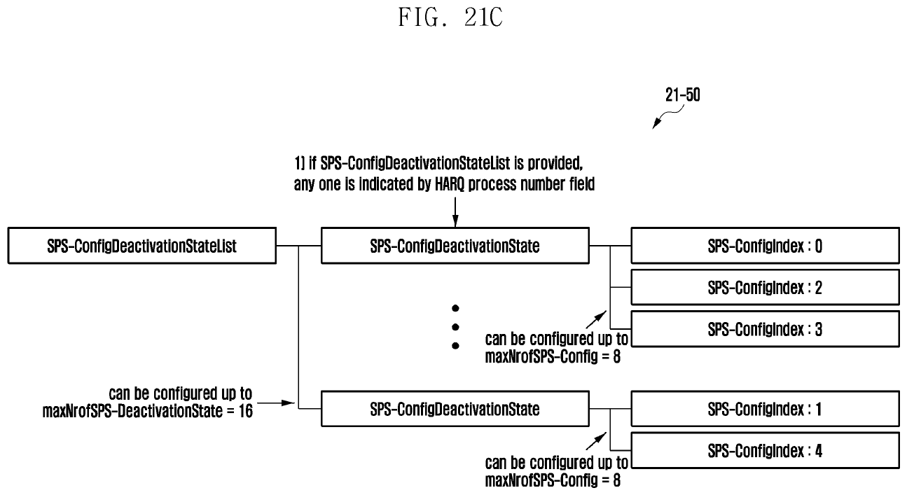

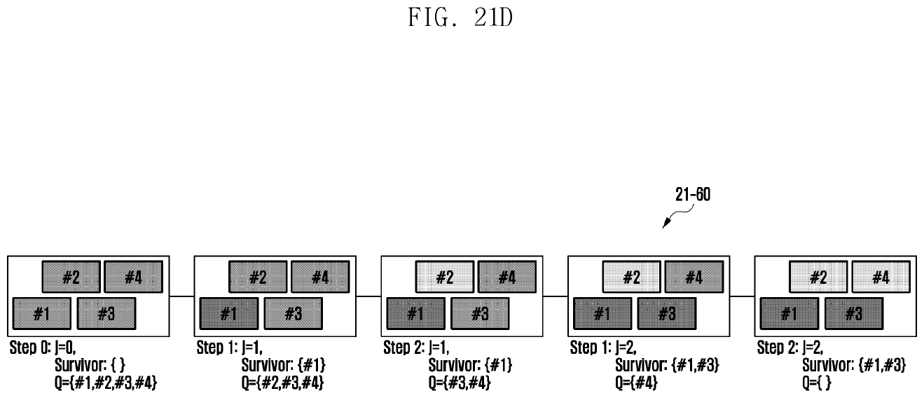

FIG. 21A is a diagram illustrating an enhanced PDSCH TCI state activation/deactivation MAC-CE structure. Definitions of respective fields in a corresponding MAC CE and configurable values for the respective fields are as follows.

Serving Cell ID: This field indicates the identity of the Serving Cell for which the MAC CE applies. The
length of the field is 5 bits. If the indicated Serving Cell is configured as part of a
simultaneousTCI-UpdateList1 or simultaneousTCI-UpdateList2 as specified in TS 38.331 [5], this MAC CE
applies to all the Serving Cells configured in the set simultaneousTCI-UpdateList1 or
simultaneousTCI-UpdateList2, respectively;
BWP ID: This field indicates a DL BWP for which the MAC CE applies as the codepoint of the DCI
bandwidth part indicator field as specified in TS 38.212 [9]. The length of the BWP ID field is 2 bits;
Cᵢ: This field indicates whether the octet containing TCI state ID_{i, 2} is present. If this field is set to “1”, the
octet containing TCI state ID_{i, 2} is present. If this field is set to “0”, the octet containing TCI state ID_{i, 2} is not
present;
TCI state ID_{i, j}: This field indicates the TCI state identified by TCI-StateId as specified in TS 38.331 [5],
where i is the index of the codepoint of the DCI Transmission configuration indication field as specified in TS
38.212 [9] and TCI state ID_{i, j} denotes the j-th TCI state indicated for the i-th codepoint in the DCI
Transmission Configuration Indication field. The TCI codepoint to which the TCI States are mapped is
determined by its ordinal position among all the TCI codepoints with sets of TCI state ID_{i, j} fields, i.e. the first
TCI codepoint with TCI state ID_{0, 1} and TCI state ID_{0, 2} shall be mapped to the codepoint value 0, the second
TCI codepoint with TCI state ID_{1, 1} and TCI state ID_{1, 2} shall be mapped to the codepoint value 1 and so on.
The TCI state ID_{i, 2} is optional based on the indication of the Ci field. The maximum number of activated TCI
codepoint is 8 and the maximum number of TCI states mapped to a TCI codepoint is 2.
R: Reserved bit, set to “0”.

In FIG. 21A, if the value of a field C₀ 21-05 is 1, a corresponding MAC-CE may include a field of TCI state ID_{0,2} 21-15 in addition to a field of TCI state ID_{0,1} 21-10. This may indicate that TCI state ID_{0,1} and TCI state ID_{0,2} are activated for the 0^{th} codepoint of the TCI state field included in DCI, and if the base station indicates the corresponding codepoint to the UE, the UE may receive an indication of two TCI states. If the value of a field C₀ 21-05 is 0, the corresponding MAC-CE may not include the field of TCI state ID_{0,2} 21-15, which indicates that one TCI state corresponding to TCI state ID_{0,1} is activated for the 0^{th} codepoint of the TCI state field included in DCI.

The configuration may be independent for each cell or each BWP. For example, there may be a maximum of two activated TCI states corresponding to one TCI codepoint in the PCell, whereas there may be a maximum of one activated TCI states corresponding to one TCI codepoint in a specific SCell. In this case, it may be considered that NC-JT transmission is constituted in the PCell, whereas NC-JT transmission is not constituted in the SCell described above.

With reference to the descriptions related to the PDCCH transmission/reception configuration and the transmission beam configuration above, since repetitive PDCCH transmission is not currently supported in Rel-15/16 NR, there may be difficulty in attaining the required reliability in a scenario requiring high reliability, such as URLLC. Meanwhile, the standardization of a method for improving the reception reliability of a PDCCH through the repetitive transmission of PDCCHs is in progress in Rel-17 FeMIMO. As a repetitive transmission method of a PDCCH, there may be a non-SFN method for repeatedly transmitting control resource sets connected to respective search spaces explicitly connected by higher layer signaling by separating the time or frequency resources through different TRPs, and a method for repeatedly transmitting the same in an SFN method by configuring a plurality of TCI states in one control resource set.

In the non-SFN method of the above methods, different control resource sets may be connected to a plurality of search spaces explicitly connected by higher layer signaling, or the same control resource set may be connected to all the search spaces. In this case, the method in which different control resource sets are connected may be regarded as a multi-TRP-based repetitive PDCCH transmission method in which the UE and the base station are transmitted in different TRPs for the respective control resource sets, which can be considered as a multiple TRP-based repetitive PDCCH transmission method. In addition, the method in which the same control resource set is connected to all the search spaces may be regarded as a single-TRP-based repetitive PDCCH transmission method in which the control resource sets are transmitted from the same TRP. Meanwhile, even in the case where different control resource sets are connected to a plurality of search spaces explicitly connected by higher layer signaling and where the respective control resource sets have different CORESETPoolIndex values, repetitive PDCCH transmission may be performed based on a plurality of corresponding control resource sets.

However, since all PDCCHs repeated during the repetitive PDCCH transmission must have the same bits, there may be a problem in which time and frequency resource allocation information, the antenna port fields, the TCI state fields, etc. indicated through all PDCCHs are the same because the values of all fields in the DCI transmitted from all the repeated PDCCHs are the same. The method for using a plurality of control resource sets having different CORESETPoolIndex values used in the above described multi-DCI-based multi-TRP transmission method has some restrictions on time and frequency resource allocation information, the antenna port field, and the TCI state field in the DCI while respective PDCCHs are able to schedule independent PDSCHs for an increase in the transmission capacity of PDSCHs based on the multi-TRP. For example, the time and frequency resource allocation information may entirely overlap, may partially overlap, or may not overlap in the time/frequency resources depending on the reported UE capability. As another example, the TCI field may apply a PDSCH TCI state activation/deactivation MAC-CE to the respective control resource set having differently configured CORESETPoolIndex values as described above, and the TCI state indicated by each PDCCH may be applied to the PDSCH scheduled by the corresponding PDCCH. As another example, the antenna port field may indicate DMRS ports in which the respective PDCCHs belong to different CDM groups, and the TCI state indicated through the TCI state field may be applied to each CDM group to which the DMRS port indicated by each PDCCH belongs. That is, two or more TCI states are unable to be applied to one CDM group. The disclosure will describe, in detail, how to interpret respective DCI fields, and the conditions for switching between whether or not to schedule a single PDSCH transmitted from a single TRP according to values of the DCI fields and whether or not schedule PDSCHs transmitted from a plurality of TRPs based on NC-JT for the case in which the control resource sets having different CORESETPoolIndex values are connected to the search spaces explicitly connected based on higher layer signaling, respectively, in repetitive PDCCH transmission.

In the following description of the disclosure, cells, transmission points, panels, beams, and/or transmission directions, which are differentiated through a higher layer/L1 parameter such as the TCI state, spatial relation information, or the like, or an indicator such as a cell ID, a TRP ID, a panel ID, or the like will be collectively referred to as a transmission reception point (TRP) for convenience. Accordingly, TRP may be appropriately replaced with one of the above terms in actual application.

Hereinafter, in the disclosure, the UE may determine whether or not to apply cooperative communication using various methods such as the case where the PDCCH(s) for allocating a PDSCH to which cooperative communication is applied has a specific format, the case where the PDCCH(s) for allocating a PDSCH to which the cooperative communication is applied includes a specific indicator indicating whether or not cooperative communication is applied, the case where the PDCCH(s) for allocating a PDSCH to which cooperative communication is applied is scrambled by a specific RNTI, the case where cooperative communication is assumed to be applied in a specific section indicated by a higher layer, or the like. Hereinafter, the case where the UE receives a PDSCH to which cooperative communication is applied based on conditions similar to the above will be referred to as an NC-JT case for convenience of description.

Hereinafter, embodiments of the disclosure will be described in detail with reference to the accompanying drawings. Hereinafter, the base station, as an entity performing resource allocation of a terminal, may be at least one of gNode B, gNB, eNode B, Node B, a base station (BS), a radio access unit, a base station controller, or a node on the network. The terminal may include a user equipment (UE), a mobile station (MS), a cellular phone, a smartphone, a computer, or a multimedia system capable of executing a communication function. Although an example embodiment will be described based on a 5G system by way of example, the example embodiment may also be applied to other communication systems having a similar technical background or channel type. For example, LTE or LTE-A mobile communication and mobile communication technology developed subsequent to 5G may be included therein. Accordingly, the example embodiment may be applied to other communication systems through some modifications without significantly departing from the scope of the disclosure as judged by those of ordinary skill in the art. A description of the disclosure may be applied to FDD and TDD systems.

In addition, in describing the disclosure, if it is determined that a detailed description of a related function or constitution may unnecessarily obscure the subject matter of the disclosure, the detailed description thereof will be omitted. In addition, the terms to be described later are defined in consideration of the functions in the disclosure, which may vary depending on intentions or customs of users and operators. Accordingly, the definitions thereof must be made based on the content throughout this specification.

Hereinafter, in describing the disclosure, higher layer signaling may be at least one of the following signaling methods or a combination thereof.
MIB (master information block)
SIB (system information block) or SIB X (X=1, 2, . . . )
RRC (radio resource control)
MAC (medium access control) CE (control element)

In addition, L1 signaling may be at least one of the signaling methods using the following physical layer channels or signaling, or a combination thereof.
PDCCH (physical downlink controlcChannel)
DCI (downlink control information)
UE-specific DCI
Group common DCI
common DCI
Scheduling DCI (e.g., DCI used for the purpose of scheduling downlink or uplink data)
Non-scheduling DCI (e.g., DCI not for the purpose of scheduling downlink or uplink data)
PUCCH (physical uplink control channel)
UCI (uplink control information)

Hereinafter, in the disclosure, determining the priority between A and B may be variously referred such as selecting one having a higher priority according to a predetermined priority rule and performing an operation corresponding thereto or omitting or dropping an operation on one having a lower priority.

Although the examples will be described through a plurality of embodiments in the disclosure, these are not independent and one or more embodiments may be applied simultaneously or in combination.

[Configuration on SPS PDSCH]

FIG. 21B is a diagram illustrating a terminal operation according to semi-persistent scheduling (SPS) configuration and configured grant configuration according to an example embodiment.

With reference to FIG. 21B, a network (or a base station) may transmit SPS configuration information (SPS-Config) to the UE for semi-persistent downlink transmission (DL SPS) to the UE, and at least one or more parameters may be configured in the UE through the SPS configuration information. The SPS configuration information may be included in an RRC message and transmitted. Specifically, the downlink BWP configuration (BWP-Downlink IE (Information Element)) included in the RRC message may include the BWP-DownlinkDedicated IE, and the BWP-DownlinkDedicated IE may include the SPS configuration information (SPS-Config. IE). The SPS may be configured for SpCell (Special Cell, PCell, PSCell) and SCell. That is, the SPS configuration information may be configured for each BWP. In addition, the network (or the base station) may be configured such that the SPS is configured only for a maximum of one cell in one cell group. In addition, a plurality of SPS configuration information may be included in one BWP of the one cell.

As shown in Table 31, the base station may configure a single SPS based on the SPS-Config configuration. Meanwhile, the base station may configure a plurality of SPSs based on sps-ConfigToAddModList-r16, sps-ConfigToReleaseList-r16, sps-ConfigDeactivationStateList-r16, and the like. The base station may add or modify one or more SPS configuration lists within one BWP by configuring sps-ConfigToAddModList-r16 to the UE, and release one or more SPS configuration lists configured in the UE by configuring sps-ConfigToReleaseList-r16 to the UE. The base station may indicate the UE to deactivate each state of at least one or more SPS configurations by configuring sps-ConfigDeactivationStateList-r16 to the UE.

TABLE 31
BWP-DownlinkDedicated ::= SEQUENCE {

| | | |
|---|---|---|
| pdcch-Config | SetupRelease { PDCCH-Config } | OPTIONAL, -- Need M |
| pdsch-Config | SetupRelease { PDSCH-Config } | OPTIONAL, -- Need M |
| sps-Config | SetupRelease { SPS-Config } | OPTIONAL, -- Need M |
| radioLinkMonitoringConfig | SetupRelease { RadioLinkMonitoringConfig } | OPTIONAL, -- Need M |

...,
[[

| | | |
|---|---|---|
| sps-ConfigToAddModList-r16 | SPS-ConfigToAddModList-r16 | OPTIONAL, -- Need N |
| sps-ConfigToReleaseList-r16 | SPS-ConfigToReleaseList-r16 | OPTIONAL, -- Need N |

sps-ConfigDeactivationStateList-r16 SPS-ConfigDeactivationStateList-r16 OPTIONAL, -- Need R
beamFailureRecoverySCellConfig-r16 SetupRelease {BeamFailureRecoverySCellConfig-r16} OPTIONAL, -- Cond SCellOnly

| | | |
|---|---|---|
| sl-PDCCH-Config-r16 | SetupRelease { PDCCH-Config } | OPTIONAL, -- Need M |
| sl-V2X-PDCCH-Config-r16 | SetupRelease { PDCCH-Config } | OPTIONAL -- Need M |

]]
}

| | |
|---|---|
| SPS-ConfigToAddModList-r16 | ::= SEQUENCE (SIZE (1..maxNrofSPS-Config-r16)) OF SPS-Config |
| SPS-ConfigToReleaseList-r16 | ::= SEQUENCE (SIZE (1..maxNrofSPS-Config-r16)) OF SPS-ConfigIndex-r16 |
| SPS-ConfigDeactivationState-r16 | ::= SEQUENCE (SIZE (1..maxNrofSPS-Config-r16)) OF SPS-ConfigIndex-r16 |
| SPS-ConfigDeactivationStateList-r16 | ::= SEQUENCE (SIZE (1..maxNrofSPS-DeactivationState)) OF SPS-ConfigDeactivationState-r16 |

In addition, the network (or base station) may transmit ConfiguredGrantConfig to the UE for semi-persistent uplink transmission to the UE, and at least one parameter may be configured in the UE through the ConfiguredGrantConfig information. The SPS configuration information may be included in an RRC message and transmitted. Specifically, the uplink BWP configuration (BWP-Uplink IE (Information Element)) included in the RRC message may include the BWP-UplinkDedicated IE, and the BWP-UplinkDedicated IE may include the ConfiguredGrantConfig IE. In addition, a plurality of ConfiguredGrant configuration information may be included in one BWP of one cell.

The ConfiguredGrantConfig may be configured to Type 1 or Type 2, Type 1 is controlled only by RRC signaling, and Type 2 (UL grant type 2) may be controlled through PDCCH addressed to RRC configuration and configured scheduling RNTI (CS-RNTI).

[SPS PDSCH Activation/Deactivation]

In the disclosure, as described above, ConfiguredGrant type 2 (UL grant type 2) that activates through the SPS configuration and CS-RNTI may be referred to as semi-persistent scheduling.

With reference to 21-20 in FIG. 21B, the base station may transmit configuration information related to semi-persistent scheduling (e.g., at least one of SPS configuration information and ConfiguredGrant configuration information) to the UE in operation 21-25. Period information may be included in the SPS configuration information or the ConfiguredGrant configuration information.

The UE may monitor the PDCCH in operation 21-30. Also, the UE may receive DCI transmitted through the PDCCH in operation 21-35. The UE may identify whether the SPS UL grant type 2 is activated through PDCCH validation based on the DCI. Thereafter, the UE receives data and performs decoding assuming that the configured resource is continuously transmitted.

Specifically, in the case where the RNTI used to scrambling the DCI transmitted through the PDCCH and the CRC of the DCI is the CS-RNTI, and where the HARQ process number and redundancy version fields included in the DCI satisfy Table 32-1 below, the UE and the base station may understand that DL SPS or UL grant type 2 is activated.

Specifically, in the case where the RNTI used to scrambling the DCI transmitted through the PDCCH and the CRC of the DCI is the CS-RNTI, where the value of the RV (Redundancy version) field included in the DCI is 0, and where the redundancy version field included in the DCI satisfies Table 32-2 below, the UE and the base station may understand that a plurality of DL SPSs or one of DL SPSs to which UL grant type 2 is configured or UL grant type 2 is activated.

Specifically, in the case where the RNTI used to scrambling the DCI transmitted through the PDCCH and the CRC of the DCI is the CS-RNTI, and where the HARQ process number, redundancy version, modulation and coding scheme and frequency domain resource assignment fields included in the DCI satisfy Table 32-3 below, the UE and the base station may understand that DL SPS or UL grant type 2 is deactivated.

Specifically, in the case where the RNTI used to scrambling the DCI transmitted through the PDCCH and the CRC of the DCI is the CS-RNTI, and where the redundancy version, modulation and coding scheme and frequency domain resource assignment fields included in the DCI satisfy Table 32-4 below, the UE and the base station may understand that a plurality of DL SPSs or one of DL SPSs to which UL grant type 2 is configured or UL grant type 2 is deactivated.

Accordingly, the UE may receive data from the base station or transmit data to the base station according to semi-persistently scheduled resources.

TABLE 32-1

| | DCI format | DCI format | DCI format |
|---|---|---|---|
| | 0_0/0_1/0_2 | 1_0/1_2 | 1_1 |
| HARQ process number | set to all ‘0’s | set to all ‘0’s | set to all ‘0’s |
| Redundancy version | set to all ‘0’s | set to all ‘0’s | For the enabled |
| | | | transport block: |
| | | | set to all ‘0’s |

TABLE 32-2

| | DCI format | DCI format | DCI format |
|---|---|---|---|
| | 0_0/0_1/0_2 | 1_0/1_2 | 1_1 |
| Redundancy version | set to all ‘0’s | set to all ‘0’s | For the enabled |
| | | | transport block: |
| | | | set to all ‘0’s |

TABLE 32-3

| | DCI format | DCI format |
|---|---|---|
| | 0_0/0_1/0_2 | 1_0/1_1/1_2 |
| HARQ process | set to all ‘0’s | set to all ‘0’s |
| number | | |
| Redundancy version | set to all ‘0’s | set to all ‘0’s |
| Modulation and | set to all ‘1’s | set to all ‘1’s |
| coding scheme | | |
| Frequency domain | set to all ‘0’s for FDRA | set to all ‘0’s for FDRA |
| resource assignment | Type 2 with μ = 1 | Type 0 or for |
| | set to all ‘1’s, otherwise | dynamicSwitch |
| | | set to all ‘1’s for FDRA |
| | | Type 1 |

TABLE 32-4

| | DCI format | DCI format |
|---|---|---|
| | 0_0/0_1/0_2 | 1_0/1_1/1_2 |
| Redundancy version | set to all ‘0’s | set to all ‘0’s |
| Modulation and | set to all ‘1’s | set to all ‘1’s |
| coding scheme | | |
| Frequency domain | set to all ‘0’s for FDRA | set to all ‘0’s for FDRA |
| resource assignment | Type 2 with μ = 1 | Type 0 or for |
| | set to all ‘1’s, otherwise | dynamicSwitch |
| | | set to all ‘1’s for FDRA |
| | | Type 1 |

[Deactivation of Multiple SPSs]

In the disclosure, an operation of deactivating a ConfiguredGrant type 2 (UL grant type 2) activated through the plurality of SPS configurations and CS-RNTI or SPS-based PDSCH will be described.

FIG. 21C is a diagram illustrating a method 21-50 for deactivating ConfiguredGrant type2 (UL grant type 2) or SPS-based PDSCH according to an example embodiment.

As an example, with reference to FIG. 21C, if a plurality of SPS-based PDSCHs or UL grant type 2 PUSCH(s) are configured by the base station and information related to ConfiguredGrantConfigType2 DeactivationStateList or SPS-ConfigDeactivationStateList is configured through a higher layer, a value of the HARQ process number field in the DCI format received by the UE may indicate an entry value corresponding to scheduling for releasing at least one UL grant Type 2 PUSCH or SPS-based PDSCH configuration.

As another example, if a plurality of SPS-based PDSCHs or UL grant type 2 PUSCH(s) are configured by the base station and information related to ConfiguredGrantConfigType2 DeactivationStateList or sps-ConfigDeactivationStateList is not configured through the higher layer, the value of HARQ process number field in the DCI format received by the UE may indicate to release the UL grant Type 2 PUSCH or SPS-based PDSCH configuration having the same value configured in ConfiguredGrantConfigIndex or sps-ConfigIndex, respectively.

In this case, up to 16 SPS-ConfigDeactivationStates included in SPS-ConfigDeactivationStateList may be configured, and up to 8 SPS-ConfigIndexs included in SPS-ConfigDeactivationState may be configured. However, the number that may be configured to the maximum is only an example embodiment, and may be changed based on configurations of the base station or a predefined value.

[Dropping Rule for Overlapped SPS PDSCH]

FIG. 21D is a diagram illustrating a method 21-60 for determining a PDSCH for data reception in the case where a plurality of SPS PDSCH resources in a slot overlap according to an example embodiment.

If there are a plurality of PDSCH resources that do not correspond to one PDCCH transmission in a single slot in one serving cell, the UE may receive one or more PDSCH(s) without corresponding PDCCH transmission in the slot as shown in Table 33 described below after overlapping of at least one symbol within a slot indicated as uplink by tdd-UL-DL-ConfigurationCommon or tdd-UL-DL-ConfigurationDedicated is resolved.

TABLE 33
Principle of not performing PDSCH reception based on SPS that overlaps with resources
Step 0: set j = 0, where j is the number of selected PDSCH(s) for decoding. Q is the set of activated
PDSCHs without corresponding PDCCH transmissions within the slot.
Step 1: A UE receives one PDSCH with the lowest configured sps-ConfigIndex within Q, set
j = j + 1. Designate the received PDSCH as survivor PDSCH.
Step 2: The survivor PDSCH in step 1 and any other PDSCH(s) overlapping (even partially) with
the survivor PDSCH in step 1 are excluded from Q.
Step 3: Repeat step 1 and 2 until Q is empty or j is equal to the number of unicast PDSCHs in a
slot supported by the UE.

As an example, with reference to FIG. 21D, the base station may configure four SPS-based PDSCHs (hereinafter referred to as SPS PDSCHs) to the UE. The UE sets j=0 in the step before performing decoding and determines (step 0) the set of activated PDSCHs, Q={PDSCH #1, PDSCH #2, PDSCH #3, PDSCH #4} and survivor={ }. Thereafter, in the step of decoding PDSCH #1 having the lowest index, the UE may designate PDSCH #1 having the lowest index as the survivor PDSCH (step 1). Accordingly, it may be determined that Q={PDSCH #2, PDSCH #3, PDSCH #4} and survivor={PDSCH #1}. Thereafter, the UE may identify PDSCH #2 resources overlapping with PDSCH #1 and exclude PDSCH #2 from the Q (step 2). Accordingly, it may be determined that Q={PDSCH #3, PDSCH #4} and survivor={PDSCH #1}. Thereafter, the UE may decode PDSCH #3 having the lowest index in Q after the first PDSCH #1 allocated resource is terminated. The UE may designate the PDSCH #3 as a survivor PDSCH (step 3). Accordingly, it may be determined that Q={PDSCH #4} and survivor={PDSCH #1, PDSCH #3}. Thereafter, the UE may identify PDSCH #4 resources overlapping with PDSCH #3 and exclude PDSCH #4 from the Q (step 3). Accordingly, it may be determined that Q={ } and survivor={PDSCH #1, PDSCH #3}. That is, the base station and the UE may understand that non-overlapping SPS-based PDSCH(s) are transmitted and received according to the above-described procedure.

### First Embodiment: Multi-TRP-Based Repetitive PDCCH Transmission Method

As an example embodiment, a repetitive PDCCH transmission method in consideration of multiple TRPs will be described. There may be various repetitive PDCCH transmission methods in consideration of multiple TRPs depending on how to apply respective TCI states, which are to be applied when transmitting PDCCHs in respective TRPs, to the above-described various parameters used in PDCCH transmission. For example, various parameters used in PDCCH transmission to which different TCI states are applied may include CCE, PDCCH candidate groups, control resource sets, search spaces, and the like. During repetitive PDCCH transmission in consideration of multiple TRPs, soft combining, selection, and the like may be considered as a reception method of the UE.

There may be the methods of repetitive PDCCH transmission through multiple TRPs as follows, and the base station may configure, for the UE, at least one of the following methods through higher layer signaling, indicate the same through L1 signaling, or configure or indicate the same through a combination of the higher layer signaling and L1 signaling.

[Method 1-1] Repetitive Transmission Method of a Plurality of PDCCHs Having the Same Payload

Method 1-1 is a method for repeatedly transmitting a plurality of pieces of control information having the same DCI format and payload. Each piece of the above-described control information may indicate information for scheduling repetitively transmitted PDSCHs, for example, {PDSCH #1, PDSCH #2, . . . , PDSCH #Y} repetitively transmitted over a plurality of slots. The fact that the payloads of respective control information repetitively transmitted are the same may be expressed that PDSCH scheduling information of the respective control information (for example, the number of repetitive PDSCH transmissions, time domain PDSCH resource allocation information, that is, the slot offset (K_0) between control information and PDSCH #1 and the number of PDSCH symbols and the like, frequency domain PDSCH resource allocation information, DMRS port allocation information, PDSCH-to-HARQ-ACK timing, PUCCH resource indicators, and the like) is the same. The UE may improve the reception reliability of control information by soft combining repetitive transmission control information having the same payload.

For the soft combining described above, the UE needs to know in advance the location of the resources of control information to be repetitively transmitted, the number of repetitive transmissions, and the like. To this end, the base station may indicate in advance the resource configuration of the time domain, frequency domain, and spatial domain of the repetitive transmission control information described above.

In the case where control information is repetitively transmitted in the time domain, the control information may be repetitively transmitted over different CORESETs, may be repetitively transmitted over different search space sets in one CORESET, or may be repetitively transmitted over different PDCCH monitoring occasions in one CORESET or one search space set. The unit (CORESET unit, search space set unit, or PDCCH monitoring occasion unit) of the resource repetitively transmitted in the time domain, and the location (PDCCH candidate index, etc.) of the repetitive transmission resource may be indicated through a higher layer configuration of the base station and the like. In this case, the number of repetitive PDCCH transmissions and/or a list and transmission patterns of TRPs participating in repetitive transmission may be explicitly indicated, and higher layer indication, MAC-CE/L1 signaling, or the like may be used as the explicit indication method. The list of TRPs may be indicated in the form of TCI states or QCL assumption described above.

In the case where control information is repetitively transmitted in the frequency domain, the control information may be repetitively transmitted over different CORESETs, may be repetitively transmitted over different PDCCH candidates in one CORESET, or may be repetitively transmitted by each CCE. The unit of the resource repetitively transmitted in the frequency domain and the location of the repetitively transmitted resource may be indicated through a higher layer configuration of the base station and the like. In addition, the number of repetitive transmissions and/or a list and transmission patterns of TRPs participating in repetitive transmission may be explicitly indicated, and higher layer indication, MAC-CE/L1 signaling, or the like may be used as the explicit indication method. The list of TRPs may be indicated in the form of TCI states or QCL assumption described above.

In the case where control information is repetitively transmitted in the spatial domain, the control information may be repetitively transmitted over different CORESETs or may be repetitively transmission by configuring two or more TCI states in one CORESET.

As an example embodiment, a method in which the base station repetitively transmits PDCCHs will be described. DCI including scheduling information on PUSCHs or PDSCHs may be transmitted from the base station to the UE through PDCCHs in the wireless communication system.

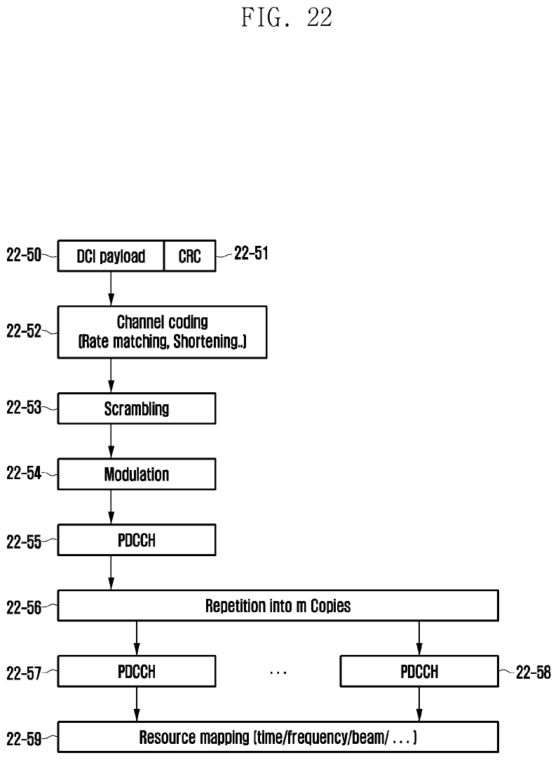

FIG. 22 is a diagram illustrating a process of producing a PDCCH that is repetitively transmitted through two TRPs according to an example embodiment.

The base station may produce DCI 22-50, CRC may be attached to a DCI payload 22-51. Thereafter, the base station may perform channel coding 22-52 and produce a PDCCH 22-55 through scrambling 22-53 and modulation 22-54. Thereafter, the base station may copy the produced PDCCH a plurality of times 22-56, 22-57, and 22-58 and transmit the same using a specific resource (e.g., time, frequency, transmission beam, etc.) 22-59. That is, all the coded bits for the PDCCHs repetitively transmitted in the respective TRPs may be the same. In order for the same coded bit described above, the information values for each DCI field in the PDCCH may also be configured to be the same. For example, all fields (TDRA, FDRA, TCI, antenna ports, . . . ) included in DCI information may be configured to have the same value. Although the same value may be generally interpreted as one indication, it may be interpreted as a plurality of indications in the case where a plurality of (e.g., two) values is included by a special configuration or in the case where it corresponds thereto as described above. A detailed description thereof will be described below.

For example, as shown in FIG. 22, in the case where the base station repetitively transmits a PDCCH twice (e.g., m=2), the base station may repetitively transmit the PDCCH based on the same or different beams in terms of the spatial domain by mapping PDCCHs to TRP A and TRP B one by one. In this case, the base station may perform repetitive PDCCH transmission, based on CORESETs respectively connected to two search spaces explicitly connected to each other by higher layer signaling, perform repetitive PDCCH transmission, based on a single TRP, in the case where IDs of the CORESETs connected to the search spaces are the same or where the TCI states of the CORESETs are the same, and perform repetitive PDCCH transmission, based on multiple TRPs, in the case where IDs of the CORESETs connected to the search spaces are different from each other or where the TCI states of the CORESETs are different from each other. In the case where the base station repetitively transmits the PDCCH four times, the base station may map two PDCCHs to TRP A and TRP B, respectively, and two PDCCHs of each TRP may be transmitted separately in the time domain. The repetitive transmission of the PDCCHs separated in the time domain may be repeated in time units of slots, sub-slots, or mini-slots.

However, the method described above is merely an example, and the disclosure is not limited thereto. The UE and the base station in the disclosure may consider the following method for the PDCCH repetition operation described above.
PDCCH repetition in terms of a time/frequency/spatial domain in the same CORESET and in the same slot.
PDCCH repetition in terms of a time/frequency/spatial domain between different slots in the same CORESET.
PDCCH repetition in terms of a time/frequency/spatial domain between different CORESETs in the same slot.
PDCCH repetition in terms of a time/frequency/spatial domain between different CORESETs and between different slots.

In addition, if CORESETPoolIndex is configured, CORESETPoolIndex may be respectively considered in addition to the CORESET described above. In addition, the number of PDCCH repetitions may increase independently, and the methods described above may be simultaneously considered in combination according thereto.

The base station may preconfigure information about the domain through which the PDCCH is repetitively transmitted for the UE through an RRC message. For example, in the case of repetitive PDCCH transmission in terms of the time domain, the base station may preconfigure, for the UE, information about any one of the slot-based, sub-slot-based, or mini-slot-based time unit by which repetition is conducted. In the case of repetitive PDCCH transmission in terms of the frequency domain, the base station may preconfigure, for the UE, information about any one of the CORESET, the bandwidth part (BWP), or the component carrier (CC) by which repetition is conducted. In the case of repetitive PDCCH transmission in terms of the spatial domain, the base station may preconfigure, for the UE, information related to beams for repetitive PDCCH transmission through configuration for each QCL type. Alternatively, the base station may combine the information listed above and transmit the same to the UE through an RRC message. Accordingly, the base station may repetitively transmit PDCCHs according to information preconfigured through an RRC message, and the UE may repetitively receive PDCCHs according to the information preconfigured through the RRC message.

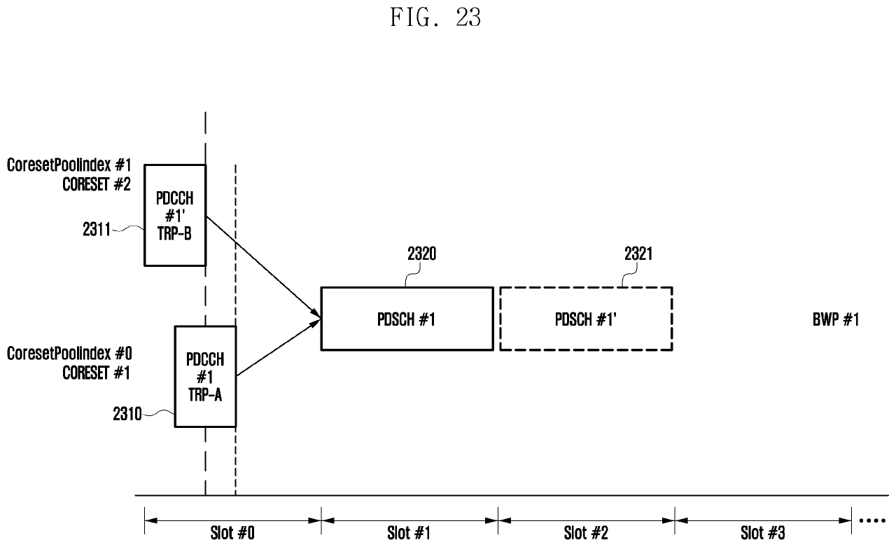

FIG. 23 is a diagram illustrating a method for a base station to repeatedly transmit PDCCHs according to an example embodiment.

Respective PDCCHs (e.g., PDCCH #1 2310 and PDCCH #1′ 2311) repetitively transmitted from a plurality of TRPs (e.g., TRP-A and TRP-B) may include at least partially or entirely the same DCI. In the case where the same DCI is included, the repetitively transmitted PDCCHs may schedule the same PDSCH resource. Here, scheduling of the same PDSCH resource (e.g., it may indicate only PDSCH #1 in the case of singe-PDSCH transmission and indicate PDSCH #1 2320 to PDSCH #1′ 2321 in the case of repetitive PDSCH transmission) may indicate that at least the respective bit values included in the DCI fields are the same. If information for PDSCH resource scheduling among the same DCI-related information is the same, the UE may determine that the PDSCHs of the same location at least in time and frequency resources are to be received. In this case, as a method for configuring PDCCHs repetitively transmitted from a plurality of TRPs, the base station may configure different CORESETPoolIndex values (e.g., CORESETPoolIndexes #0 and CORESETPoolIndexes #1) for the UE. Meanwhile, in the disclosure, a case in which PDCCHs through which DCI is transmitted is located in the same slot is described as an example, but the disclosure is not limited thereto, and DCI transmitted through PDCCHs in different slots may include the same bit information. and PDSCHs in the same location may be scheduled. For example, PDCCHs are located in different slots, and PDSCHs may be scheduled by the same DCI information from each PDCCH located in different slots.

[Method 1-2] Method for Repetitively Transmitting a Plurality of Pieces of Control Information in which DCI Formats and/or Payloads May be Different

Method 1-2 is for repetitively transmitting a plurality of pieces of control information in which DCI formats and/or payloads may be different. The control information may schedule the repetitively transmitted PDSCHs, and the number of repetitive PDSCH transmissions indicated by the control information may be different between the control information. For example, PDCCH #1 may indicate information for scheduling {PDSCH #1, PDSCH #2, . . . , PDSCH #Y}, PDCCH #2 may indicate information for scheduling {PDSCH #2, . . . , PDSCH #Y}, . . . , and PDCCH #X may indicate information for scheduling {PDSCH Y}. The repetitive control information transmission method as described above has an advantage of reducing the total delay required for repetitive control information and PDSCH transmission, compared to Method 1-1. However, in this method, since the payloads of the respective control information repetitively transmitted may be different, soft combining of the repetitively transmitted control information is impossible, which may lower the reliability, compared to Method 1-1.

In Method 1-2 above, the UE may not need to know in advance the resource location of control information to be repetitively transmitted, the number of repetitive transmissions, and the like, and the UE may independently decode and process each piece of control information repetitively transmitted. In the case where the UE decodes a plurality pieces of repetitive transmission control information for scheduling the same PDSCH, the UE may process only the first repetitive transmission control information and ignore the second repetitive transmission control information and subsequent repetitive transmission control information thereto. Alternatively, the resource location of the control information to be repetitively transmitted and the number of repetitive transmissions may be indicated in advance, and the indication method may be the same as the Method 1 described above.

[Method 1-3] Method for Repetitively Transmitting Each of a Plurality of Pieces of Control Information in which DCI Formats and/or Payloads May be Different

Method 1-3 is for repetitively transmitting each of the plurality of pieces of control information in which DCI formats and/or payloads may be different. In this case, the respective pieces of repetitively transmitted control information have the same DCI format and payload. The Method 1-2 is not able to perform soft combining of a plurality of pieces of control information, thereby providing lower reliability than Method 1-1, and in Method 1-1, the total delay required for repetitive control information and PDSCH transmission may increase. Method 1-3, using the advantages of Method 1-1 and Method 1-2, may transmit control information with reliability higher than that in Method 1-2 while reducing the total delay required for repetitive control information and PDSCH transmission, compared to Method 1-1.

In Method 1-3, soft combining in Method 1-1 and individual decoding in Method 1-2 may be used to decode and soft-combine the repetitively transmitted control information. For example, the first transmitted control information among a plurality of pieces of repetitively transmitted control information in which DCI formats and/or payloads may be different may be decoded according to Method 1-2 above, and repetitive transmission for the decoded control information may be soft-combined according to Method 1-1 above.

Meanwhile, the base station may select and configure one of Method 1-1, Method 1-2, or Method 1-3 above for repetitive control information transmission. The base station may explicitly indicate the repetitive control information transmission method for the UE through higher layer signaling. Alternatively, the repetitive control information transmission method may be indicated in combination with other configuration information. For example, a higher layer configuration indicating the repetitive PDSCH transmission method may be combined with the repetitive control information transmission indication. In the case where a PDSCH is indicated to be repetitively transmitted by an FDM scheme, control information may be interpreted to be repetitively transmitted only by Method 1-1 because there is no delay reduction effect due to Method 1-2 in the repetitive PDSCH transmission by the FDM scheme. For similar reason, in the case where a PDSCH is indicated to be repetitively transmitted by an intra-slot TDM scheme, control information may be interpreted to be repetitively transmitted by Method 1-1. On the other hand, in the case where a PDSCH is indicated to be repetitively transmitted by an inter-slot TDM scheme, Method 1-1, Method 1-2, or Method 1-3 above for repetitive control information transmission may be selected through higher layer signaling or L1 signaling.

Meanwhile, the base station may explicitly indicate a repetitive control information transmission unit to the UE through a configuration such a higher layer and the like. Alternatively, the repetitive control information transmission unit may be indicated in combination with other configuration information. For example, a higher layer configuration indicating the repetitive PDSCH transmission method may be combined with the repetitive control information transmission unit. In the case where a PDSCH is indicated to be repetitively transmitted by the FDM scheme, control information may be interpreted to be repetitively transmitted by FDM or SDM because there is no delay reduction effect due to repetitive PDSCH transmission in the FDM scheme if the control information is repetitively transmitted by the inter-slot TDM scheme or the like. For similar reason, in the case where a PDSCH is indicated to be repetitively transmitted by the intra-slot TDM scheme, control information may be interpreted to be repetitively transmitted by the intra-slot TDM, FDM, or SDM. On the other hand, in the case where a PDSCH is indicated to be repetitively transmitted by the inter-slot TDM scheme, the inter-slot TDM, intra-slot TDM, FDM, or SDM may be selected through the higher layer signaling or the like so as to repetitively transmit the control information.

[Method 1-4] PDCCH Transmission Method of Applying Respective TCI States to Different CCEs in the Same PDCCH Candidates

Methods 1-4 may apply different TCI states indicating transmission from multiple TRPs to different CCEs in the PDCCH candidates in order to improve reception performance of a PDCCH without repetitive PDCCH transmission and transmit the same. Although this method is not intended for repetitive transmission of PDCCHs, since different TCI states of the respective TRPs are applied to different CCEs in the PDCCH candidates to perform transmission, it is possible to obtain spatial diversity in the PDCCH candidates. The different CCEs to which different TCI states are applied may be separated in time or frequency dimension, and the UE may need to know in advance the location of resources to which the different TCI states are applied. The UE may receive different CCEs to which different TCI states are applied in the same PDCCH candidate and decode the same independently or at once.

[Method 1-5] PDCCH Transmission Method of Applying a Plurality of TCI States to all CCEs in the Same PDCCH Candidate (SFN Method)

Method 1-5 may apply a plurality of TCI states to all CCEs in the PDCCH candidate and perform transmission by the SFN method in order to improve reception performance of a PDCCH without repetitive PDCCH transmission. Although this method is not intended for repetitive transmission of PDCCHs, it is possible to obtain spatial diversity through SFN transmission at the same CCE location within the PDCCH candidate. The UE may receive CCEs of the same location to which different TCI states are applied in the same PDCCH candidate and decode the same independently or at once using some or all of the plurality of TCI states.

### Second Embodiment: UE Capability Report Related to Soft Combining During Repetitive PDCCH Transmission

The UE may report UE capability related to soft combining during repetitive PDCCH transmission to the base station, and several methods may be provided for this. Specific methods may be as follows.

[UE capability reporting method 1] The UE may report only on whether soft combining is possible or impossible in repetitive PDCCH transmission as UE capability to the base station.

For example, if the UE reports information stating that soft combining is possible in repetitive PDCCH transmission as UE capability to the base station, the base station may most flexibly determine the possibility of soft combining of the UE (e.g., may determine that the UE is able to perform soft combining at the LLR level) and may notify the UE of the repetitive PDCCH transmission-related configuration as flexibly as possible during configuration related to PDCCH transmission. In this case, as an example related to PDCCH repetition configuration, assuming that the UE is able to perform soft combining between control resource sets or search spaces having different configurations, soft combining between PDCCH candidates in the same aggregation level, or soft combining between PDCCH candidates in different aggregation levels, the base station may notify the UE of the corresponding configuration.

As another example, if the UE reports information stating that soft combining is possible in repetitive PDCCH transmission to the base station through the UE capability, the base station may most conservatively determine the level of soft combining of the UE (e.g., may determine that UE is able to perform soft combining at the OFDM symbol level) and notify the UE of the repetitive PDCCH transmission-related configuration as restrictedly as possible during configuration related to PDCCH transmission. In this case, as an example related to the PDCCH repetition configuration, assuming that the UE is able to perform soft combining between a plurality of control resource sets having the same configuration or soft combining between PDCCH candidates in the same aggregation level, the base station may notify the UE of the corresponding configuration.

[UE capability reporting method 2] In order to express in more detail the operation of soft combining possible in the UE as UE capability, compared to UE capability reporting method 1 described above, the UE may report the possibility of soft combining in repetitive PDCCH transmission by levels as UE capability to the base station. That is, the UE may identify the signal level to which soft combining is able to be applied in repetitive PDCCH transmission, among the signal levels produced in the reception operation process of the UE, and the UE may report such information as UE capability to the base station. For example, the UE may inform that soft combining is possible at the OFDM symbol level, that soft combining is possible at the modulation symbol level, and that soft combining is possible at the LLR level, as a signal level to which soft combining may be applied. According to each signal level reported by the UE, the base station may send a notification of an appropriate configuration according to the reported UE capability such that the UE may perform soft combining.

[UE capability reporting method 3] The UE may transmit, to the base station, the restrictions necessary for soft combining by the UE during the repetitive PDCCH transmission as UE capability. For example, the UE may report to the base station that respective control resource sets including two repeated PDCCHs must have the same configuration. As another example, the UE may report to the base station that two repeated PDCCH candidates must have at least the same aggregation level.

[UE capability reporting method 4] In the case where the UE receives repetitively transmitted PDCCHs from the base station, the UE may report a method supporting the repetitive PDCCH transmission as UE capability. For example, the UE may report to the base station that Method 1-5 (SFN transmission method) is supported. As another example, the UE may report to the base station that the intra-slot TDM method, the inter-slot TDM method, or the FDM method among Method 1-1 (the method of repeatedly transmitting a plurality of PDCCHs having the same payload) are supported. In particular, in the case of TDM, the UE may report a maximum value of the time interval between two repeated PDCCHs to the base station. For example, if the UE reports the maximum value of the time interval between two repeated PDCCHs as 4 OFDM symbols, the base station may have to adjust the time interval between two repeated PDCCHs to 4 OFDM symbols or less, based on the information, in the case of performing TDM-based repetitive PDCCH transmission to the UE.

The above-described UE capability reporting methods may be configured as a combination of two or more thereof in actual application. For example, the UE may report that two repeated PDCCH candidates must have at least the same aggregation level by [UE capability reporting method 3] while reporting that soft combining is possible at the LLR level by [UE capability reporting method 2], support the repetitive PDCCH transmission through TDM by [UE capability reporting method 4], and report that the maximum value of the time interval between two repeated PDCCHs is 4 OFDM symbols. In addition, although various applications based on a combination of UE capability reporting methods are possible, a detailed description thereof will be omitted.

### Third Embodiment: Configuration Method in Relation to Repetitive PDCCH Transmission and Explicit Connectivity

As an example embodiment, a method for configuring repetitive PDCCH transmission to enable soft combining during the repetitive PDCCH transmission will be described. In the case of performing repetitive PDCCH transmission to the UE based on Method 1-1 (the method of repetitively transmitting a plurality of PDCCHs having the same payload) among various repetitive PDCCH transmission methods, in order to reduce the number of blind decodings in consideration of whether or not the UE is able to perform soft combining, the base station may configure information indicating that there is an explicit connection (linkage or association) between the repeated PDCCH candidates through higher layer signaling, indicate the same through L1 signaling, or configure or indicate the same through a combination of the higher layer signaling and the L1 signaling. More specifically, various connection methods may be provided as follows.

There may be various methods for repetitive PDCCH transmission and explicit connectivity-related configuration through higher layer signaling as follows.

[PDCCH repetition configuration method 1] the case where configuration information exists in the higher layer signaling, PDCCH-Config

For repetitive PDCCH transmission and explicit connectivity-related configuration, the base station may configure PDCCH-repetition-config in the higher layer signaling, PDCCH-config, for the UE, and PDCCH-repetition-config may include the following information.
A repetitive PDCCH transmission scheme-one of TDM, FDM, and SFN
Control resource set-search space combination(s) to be used in repetitive PDCCH transmission
▪ Control resource set index(es)—OPTIONAL
▪ Search space index(es)—OPTIONAL
Aggregation level(s) for explicit connectivity—OPTIONAL
PDCCH candidate index(es) for explicit connectivity—OPTIONAL
Frequency resources for explicit connectivity—OPTIONAL

Based on the above information, the base station may configure repetitive PDCCH transmission through higher layer signaling for the UE. For example, if the repetitive PDCCH transmission scheme is configured as SFN, if the control resource set index, as a control resource set-search space combination to be used in repetitive PDCCH transmission, is configured as 1, and if the search space index is not configured, the UE may expect that the PDCCH will be repetitively transmitted through Method 1-5 (SFN transmission method) in the control resource set having index 1. In this case, for the configured control resource set, one or more different TCI states may be configured, the TCI state may be configured through higher layer signaling, indicated through L1 signaling or MAC-CE signaling, or configured or indicated through a combination of the higher layer signaling and the L1 signaling or the MAC-CE signaling. In addition, if the repetitive PDCCH transmission scheme is configured as SFN, the UE may not expect that a search space index will be configured in the control resource set-search space combination to be used in repetitive PDCCH transmission.

As another example, if the repetitive PDCCH transmission scheme is configured as TDM or FDM, and if a total of two control resource set-search space combinations to be used in repetitive PDCCH transmission are configured such that control resource set index 1 and search space index 1 are configured for a first combination and such that control resource set index 2 and search space index 2 are configured for a second combination, the UE may expect that repetitive PDCCH transmission will be performed by the TDM or FDM scheme through Method 1-1 using the two control resource sets-search space combinations. In this case, for the respective control resource sets, a plurality of TCI states that are the same or different from each other may be configured, the TC state may be configured through higher layer signaling, indicated through L1 signaling or MAC-CE signaling, or configured or indicated through a combination of the higher layer signaling and the L1 signaling or the MAC-CE signaling.

In addition, if the repetitive PDCCH transmission scheme is configured as TDM or FDM, the UE may expect that up to two control resource set-search space combinations to be used in repetitive PDCCH transmission will be configured and that all control resource set and search space indexes will be configured in the respective combinations.

In addition, the values of the five pieces of information may be updated based on a MAC-CE without RRC reconfiguration. If the base station does not configure PDCCH-repetition-config for the UE, the UE may expect single-PDCCH transmission, instead of repetitive PDCCH transmission. All of the above-described aggregation level, PDCCH candidate index, and frequency resources for explicit connectivity may not be configured, or at least one thereof may be configured according to an explicit connection method to be described later.

[PDCCH repetition configuration method 2] the case where configuration information exists in the higher layer signaling for a search space

The base station may add higher layer signaling for repetitive PDCCH transmission to the higher layer signaling, searchSpace, for a search space, and notify the UE of the same. For example, a parameter, repetition, which is additional higher layer signaling, may be configured as on or off in the higher layer signaling, searchSpace, such that a corresponding search space is used for repetitive transmission. There may be one or two search spaces in which repetition is configured as on in each bandwidth part. For example, if searchSpaceId is configured as 1, if controlResourceSetId is configured as 1, and if repetition is configured as on in the higher layer signaling, searchSpace, for search space index 1, the UE may expect that repetitive PDCCH transmission will be performed according to Method 1-5 (SFN transmission method) in control resource set 1 connected to search space 1.

As another example, if searchSpaceId is configured as 1, if controlResourceSetId is configured as 1, and if repetition is configured as on in the higher layer signaling, searchSpace, for search space index 1, and if searchSpaceId is configured as 2, if controlResourceSetId is configured as 2, and if repetition is configured as on in the higher layer signaling, searchSpace, for search space index 2, the UE may recognize that repetitive PDCCH transmission is to be performed by TDM or FDM using Method 1-1 between a combination of control resource set 1+search space 1 and a combination of control resource set 2+search space 2. TDM or FDM may be selected according to the time and frequency configuration through higher layer signaling of control resource sets 1 and 2 and search spaces 1 and 2. In addition, the aggregation level or PDCCH candidate indexes for explicit connectivity specified in the above [PDCCH repetition configuration method 1] may be configured in the higher layer signaling for a search space in which repetition is configured as on, and neither may be configured, either one may be configured, or both may be configured according to an explicit connection method to be described later.

### Fourth Embodiment: The Case where Different CORESETPoolIndex Values are Configured for CORESETs Respectively Connected to Explicitly Connected Search Spaces During Repetitive PDCCH Transmission

According to an example embodiment, the UE may consider the case where repetitive PDCCH transmission is received from the base station in a non-SFN manner, that is, the case where different CORESETPoolIndex values are configured in the control resource sets respectively connected to the explicitly connected search spaces. As described above, since the repetitively transmitted PDCCHs must have the same value for the same DCI field (e.g., a time/frequency resource assignment field, an antenna port field, a TCI state field, an HARQ process ID field (or it may also be called HARQ process number field), an NDI field, etc.), there may be a problem in which time and frequency resource allocation information, the antenna port fields, the TCI state fields, the HARQ process ID fields, the NDI fields, etc. indicated through all the PDCCHs are the same. In the following detailed embodiment will describe a method of steadily scheduling a single PDSCH, steadily scheduling a plurality of PDSCHs based on NC-JT, or switching between scheduling of a single PDSCH and scheduling of a plurality of PDSCHs based on NC-JT, based on higher layer signaling, L1 signaling, or a combination of higher layer signaling and L1 signaling in the case where different CORESETPoolIndex values are configured in control resource sets respectively connected to explicitly connected search spaces in repetitive PDCCH transmission.

### Fourth-1 Embodiment: Single-PDSCH Scheduling Method for Repetitive PDCCH Transmission Based on CORESETs Having Different CORESETPoolIndex Values

According to an example embodiment, in the case where the UE receives, from the base station, configuration information of search spaces to which control resource sets in which different CORESETPoolIndex values are configured are explicitly connected, and receives repetitively transmitted PDCCHs based on the same, the UE may understand that a single PDSCH is to be scheduled from the base station. In this case, the UE may respectively apply PDSCH TCI state activation/deactivation MAC-CEs to the control resource sets in which different CORESETPoolIndex values are configured, even if each field of DCI has the same value due to repetitive PDCCH transmission, the TCI state field may indicate different TCI states according to the control resource sets corresponding to different CORESETPoolIndex values for the same codepoint. For example, in the case where the UE receives a PDSCH TCI state activation/deactivation MAC-CE, in which the CORESET Pool ID field is configured as 0, for activating first and second TCI states for TCI state codepoints 1 and 2, respectively, and applies the same to a first control resource set in which CORESETPoolIndex is configured as 0. In addition, in the case where the UE receives a PDSCH TCI state activation/deactivation MAC-CE, in which the CORESET Pool ID field is configured as 1, for activating first and third TCI states for TCI state codepoints 1 and 2, respectively, and applies the same to a second control resource set in which CORESETPoolIndex is configured as 1. In the case where the base station performs repetitive PDCCH transmission based on the two control resource sets, if a DCI payload indicating TCI state codepoint 1 is produced, both PDCCHs may indicate the first TCI state, but if a DCI payload indicating TCI state codepoint 2 is produce, the PDCCHs transmitted in the first and second control resource sets indicate the second and third TCI states, respectively, so even if the same codepoint is indicated, the actual TCI state may be different.

As described above, in the case where the CORESETs in which different CORESETPoolIndex values are configured are connected to search spaces explicitly connected to each other and where repetitive PDCCH transmission is perform based on the same, even if the TCI state fields in the repeated PDCCHs have the same value, the actual codepoint may indicate different TCI states, Methods 1-1 to 1-6 below may be considered as methods for solving this.

[Method 1-1] The UE may assume that a MAC CE message indicated by the base station refers to the same QCL relationship or beamforming information. That is, since the same TCI is configured in the MAC CE message activation step, the UE may determine that the TCI information in DCI in the repetitively transmitted PDCCHs configured by different CORESETPoolIndex values has the same TCI field value and that the actual TCI information corresponding to the TCI value or the TCI information corresponding to a value indicated by the TCI codepoint is the same.

[Method 1-2] The UE may apply a TCI activation MAC CE message for the PDSCHs in common, regardless of the two CORESETPoolIndex values. More specifically, in the case where different CORESETPoolIndex values are configured for control resource sets respectively connected to search spaces explicitly connected to each other and where repetitive PDCCH transmission is performed using the control resource sets, if the UE receives a PDSCH TCI state activation/deactivation MAC-CE, the UE may apply the corresponding MAC-CE to the control resource sets of all CORESETPoolIndex values, regardless of the CORESET Pool ID value of the MAC-CE. That is, even if the PDSCH TCI state activation/deactivation activation MAC-CE, which is considered to be differently applied to the UE depending on CORESETPoolIndex values, has any CORESETPoolIndex value for the CORESET Pool ID field, the same PDSCH TCI state activation/deactivation MAC-CE may be activated for all the CORESETs having different CORESETPoolIndex values. For example, in the case where the CORESETPoolIndex value may have 0 or 1, where first to third control resource sets in which the CORESETPoolIndex value is configured as 0 exist, and where fourth to fifth control resource sets in which the CORESETPoolIndex value is configured as 1 exist, where the UE receives a PDSCH TCI state activation/deactivation MAC-CE and the CORESET Pool ID field in the MAC-CE has a value of 0, the corresponding MAC-CE may be applied to all of the first to fifth control resource sets. In this case, the PDCCHs repetitively transmitted through a plurality of control resource sets configured with different CORESETPoolIndexes values have the same bit value for TCI state indication, and the same MAC-CE is applied to all the control resource sets having different CORESETPoolIndex values, so the same codepoint in the TCI states of the PDCCHs repetitively transmitted from the plurality of control resource sets configured with different CORESETPoolIndex values may have the same value.

[Method 1-3] The UE may decode the repetitively transmitted PDCCHs and follow the TCI field of the PDCCH that is successfully decoded first and QCL information corresponding thereto. For example, if the PDCCH transmitted in the control resource set in which the CORESETPoolIndex value is configured as 0, among the repetitively transmitted PDCCHs, is successfully decoded earlier than the PDCCH transmitted in the control resource set in which the CORESETPoolIndex value is configured as 1, the UE may interpret the TCI state field, based on the PDSCH TCI state activation/deactivation MAC-CE information applied to the control resource set in which the CORESETPoolIndex value is configured as 0. In the case where the UE reports to the base station that the UE is capable of soft combining as described above, and where only soft combining is performed during repetitive PDCCH transmission, that is, in the case where there is no sequence in decoding success, the UE may interpret the TCI state field, based on the PDSCH TCI state activation/deactivation MAC-CE information applied to the control resource set having the lowest CORESETPoolIndex value or the lowest control resource set ID value.

[Method 1-4] The UE may follow the TCI state field of the PDCCH transmitted in the monitoring occasion that is configured first, among the monitoring occasions in at least one slot in which repetitively transmitted PDCCH is configured to be transmitted, and QCL information corresponding to. If the repeated PDCCHs are transmitted in the same monitoring occasion, that is, if the UE receives repetitively transmitted PDCCHs by a frequency division scheme, the UE may interpret the TCI state field, based on the PDSCH TCI state activation/deactivation MAC-CE information applied to the control resource set having the lowest CORESETPoolIndex value or the lowest control resource set ID value.

[Method 1-5] The UE may follow the TCI field of the PDCCH in the CORESET having the (lowest) CORESET ID value that is configured first, among at least one or more CORESETs in which repetitively transmitted PDCCHs are configured, and QCL information corresponding thereto.

[Method 1-6] The UE may the TCI field of the PDCCH in the CORESET having the (lowest) CORESETPoolIndex value that is configured first, among at least one or more CORESETPoolIndex values in which repetitively transmitted PDCCHs are configured, and QCL information corresponding thereto.

The various embodiments described above may be operated independently, and two or more thereof may be associated dependently to be considered together with each other.

As described in the embodiment, in the case where the UE receives, from the base station, configuration information of the search space to which control resource sets having different CORESETPoolIndex values are explicitly connected and receives repetitively transmitted PDCCHs, based on the same, and where the repeated PDCCHs schedule a single PDSCH, since each of the time/frequency resource assignment field (TDRA and FDRA) in the DCI, antenna port field, HARQ process ID field, and NDI field has the same values, the embodiment may be used to schedule a single PDSCH, based on the same, without separate re-interpretation and post-processing.

The various embodiments described above may be applied to both the DAI field and the PUCCH resource indicator field in a similar manner during the repetitive PDCCH transmission. For example, the UE receiving respective PDCCHs in which different CORESETPoolIndex values are configured may apply the DAI field value of the PDCCH transmitted from the first PDCCH candidate resource among the two monitoring occasions. As another example, the UE receiving respective PDCCHs in which different CORESETPoolIndex values are configured may apply the PUCCH resource indicator field value of the PDCCH included in the first (lowest) CORESET ID or the first (lowest) search space ID, among the two monitoring occasions.

### Fourth-2 Embodiment: Method of Scheduling a Plurality of PDSCHs Based on NC-JT in Repetitive PDCCH Transmission Based on CORESETs Having Differently Configured CORESETPoolIndex Values

According to an example embodiment, in the case where the UE receives, from the base station, configuration information of search spaces to which control resource sets in which different CORESETPoolIndex values are configured are explicitly connected, and receives repetitively transmitted PDCCHs based on the same, the UE may understand that scheduling of a plurality of PDSCHs based on NC-JT is received from the base station. Here, receiving scheduling of a plurality of PDSCHs based on NC-JT may indicate receiving scheduling in which a plurality of PDSCHs that entirely overlap, partially overlap, or do not overlap on time/frequency resources, based on the respective PDCCHs, is transmitted. In other words, receiving scheduling of a plurality of PDSCHs based on NC-JT may indicate receiving scheduling of each PDSCH for each PDCCH. In this case, the UE may respectively apply PDSCH TCI state activation/deactivation MAC-CEs to the control resource sets in which different CORESETPoolIndex values are configured as described above, even if each field of DCI has the same value due to repetitive PDCCH transmission, the TCI state field may indicate different TCI states according to the control resource sets corresponding to different CORESETPoolIndex values for the same codepoint. Therefore, although the UE receives an indication of a codepoint for the same TCI state field, since it may indicate that the respective PDCCHs indicate different TCI states from each other, the UE may apply each TCI state to the PDSCH scheduled by each PDCCH. However, since TDRA/FDRA are the same as described above, they overlap entirely on time/frequency resources, regardless of UE capability reporting.

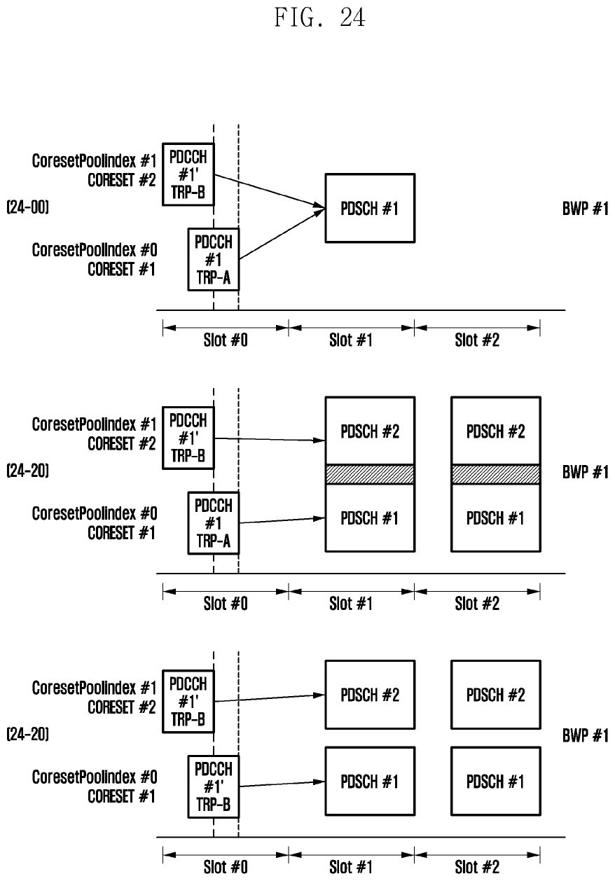

FIG. 24 is a diagram illustrating a method for allocating time and frequency resources of a plurality of PDSCHs, based on NC-JT, scheduled from control resource sets in which different CORESETPoolIndex values are configured according to an example embodiment.

With reference to FIG. 24, the base station may transmit, to the UE, a first PDCCH (PDCCH #1) in a first TRP (TRP-A) configured as CORESETPoolIndex #0, and a second PDCCH (PDCCH #1′) in a second TRP (TRP-B) configured as CORESETPoolIndex #1. As described above, if DCI field values of at least some or all of the first PDCCH and the second PDCCH are configured to have the same value, it may cause some ambiguous interpretation or an undefined interpretation. For example, if at least some or all field values among the TDRA, FDRA, antenna port, HARQ process ID, and NDI fields of DCI are the same, the UE may perform different operations depending on whether or not the respective PDSCHs scheduled by repetitively transmitted PDCCHs overlap. That is, although the values indicated in the TDRA, FDRA, antenna port, HARQ process ID, and NDI fields in at least DCI formats 1_0, 1_1, and 1_2 corresponding to respective TRPs configured in different CORESETPoolIndex values received by the UE are the same, these values are ambiguous to interpret.

In the case where a plurality of control resource sets in which different CORESETPoolIndex values are configured are respectively connected to explicitly connected search spaces and where a plurality of PDSCHs are scheduled based on NC-JT by repetitively transmitted PDCCHs according thereto, an operation for interpreting and determining the TDRA and FDRA fields in order to determine whether or not the respective PDSCHs overlap in the time/frequency resources will be described as follows.

[Method 2-1] For the TDRA and FDRA fields in the PDCCHs repetitively transmitted in control resource sets in which different CORESETPoolIndex values are configured, the base station may perform repetitive PDCCH transmission-based PDSCH scheduling only for the UE that supports the simultaneous reception of the entirely overlapping PDSCHs or the UE that reports the UE capability. That is, the UE reporting partially overlapping or non-overlapping through the UE capability report is unable to receive a configuration of the PDCCHs repetitively transmitted in the control resource sets in which different CORESETPoolIndex values are configured. That is, the UE reporting partially overlapping or non-overlapping through the UE capability report may expect to not receive a configuration related to repetitive transmission of the PDCCHs in which the control resource sets in which different CORESETPoolIndex values are configured are connected to the explicitly connected search spaces.

[Method 2-2] For the TDRA fields in the PDCCHs repetitively transmitted in CORESETs in which different CORESETPoolIndex values are configured, the base station may configure time and frequency resource offset-related information for PDSCH scheduling for the UE that supports the simultaneous reception of the entirely overlapping 24-00, partially overlapping 24-20, or non-overlapping 24-40 PDSCHs or the UE that reports the UE capability. In this case, the FDRA field may be indicated in a manner configured between the base station and the UE according to the existing interpretation and may be used to schedule the PDSCH. That is, if the frequency resource offset is not applied, all of the plurality of PDSCHs may be scheduled based on the same frequency resource allocation information.

For example, the base station may configure time and frequency resource offset-related information of the entirely overlapping 24-00, partially overlapping 24-20, or non-overlapping 24-40 PDSCH resources scheduled by the PDCCHs repetitively transmitted in the high layer (e.g., RRC) according to the UE capability (e.g., capable of simultaneously receiving the entirely overlapping 24-00, partially overlapping 24-20, or non-overlapping 24-40 PDSCHs). For example, in the case where control resource sets in which different CORESETPoolIndex values are configured are respectively connected to explicitly connected search spaces, time and frequency resource offset information may be configured through higher layer signaling, and in this case, time resource offset information applicable to the partially overlapping or non-overlapping case may be in units of OFDM symbols, mini-slots, slots, or milliseconds (msecs), and frequency resource offset information may be in units of REs and RBs. In addition, in the non-overlapping case, one of time resource non-overlapping, frequency resource non-overlapping, and time/frequency resource non-overlapping methods may be configured based on higher layer signaling to adjust the PDSCH position.

The time resource non-overlapping method is to adjust the PDSCH position such that the time/frequency resource position of the PDSCH determined through TDRA/FDRA among the DCI fields indicated through the repeated PDCCHs does not overlap the time resource. For example, in the case where two PDCCHs are repeatedly transmitted, where time resources are allocated to OFDM symbols 4 to 7, based on the TDRA field, and where frequency resources are allocated to PRBs 1 to 4, based on the FDRA field, the first PDSCH is transmitted to the UE based on the TDRA/FDRA field, and the second PDSCH is adjusted in its position such that the OFDM symbol position is shifted to the right by 4 in the PDSCH resource position based on the TDRA/FDRA field to not overlap in the time resource and is transmitted to the UE. In this case, in the case where the shifted PDSCH crosses a slot boundary, the corresponding PDSCH may not be transmitted, or only the OFDM symbol crossing the slot boundary may not be transmitted. Similarly, the frequency resource non-overlapping method and the time/frequency resource non-overlapping method may be considered as methods of adjusting the PDSCH position such that a plurality of PDSCHs does not overlap both in frequency resources and in time/frequency resources. In the case where the PDSCH shifted to the frequency resource also crosses a BWP boundary in application to frequency resources, the corresponding PDSCH may not be transmitted or only RBs crossing the BWP boundary may not be transmitted.

As another example, as shown in Table 34-1, the base station may configure time and/or frequency offset-related information corresponding to each TDRA entry for TDRA configuration in a higher layer (e.g., RRC) according to the UE capability (e.g., capable of simultaneously receiving the entirely overlapping, partially overlapping, or non-overlapping PDSCHs). Also, based on this, the base station may indicate the time and frequency resource offset-related information of the entirely overlapping, partially overlapping, or non-overlapping PDSCHs through the TDRA field of DCI.

For example, in the case where the TDRA configuration information is configured in the higher layer as shown in Table 34-1 or determined by the standards, and where the UE identifies 0000 (corresponding to entry #1) in the TDRA field of DCI, the UE may determine that the RB offset value between the first PDSCH resource and the second PDSCH resource is configured as 2. As another example, in the case where the TDRA configuration information (or TDRA entry) is configured in the higher layer or determined by the standards, and where the UE identifies 0001 (corresponding to entry #2) in the TDRA field, the UE may determine that the symbol offset value between the first PDSCH resource and the second PDSCH resource is configured as 1 and that the RBoffset is configured as 4. As another example, in the case where the TDRA configuration information (or TDRA entry) is configured in the higher layer or determined by the standards, and where the UE identifies 1111 (corresponding to entry #16) in the TDRA field of DCI in Table 34-2, the UE may determine that the symbol offset value between the first PDSCH resource and the second PDSCH resource is configured as 0. In the case where the symbol offset and RBoffset values are not configured for each entry or configured as 0, it may be regarded as a TDRA entry to which the symbol offset and the RBoffset are not applied.

In particular, if the base station configures an offset for the UE supporting simultaneous reception of partially overlapping or non-overlapping PDSCHs through the TDRA offset information through the higher layer or the TDRA field value of DCI described above, the UE may determine that the second PDSCH time and/or frequency resource is configured by adding the offset to the first PDSCH time and/or frequency resource configuration. The offset may include at least one or more pieces of time offset and frequency offset information. That is, the first PDSCH, as a reference, may be transmitted at a resource position based on the TDRA/FDRA field without applying an offset, and the second PDSCH may be applied with an offset from the reference position. In the case where three or more PDSCHs are transmitted based on the repeated PDCCHs, if T and F are respectively applied to the second PDSCH as the time and frequency resource offset, (N−1)T and (N−1)F may be applied to N^{th} PDSCH (N>2).

```
TABLE 34-1
  PDSCH-TimeDomainResourceAllocationList-r16 ::=
  SEQUENCE (SIZE(1..maxNrofDL-Allocations)) OF PDSCH-TimeDomainResourceAllocation-r16
  PDSCH-TimeDomainResourceAllocation-r16 ::= SEQUENCE {
```

| | |
|---|---|
| k0-r16 | INTEGER(0..32) OPTIONAL, -- Need S |
| mappingType-r16 | ENUMERATED {typeA, typeB}, |
| startSymbolAndLength-r16 | INTEGER (0..127), |
| repetition Number-r16 | ENUMERATED {n2, n3, n4, n5, n6, n7, n8, n16} OPTIONAL, -- Cond Formats1-0and1-1 |
| symbolOffset | INTEGER (0,...,M) OPTIONAL -- Cond PDCCH repetition |
| RBOffset | INTEGER (0,...,N) OPTIONAL -- Cond PDCCH repetition |

}

TABLE 34-2
Time domain resource assignment field

| # of Entry | K0 | mappingType | SLIV | Rep. num | symbol offset | RBoffset |
|---|---|---|---|---|---|---|
| 1 | 0 | A | 0 | — | — | 2 |
| 2 | 0 | B | 2 | — | 1 | 4 |
| . . . | . . . | . . . | . . . | . . . | . . . | . . . |
| 16 | 2 | B | 15 | — | 1 | — |

[Method 2-3] For the TDRA and FDRA fields in the PDCCH that are repetitively transmitted in CORESETs having differently configured CORESETPoolIndex values, the base station may independently configure a plurality of TDRA or FDRA fields as many as the number of different CORESETPoolIndex values. That is, the base station may independently configure information related to a plurality of TDRA or FDRA fields as many as the number of different CORESETPoolIndex values for the UE that supports the simultaneous reception of the entirely overlapping 24-00, partially overlapping 24-20, or non-overlapping 24-40 PDSCHs or the UE that reports the UE capability, and a plurality of TDRA or FDRA fields capable of indicating independent information may exist in the repeated PDCCHs.
1) A plurality of resourceAllocation configurations may exist in the higher layer signaling, PDSCH-Config, and may be applied to each of a plurality of FDRA fields.
2) A method in which a resourceAllocation configuration is configured in the higher layer signaling, PDSCH-Config, may be applied in common to a plurality of FDRA fields. In this case, if resourceAllocation in the higher layer signaling, PDSCH-Config, is configured as dynamic, the 1-bit MSB in the first FDRA field indicates resource allocation type 0 or type 1 (e.g., if the bit value is 0, it indicates type 0, and if the bit value is 1, it indicates type 1), and the 1-bit MSBs from the second to last FDRA fields may be used in frequency resource allocation. Alternatively, n bits obtained by collecting the 1-bit MSBs of the second to last (e.g., n^{th}) FDRA fields may be used for other purposes (e.g., it may be used to supplement the number of bits in the NDI field by 1 bit for each PDSCH, or may be used to indicate the redundancy version (RV) by 1 bit for each PDSCH, for example, if the corresponding bit has a value of 0, it may indicate RV 0, and if the bit has a value of 1, it may indicate RV 3).

[Method 2-4] For the TDRA field in the PDCCHs that are repetitively transmitted in CORESETs having differently configured CORESETPoolIndex values, the base station may include a plurality of pieces of TDRA information in one entry that may be indicated by the TDRA field. For example, one piece of slot offset information and a plurality of pieces of SLIV information may be included in one entry that may be indicated by the TDRA field, a plurality of pieces of slot offset information and one piece of SLIV information may be included in one entry, or a plurality of pieces of slot offset information and a plurality of pieces of SLIV information may be included in one entry. In addition, similarly to the TDRA field, the FDRA field in the PDCCHs that are repetitively transmitted from CORESETs having differently configured CORESETPoolIndex values may be defined to select one of a plurality of entries configured through higher layer signaling. In this case, a plurality of pieces of FDRA information may be included in each entry.

Meanwhile, in addition to the TDRA and FDRA fields in the DCI considered above, in the case where control resource sets received by the UE in which different CORESETPoolIndexes values are configured are respectively connected to the explicitly connected search spaces, and where the values indicated by the antenna port fields in DCI format 1_0, 1_1, and L2 included in the repeated PDCCHs are the same, these values are ambiguous to interpret. Hereinafter, in the case where a plurality of control resource sets in which different CORESETPoolIndex values are configured are respectively connected to the explicitly connected search spaces, and where a plurality of NC-JT-based PDSCHs is scheduled by repetitively transmitted PDCCHs according thereto, an operation for interpreting and determining the antenna port field in order to determine whether or not the respective PDSCHs overlap will be described as follows.

Table 35 below shows an antenna port indication table in the case of antenna port(s) (1000+DMRS port), dmrs-Type=1, and maxLength=1 in current Rel-15 to 16. Table 36 below shows an antenna port indication table in the case of antenna port(s) (1000+DMRS port), dmrs-Type=1, and maxLength=2 in current Rel-15 to 16. The UE may identify the DCI format and identify a value of the antenna port field, thereby determining a DMRS port and a CDM group according to the values of the DMRS indication table corresponding thereto.

TABLE 35
One Codeword: Codeword 0 enabled, Codeword 1 disabled

| | Number of DMRS CDM | DMRS |
|---|---|---|
| Value | group(s) without data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12-15 | Reserved | Reserved |

TABLE 36

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number | | | | Number | | |
| | of DMRS | | | | of DMRS | | |
| | CDM | | | | CDM | | |
| | group(s) | | Number of | | group(s) | | Number of |
| | without | DMRS | front-load | | without | DMRS | front-load |
| Value | data | port(s) | symbols | Value | data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

[Method 3-1] In the case where the antenna port field values in the PDCCHs repetitively transmitted in CORESETs having differently configured CORESETPoolIndex values are the same, the base station may schedule two CDM groups (e.g., antenna port {0,2} in the case of DMRS type 1) using the antenna port fields for scheduling a plurality of PDSCHs, and apply DMRS ports belonging to different CDM groups to transmission of the respective PDSCHs. In addition, the UE may apply each identified TCI (e.g., the same or different TCIs by each DCI) field to each CDM group. Specifically, the TCI state field among the DCI fields in the PDCCH included in the control resource set in which CORESETPoolIndex is configured as 0, among the repeated PDCCHs, may be applied to a first CDM group among a plurality of CDM groups to which DMRS ports indicated by the antenna ports may belong, and the TCI state field in the control resource set in which CORESETPoolIndex is configured as 1 may be applied to a second CDM group.

For example, if the codepoint value of the antenna port field among the DCI fields in repetitively transmitted PDCCHs received by the UE indicates 9 (e.g., DMRS ports 0, 1, and 2), the UE may regard (or determine) that DMRS port 0 and DMRS port 1 are transmitted from the first TRP and that DMRS port 2 is transmitted from the second TRP. That is, the UE may perform decoding using DMRS port 0 and DMRS port 1 to receive the first PDSCH (e.g., PDCCH #1) transmitted from the first TRP, and perform decoding using DMRS port 2 to receive the second PDSCH (e.g., PDCCH #1′) transmitted from the second TRP.

[Method 3-2] In the case where the antenna port field values in the PDCCHs repetitively transmitted in CORESETs having differently configured CORESETPoolIndex values are the same, the base station may reconfigure the corresponding antenna port indication table. Specifically, the base station and the UE may remove the DMRS port index corresponding to the codepoint of at least one DMRS port configured to indicate two or more CDM groups in the antenna port field to divide the antenna port field into two parts such that each part indicates the DMRS port of each PDSCH. For example, entries 9 to 11 supporting two CDM groups may be removed from Table 35 indicating a plurality of codepoints configured in the antenna port(s) (1000+DMRS port) determined as dmrs-Type=1 and maxLength=1, and 4 bits of information indicating a total of 16 codepoints may be divided into two parts by 2 bits each to constitute an antenna port indication table for indicating each part using some or all of entries in Table 37 below.
For example, the antenna port field may be maintained at 4 bits and divided into two parts to have 2 bits for each, so that the antenna port indication table for indicating each part may include entries 0 to 3 in Table 37. In this case, the same antenna port indication table may be used for both parts, transmission rank-1 may be allocated for each of the two PDSCHs, and the DMRS ports in the same CDM group may not be indicated.
As another example, the antenna port field may be maintained at 4 bits and divided into two parts using 2 bits for each, so that the first part, as an antenna port indication table, may include entries 0, 1, and 4 in Table 37 and so that the second part may include entries 2, 3, and 5 in Table 37. In this case, different antenna port indication tables may be used for the two parts, transmission rank-1 or 2 may be allocated for both PDSCHs, and it may be assumed that the first and second PDSCHs use CDM groups 0 and 1, respectively.
As another example, 5 bits may be allocated to the antenna port field, and the antenna port filed may be divided into two parts using 3 bits and 2 bits, respectively, so that the first part, may include entries 0 to 5 in Table 37, as an antenna port indication table, and so that the second part may include some of the entries 0 to 5 in Table 37 depending on the entry indicated for the first part through DCI. If entry 0 in Table 37 is indicated for the first part, the antenna port indication table for the second part may include entries 2, 3, and 5 related to the remaining CDM groups, excluding the CDM group indicated for the first part. In this case, different antenna port indication tables may be used for the two parts, transmission rank-1 or 2 may be allocated for each of the two PDSCHs, and it may be assumed that the first and second PDSCHs use different CDM groups.
As another example, 6 bits may be allocated to the antenna port field, and the antenna port filed may be divided into two parts using 3 bits for each, so that the antenna port indication table for indicating each part may include all entries in Table 37. In this case, the same antenna port indication table may be used for both pants. Transmission rank-1 or 2 may be allocated to two PDSCHs, respectively, and it may be assumed that the first and second PDSCHs use different CDM groups.

TABLE 37
One Codeword: Codeword 0 enabled, Codeword 1 disabled

| | Number of DMRS CDM | DMRS |
|---|---|---|
| Value | group(s) without data | port(s) |
| 0 | 2 | 0 |
| 1 | 2 | 1 |
| 2 | 2 | 2 |
| 3 | 2 | 3 |
| 4 | 2 | 0, 1 |
| 5 | 2 | 2, 3 |

The above-described methods may be applied to Table 36 above in a similar manner. As an example, in Table 36 indicating a plurality of codepoints configured in antenna port(s) (1000+DMRS port) determined as dmrs-Type=1 and maxLength=2, entries 9, 10, 11, and 30 supporting two CDM groups may be deleted in the case of one codeword, and entries 0 to 3 may be deleted in the case of two codewords. Also, 5-bit information indicating a total of 32 codepoints may be divided into two parts, and an antenna port indication table for indicating each part may be configured using some or all of the entries in Table 38 below. Meanwhile, since each of the two divided parts schedules each PDSCH, the case of two codewords in Table 38 below may be omitted.

TABLE 38
One Codeword: Codeword 0 enabled, Codeword 1 disabled

| | Number of DMRS | | Number of |
|---|---|---|---|
| | CDM group(s) | DMRS | front-load |
| Value | without data | port(s) | symbols |
| 0 | 2 | 0 | 1 |
| 1 | 2 | 1 | 1 |
| 2 | 2 | 2 | 1 |
| 3 | 2 | 3 | 1 |
| 4 | 2 | 0, 1 | 1 |
| 5 | 2 | 2, 3 | 1 |
| 6 | 2 | 0 | 2 |
| 7 | 2 | 1 | 2 |
| 8 | 2 | 2 | 2 |
| 9 | 2 | 3 | 2 |
| 10 | 2 | 4 | 2 |
| 11 | 2 | 5 | 2 |
| 12 | 2 | 6 | 2 |
| 13 | 2 | 7 | 2 |
| 14 | 2 | 0, 1 | 2 |
| 15 | 2 | 2, 3 | 2 |
| 16 | 2 | 4, 5 | 2 |
| 17 | 2 | 6, 7 | 2 |
| 18 | 2 | 0, 4 | 2 |
| 19 | 2 | 2, 6 | 2 |
| 20 | 2 | 0, 1, 4 | 2 |
| 21 | 2 | 2, 3, 6 | 2 |
| 22 | 2 | 0, 1, 4, 5 | 2 |
| 23 | 2 | 2, 3, 6, 7 | 2 |

[Method 3-3] In the case where the antenna port field values in the PDCCHs repetitively transmitted in CORESETs having differently configured CORESETPoolIndex values are the same, the base station may perform reconfiguration such that each entry in the antenna port indication table indicates a DMRS port pair. In this case, all pairs may indicate DMRS ports included in different CDM groups, and first and second DMRS port groups in the pair may be applied to first and second PDSCH transmissions, respectively. Table 39 shows an example of an antenna port indication table reconfigured for Method 3-3. For example, all entries in Table 39 may be used to indicate a 4-bit-based antenna port field. As another example, one entry (e.g., entry 8) among all the entries in Table 39 may be removed to indicate a 3-bit-based antenna port field.

TABLE 39
One Codeword: Codeword 0 enabled, Codeword 1 disabled

| | Number of DMRS CDM | DMRS |
|---|---|---|
| Value | group(s) without data | port(s) |
| 0 | 2 | {0}, {2} |
| 1 | 2 | {0}, {3} |
| 2 | 2 | {1}, {2} |
| 3 | 2 | {1}, {3} |
| 4 | 2 | {0}, {2, 3} |
| 5 | 2 | {1}, {2, 3} |
| 6 | 2 | {0, 1}, {2} |
| 7 | 2 | {0, 1}, {3} |
| 8 | 2 | {0, 1}, {2, 3} |

Meanwhile, in addition to the TDRA, FDRA, and antenna port fields in the DCI considered above, in the case where control resource sets received by the UE in which different CORESETPoolIndexes values are configured are respectively connected to the explicitly connected search spaces, where the values indicated by the HARQ process ID field in DCI format 1_0, 1_1, and 1_2 included in the repeated PDCCHs are the same, these values are ambiguous to interpret. Hereinafter, in the case where a plurality of control resource sets in which different CORESETPoolIndex values are configured are respectively connected to the explicitly connected search spaces, where a plurality of NC-JT-based PDSCHs is scheduled by repetitively transmitted PDCCHs according thereto, an operation for interpreting and determining the HARQ process ID field in order to determine whether or not the respective PDSCHs overlap will be described as follows.

In the case where the HARQ process ID field values in the PDCCHs repetitively transmitted in the CORESETs having differently configured CORESETPoolIndex values are the same, one of the plurality of PDSCHs may follow the HARQ process ID (e.g., n) indicated by the HARQ process ID field, and the remaining PDSCH(s) may follow the HARQ process ID obtained by changing the HARQ process ID included in the DCI based on a predetermined method. The predetermined method may be determined by adding a specific value to the HARQ process ID indicated by the HARQ process ID field and then taking the remainder obtained by dividing the same by the maximum number of HARQ process IDs (e.g., mod(n+1, N), mod(x, y) indicate the remainder of dividing x by y, and N is the maximum number of HARQ process IDs and may be, for example, 16). In this case, various methods may be considered to determine the HARQ process IDs to be allocated to a plurality of PDSCHs.

[Method 4-1] In the case where there is a plurality of TDRA fields or where respective entries of the TDRA field indicate a plurality of pieces of TDRA information, the HARQ process ID (e.g., n) indicated through the HARQ process ID field may be allocated to the PDSCH scheduled through the TDRA field indicated first or first TDRA information among the entries of the indicated TDRA field, and if the number of the remaining TDRA fields or the number of pieces of the remaining TDRA information among the entries of the indicated TDRA field is m, HARQ process IDs of mod(n+1, N), mod(n+2, N), . . . , mod(n+m, N) may be respectively allocated to m PDSCHs scheduled through the m pieces of TDRA information. Here, mod(x, y) indicates the remainder of dividing x by y, and N is the maximum number of HARQ process IDs and may be, for example, 16.

[Method 4-2] In the case where there is a plurality of TDRA fields or where respective entries of the TDRA field indicate a plurality of pieces of TDRA information, HARQ process IDs may be allocated based on the position of a start symbol of the PDSCH scheduled through each field or each piece of TDRA information in the entry. For example, in the case where two TDRA fields are indicated or where the entry indicated by the TDRA field includes two pieces of TDRA information, and where two pieces of TDRA information indicate the same slot offset and where the position of a start symbol of the PDSCH of the first TDRA information is earlier, the HARQ process ID (e.g., n) indicated through the HARQ process ID field may be allocated to the PDSCH scheduled through the first TDRA information, and the HARQ process ID for the PDSCH scheduled through the second TDRA information may be determined by adding a specific value to the HARQ process ID indicated by the HARQ process ID field and then taking the remainder obtained by dividing the same by the maximum number of HARQ process IDs (e.g., mod(n+1, N), mod(x, y) indicate the remainder of dividing x by y, and N is the maximum number of HARQ process IDs and may be, for example, 16). In the case where two pieces of TDRA information have different slot offsets, the HARQ process ID may be allocated from the TDRA information corresponding to the small slot offset in the above manner.

[Method 4-3] In the case where there is a plurality of FDRA fields or where respective entries of the FDRA field indicate a plurality of pieces of FDRA information, HARQ process IDs may be allocated in the order of FDRA information indication in a similar manner as 1) above.

[Method 4-4] In the case where there is a plurality of FDRA fields or where respective entries of the FDRA field indicate a plurality of pieces of FDRA information, HARQ process IDs may be allocated in the order of FDRA information indication in a similar manner as 2) above. In this case, the HARQ process ID is allocated based on the position of a start symbol in 2) above, whereas, in this method using FDRA, the HARQ process ID may be allocated based on the lower starting PRB position or the higher starting PRB position.

[Method 4-5] In the case where, based on Method 2-2, a time/frequency resource offset may be configured in each entry of the TDRA field through the TDRA field and where the time/frequency resource offset is applied to a plurality of PDSCHs by indicating corresponding entries, the HARQ process ID indicated through the HARQ process ID field may be allocated to the PDSCH to which the time/frequency resource offset is not applied, and the HARQ process ID for the PDSCH to which the time/frequency resource offset is applied may be determined by adding a specific value to the HARQ process ID indicated by the HARQ process ID field and then taking the remainder obtained by dividing the same by the maximum number of HARQ process IDs (e.g., mod(n+1, N), mod(x, y) indicates the remainder of dividing x by y, and N is the maximum number of HARQ process IDs and may be, for example, 16). In this case, in the case where a time/frequency resource offset is applied to the respective PDSCHs described in Method 2-2 above, for example, HARQ process IDs of mod(n+1, N), mod(n+2, N), . . . , mod(n+m, N) may be respectively allocated to m PDSCHs to which m time/frequency resource offsets are applied. Here, mod(x, y) indicates the remainder of dividing x by y, and N is the maximum number of HARQ process IDs and may be, for example, 16.

With regard to the methods listed above, one of [Method 2-1] to [Method 2-4] may be applied to the TDRA/FDRA fields among the DCI fields included in the repeated PDCCHs, one of [Method 3-1] to [Method 3-3] may be applied to the antenna port field, and one of [Method 4-1] to [Method 4-5] may be applied to the HARQ process ID field. For example, in the case where respective CORESETs having differently configured CORESETPoolIndex values are respectively connected to explicitly connected search spaces and where a plurality of PDSCHs for NC-JT is scheduled through PDCCHs repeated from the respective CORESETs, when interpreting the repeated DCI fields, [Method 2-2] may be applied to the TDRA/FDRA fields, [Method 3-1] may be applied to the antenna port field, and [Method 4-5] may be applied to the HARQ process ID field. In the case where [Method 2-3] is not used, the bit size of the field may be determined using one of the number of scheduled PDSCHs, the number of pieces of independent TDRA/FDRA information indicated by the TDRA/FDRA field, the number of CORESETPoolIndex values that are differently configured, and the maximum number of pieces of independent TDRA/FDRA information that may be indicated through the TDRA/FDRA field. For example, in the case where the size of the NDI field is determined as the maximum number of pieces of independent TDRA information that may be indicated through the TDRA field, and where the maximum number of pieces of independent TDRA information that may be indicated by a single entry for the TDRA field is 8, the NDI field may be configured as 8 bits. In this case, in the case where an entry having two pieces of independent TDRA information is indicated through the TDRA field, the remaining 6 bits may be used as additional bits for the MCS or RV field.

### Fourth-3 Embodiment: Method of Switching Between Single-PDSCH Scheduling and NC-JT-Based Multi-PDSCH Scheduling in Repetitive PDCCH Transmission Based on CORESETs Having Differently Configured CORESETPoolIndex Values

As an example embodiment, the base station may configure, for a specific UE, an operation of switching between an operation of scheduling a single PDSCH and an operation of scheduling NC-JT-based PDSCHs in respective PDCCHs repetitively transmitted in a plurality of TRPs described above. The operation of switching the PDSCH scheduling may be performed statically, semi-statically, or dynamically in consideration of a configuration method and an applied time.

[Method 5-1] Static Switching Operation Using Higher Layer Signaling

The base station may configure, for the UE, parameter information related to switching between an operation of scheduling a single PDSCH and an operation of scheduling NC-JT-based PDSCHs in respective PDCCHs repetitively transmitted in TRP in a semi-statical manner through a higher layer configuration.

For example, the base station may indicate the UE of whether or not NC-JT-based PDSCH scheduling is possible by enabling a configuration parameter (e.g., enableNCJT) that distinguishes between the single-PDSCH scheduling and the NC-JT-based PDSCH scheduling in RRC. That is, if the UE receives a message in which a parameter for configuring the NC-JT-based PDSCH scheduling is disabled in the higher layer, the UE may determine that a single PDSCH is to be scheduled in the PDCCHs repetitively transmitted in a plurality of TRPs, instead of considering the NC-JT-based PDSCH scheduling.

As another example, the base station may indicate the UE of whether or not single-PDSCH-based PDSCH scheduling is possible by enabling a configuration parameter (e.g., single-PDSCH) that distinguishes between the single-PDSCH scheduling and the NC-JT-based PDSCH scheduling in RRC. That is, if the UE receives a message in which a parameter for configuring the single-PDSCH scheduling is disabled in the higher layer, the UE may determine that the NC-JT-based PDSCH scheduling is performed in the PDCCHs repetitively transmitted in a plurality of TRPs, instead of considering the single-PDSCH scheduling.

[Method 5-2] TCI State Field-Based Dynamic Switching Operation

In repetitive PDCCH transmission based on CORESETs having differently configured CORESETPoolIndex values and respectively connected to search spaces that are explicitly connected to each other, the UE may perform a method of dynamically switching between an operation of scheduling a single PDSCH and an operation of scheduling NC-JT-based PDSCHs, based on the TCI state field in DCI.

For example, respective codepoint values of the TCI fields in DCI of the PDCCHs repetitively transmitted in the respective TRPs may be the same or different from each other. Specifically, in the case where the codepoint value of the TCI field in the DCI of the PDCCH received by the UE from a first TRP or a second TRP is 000, the UE may determine whether or not the values of first (e.g., corresponding to codepoint 000) TCI state IDs configured in CORESETPoolindex 0 or CORESETPoolindex 1 are the same, based on an higher layer or MAC-CE message (e.g., TCI states activation/deactivation for UE-specific PDSCH MAC CE). Here, if the first (e.g., corresponding to codepoint 000) TCI state ID identified in CORESETPoolindex 0 is different from the first (e.g., corresponding to codepoint 000) TCI state ID identified in CORESETPoolindex 1, the UE may determine that NC-JT-based PDSCHs are to be scheduled. On the other hand, if the first (e.g., corresponding to codepoint 000) TCI state ID identified in CORESETPoolindex 0 is the same as the first (e.g., corresponding to codepoint 000) TCI state ID identified in CORESETPoolindex 1, the UE may determine that a single PDSCH is to be scheduled. That is, the UE may identify whether or not the TCI state ID values indicated by the TCI codepoint received from each PDCCH are the same, and determine whether the PDSCH scheduled by the PDCCHs repetitively transmitted in a plurality of TRPs schedules a single PDSCH or NC-JT-based PDSCHs.

As another example, if the codepoint indicated by the TCI field in the DCI of the PDCCH received from the first TRP or the second TRP by the UE indicates different TCI states between different CORESETPoolIndex values, the UE may determine that NC-JT-based PDSCHs are scheduled, and if the codepoint indicates the same TCI state between different CORESETPoolIndex values, the UE may determine that a single PDSCH is scheduled.

Meanwhile, in order to perform signaling for the UE about switching between an operation of scheduling a single PDSCH and an operation of scheduling NC-JT-based PDSCHs, based on the TCI state field as described above, the base station may perform management such that the TCI state for the same TCI codepoint in one piece of DCI is the same or different between respective CORESETPoolIndex values. To this end, the UE may need to receive a plurality of PDSCH TCI state activation/deactivation MAC-CEs shown 16-50 in FIG. 16 between different CORESETPoolIndex values. In this case, as a method for reducing MAC-CE overhead, the base station may transmit the enhanced TCI states activation MAC-CE message (d: enhanced TCI states activation/deactivation for UE-specific PDSCH MAC CE) shown in FIG. 21A, which is introduced for a single-DCI-based multi-TRP transmission method, to the UE, thereby obtaining the effect of transmitting a plurality of PDSCH TCI state activation/deactivation MAC-CEs.

For example, in the case where the UE is configured to receive the repetitively transmitted PDCCHs, when receiving the enhanced TCI states activation MAC-CE message, the UE may identify a value of C_x corresponding to the codepoint of the x^{th} TCI state. The UE may determine information related to the TCI state activated for CORSETPoolindex 0 or information related to the TCI state activated for CORSETPoolindex 1, based on the received MAC CE message. For example, if the value of C₀ in Oct 2 of the message is 0, the UE may determine that only one TCI state ID_{0,1} is configured in CORESETPoolindex 0. Alternatively, if the value of C₀ in Oct 2 of the message is 1, the UE may determine that TCI state ID_{0,1} corresponding to CORESETPoolindex 0 is configured and that TCI state ID_{0,2} corresponding to CORESETPoolindex 1 is further configured.

That is, the base station may update the TCI states using an enhanced TCI states activation MAC-CE message (enhanced TCI states activation/deactivation for UE-specific PDSCH MAC CE) for a plurality of TRPs to support switching between an operation of scheduling a single PDSCH and an operation of scheduling NC-JT-based PDSCHs.

[Method 5-3] Antenna Port Field-Based Dynamic Switching Operation

In repetitive PDCCH transmission based on CORESETs having differently configured CORESETPoolIndex values and respectively connected to search spaces that are explicitly connected to each other, the UE may perform a method of dynamically switching between an operation of scheduling a single PDSCH and an operation of scheduling NC-JT-based PDSCHs, based on a value of the antenna port field in DCI.

For example, the UE may identify an antenna port field value in DCI of the PDCCHs repetitively transmitted from a plurality of TRPs and identify a DM-RS port codepoint corresponding to the antenna port field value in the DCI. In the case where the CDM group of the DM-RS corresponding to the identified codepoint is a single CDM group, the UE may determine that a single PDSCH is to be scheduled from the PDCCH. Alternatively, in the case where the CDM group of the DM-RS corresponding to the identified codepoint includes two or more CDM groups, the UE may determine that NC-JT-based PDSCHs are scheduled from the PDCCHs. Specifically, if the antenna port field values in DCI of the repetitively transmitted PDCCHs are entries 9 to 11 in the above Table 33, the UE may determine that NC-JT-based PDSCHs are scheduled, and if other entry values are indicated, the UE may determine that a single PDSCH is scheduled.

As another example, the antenna port indication table may be reconfigured for switching between single-PDSCH scheduling and NC-JT-based PDSCH scheduling. Specifically, in the above Table 35, entries 0 to 8 may indicate the single-PDSCH scheduling, and entries 9 to 15 may indicate the NC-JT-based PDSCH scheduling. Entries 12 to 15 are reserved codepoints and may be defined as combinations of DMRS ports including two CDM groups as shown in Table 40 below. Definitions for entries 12 to 15 shown in Table 40 are only examples, and defining other combinations may not be excluded.

TABLE 40

| | Number of DMRS CDM | DMRS |
|---|---|---|
| value | group(s) without data | port(s) |
| 12 | 2 | 0, 3 |
| 13 | 2 | 1, 3 |
| 14 | 2 | 0, 2, 3 |
| 15 | 2 | 1, 2, 3 |

[Method 5-4] Dynamic Switching Operation Using TDRA or FDRA Field

In repetitive PDCCH transmission based on CORESETs having differently configured CORESETPoolIndex values and respectively connected to search spaces that are explicitly connected to each other, the UE may perform a method of dynamically switching between an operation of scheduling a single PDSCH and an operation of scheduling NC-JT-based PDSCHs, based on a TDRA or FDRA field value in DCI.

1) In the case of [Method 2-2], in the case where a TDRA entry in which a time/frequency resource offset is not configured is indicated (or in the case where a TDRA entry in which a time/frequency resource offset is not configured is configured), the UE may expect that a single PDSCH transmission is to be scheduled. In the case where a TDRA entry in which at least one time/frequency resource offset is configured is indicated (or in the case where a TDRA entry in which a time/frequency resource offset is configured is configured), the UE may expect that a plurality of PDSCHs are to be transmitted in the NC-JT scheme.

2) In the case of [Method 2-4], in the case where an entry including one piece of TDRA and FDRA information for both the TDRA and FDRA fields is indicated, the UE may expect that a single PDSCH transmission is to be scheduled. In the case where an entry including a plurality of pieces of TDRA or FDRA information is indicated by at least one of the TDRA or FDRA fields, the UE may expect that a plurality of PDSCHs are to be transmitted in the NC-JT scheme.

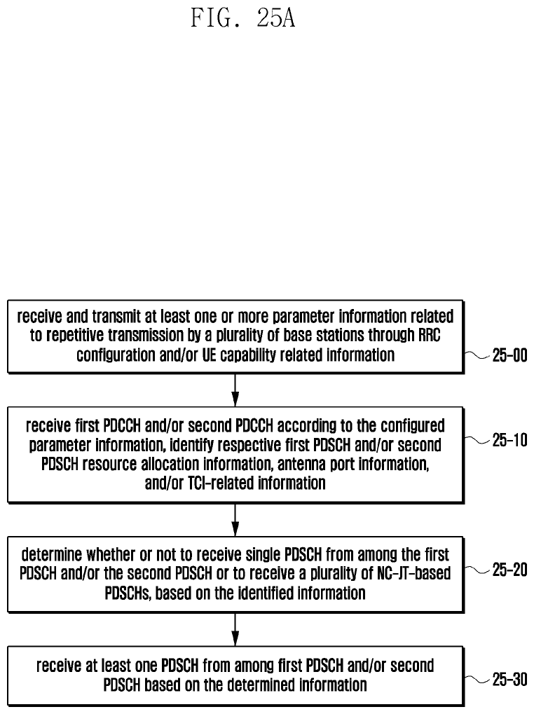

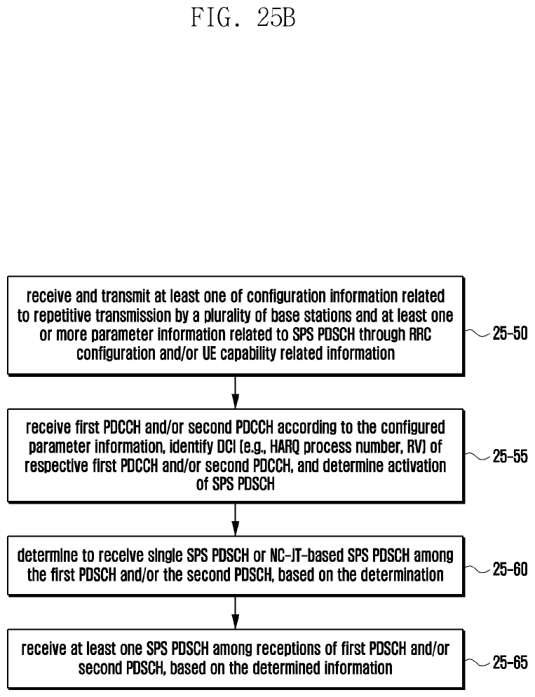

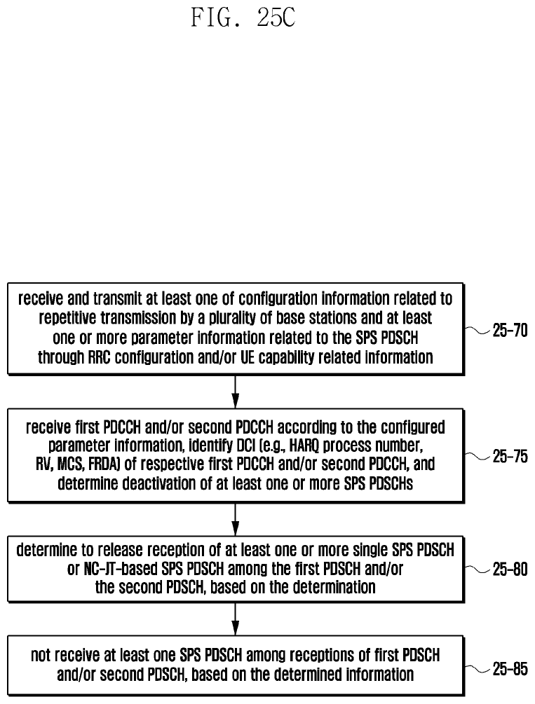

FIG. 25A is a flowchart illustrating an operation in which a UE receives control and/or data transmitted by a base station in a wireless communication system according to an example embodiment.

With reference to FIG. 25A, methods 1 to 5 described in FIGS. 21 to 24 will be briefly described.

The base station may transmit to the UE at least one or more parameter information related to repetitive transmission by at least one base stations through the RRC configuration 25-00. Accordingly, the UE may receive at least one parameter information related to repetitive transmission through RRC configuration 25-00. In addition, the base station may transmit a message requesting UE capability-related information to the UE and receive UE capability-related information from the UE. For example, information related to transmission by a plurality of base stations may include information related to CORESET or CORESETPoolIndex configuration, information related to PDSCH resource configuration, information related to TCI state configuration, information related to antenna port configuration, etc. described above. As another example, as parameter information related to repetitive PDCCH transmission, information on a plurality of search spaces explicitly connected by higher layer signaling and whether or not different CORESETPoolIndex values are configured or able to be configured in a plurality of CORESETs connected to the corresponding search spaces may be included, and information indicating whether or not activate transmission of a plurality of NC-JT-based PDSCHs that may be scheduled based on a plurality of CORESETs having differently configured CORESETPoolIndex values and respectively connected to a plurality of explicitly connected search spaces (e.g., enableNCJT) may be included. In addition, as described above, the base station may receive the UE capability information according to the request of the base station. The UE capability information may be received before or after the transmitting of the RRC configuration information. Also, reception of the UE capability information may be omitted. For example, in a situation where the base station has already received the UE capability information, the requesting the UE capability information may be omitted.

The UE may receive a first PDCCH and/or a second PDCCH according to the configured parameter information. In addition, the UE may identify the first PDSCH and/or second PDSCH resource allocation information, antenna port information, and/or TCI-related information based on the first PDCCH and/or the second PDCCH 25-10.

The UE may determine whether or not to receive a single PDSCH from among the first PDSCH and/or the second PDSCH or to receive a plurality of NC-JT-based PDSCHs, based on the identified information 25-20. Specific details are the same as those described above, and are omitted below.

In addition, the UE may receive at least one of the first PDSCH and/or the second PDSCH, based on the determined information 25-30.

### Fifth Embodiment: SPS PDSCH or NC-JT-Based SPS PDSCH Scheduling Configuration Method for Repetitive PDCCH Transmission

According to an example embodiment, the case where a UE receives repetitive PDCCH transmissions from a base station in the non-SFN method, that is, the case where different CORESETPoolIndexes are configured for control resource sets respectively connected to explicitly connected search spaces may be considered. As described above, the same DCI field (e.g., time/frequency resource allocation field, antenna port field, TCI state field, HARQ process ID field, NDI field, etc.) for repetitively transmitted PDCCHs must have the same value, so that a problem may occur in that time and frequency resource allocation information indicated through all PDCCHs, an antenna port field, a TCI state field, a HARQ process ID field, an NDI field, and the like are identical to each other. In the following embodiment, in the case where different CORESETPoolIndexes are configured for the control resource sets respectively connected to explicitly connected search space during repetitive PDCCH transmission, an SPS-based single PDSCH or a plurality of PDSCHs are activated, which is received by the UE, and the operation of such UE is described below. Here, in the case where a plurality of PDSCHs are activated, entirely overlapping, partially overlapping, or non-overlapping SPS-based PDSCH reception scenarios may be considered.

### Fifth-1 Embodiment: Method for Activating a Single SPS PDSCH Transmission or a Plurality of NC-JT-Based SPS PDSCH Transmission when Repetitively Transmitting PDCCHs Based on CORESET in which Different CORESETPoolIndex are Configured

FIG. 24 is a diagram illustrating a method for allocating time and frequency resources of a plurality of PDSCHs, based on NC-JT, scheduled from control resource sets in which different CORESETPoolIndex are configured according to an example embodiment.

With reference to FIG. 24, the base station may transmit a first PDCCH (PDCCH #1) in a first TRP (TRP-A) configured with CORESETPoolIndex #0 and a second PDCCH (PDCCH #1′) in a second TRP (TRP-B) configured with CORESETPoolIndex #1 to the UE. In this case, if the values of the DCI field of at least some or all of the first PDCCH and the second PDCCH are configured to the same value, some ambiguous interpretation or undefined interpretation may occur. In particular, operation and definition for activating a single SPS PDSCH transmission or a plurality of NC-JT-based SPS PDSCH transmission when repetitively transmitting PDCCHs based on CORESET in which different CORESETPoolIndex are configured are required.

[Method 6-1] As shown in FIG. 24 and Table 32-1, if the RNTI used to scrambling the CRC of the DCI in the first PDCCH and second PDCCH transmitted in CORESET in which different CORESETPoolIndex are configured is the CS-RNTI, and if both the HARQ process number field and redundancy version field of the DCI (e.g., DCI format 1_0 or DCI format 1_2) field information are configured to 0, the base station and the UE may understand that a single DL SPS (or single UL grant Type 2 SPS) is activated according to SPS-related parameters preconfigured in RRC. In addition, if the RNTI used to scrambling the CRC of the DCI in the first PDCCH and second PDCCH transmitted in CORESET in which different CORESETPoolIndex are configured is the CS-RNTI, if all the HARQ process number field of the DCI (e.g., DCI format 1_1) field information are configured to 0, and if all fields corresponding to the activated TB (e.g., Transport Block #1 or Transport Block #2) among the redundancy version fields are configured to 0, the base station and the UE may understand that a single DL SPS (or single UL grant Type 2 SPS) is activated according to SPS-related parameters preconfigured in RRC.

That is, when the UE performs decoding of both the first PDCCH and the second PDCCH and identifies that both the HARQ process number field and/or the RV field are configured to a value of 0, the UE may determine that a single SPS PDSCH or a plurality of SPS PDSCHs based on NC-JT is scheduled and activated based on the allocated time and frequency resource. In addition, when the UE performs decoding of the first PDCCH or the second PDCCH associated with the search space (set) associated with the first PDCCH, and identifies that the HARQ process number field and/or RV field of one of the first PDCCH and the second PDCCH are both configured to a value of 0, the UE may determine that a single SPS PDSCH or a plurality of SPS PDSCHs based on NC-JT are scheduled and activated based on the allocated time and frequency resources.

[Method 6-2] As shown in FIG. 24 and Table 32-2, if the RNTI used to scrambling the CRC of the DCI in the first PDCCH and second PDCCH transmitted in CORESET in which different CORESETPoolIndex are configured is the CS-RNTI, and if all the redundancy version field of the DCI (e.g., DCI format 1_0 or DCI format 1_2) field information are configured to 0, the base station and the UE may understand that a single DL SPS (or single UL grant Type 2 SPS) corresponding to a value of HARQ process number, among a plurality of SPS configurations, is activated according to SPS-related parameters (e.g., ConfiguredGrantConfigIndex or by sps-ConfigIndex) preconfigured in RRC. In addition, if all fields corresponding to the activated TB (e.g., Transport Block #1 or Transport Block #2) among the redundancy version field in the DCI (e.g., DIC format 1_1) field information in the first PDCCH and second PDCCH transmitted in CORESET in which different CORESETPoolIndex are configured to 0, the base station and the UE may understand that a single DL SPS (or single UL grant Type 2 SPS) corresponding to a value of HARQ process number among the plurality of SPS configurations is activated according to SPS-related parameters (e.g., ConfiguredGrantConfigIndex or by sps-ConfigIndex) preconfigured in RRC.

That is, when the UE performs decoding of both the first PDCCH and the second PDCCH, identifies that the RV fields are all configured to a value of 0, and identifies whether the values of the HARQ process number are the same or the values of the HARQ process number are sequential, the UE may determine that a single SPS PDSCH or a plurality of SPS PDSCHs based on NC-JT is scheduled and activated based on the allocated time and frequency resource.

[Method 6-3] By extending the above-described Fourth-3 embodiment, the base station and the UE may support all or limited switching operation of a single SPS PDSCH and SPS PDSCH(s) based on NC-JT.

Static switching operation using higher layer signaling may be performed based on RRC signaling (e.g., enableNCJT=enable).

For example, if a single SPS PDSCH or single NC-JT-based SPS PDSCH(s) is already activated in one of the two methods, and if the static switching operation using higher layer signaling is performed based on RRC signaling (e.g., enableNCJT=enable), the UE may maintain a continuous reception operation without switching until the single SPS PDSCH or single NC-JT-based SPS PDSCH(s) in an already activated state becomes an inactive state. That is, the UE may perform switching based on the updated RRC signaling at a time point after the inactive state of the single SPS PDSCH or single NC-JT-based SPS PDSCH(s) has progressed. As another example, if the single SPS PDSCH or single NC-JT-based SPS PDSCH(s) is already activated in one of the two methods, and if the static switching operation using higher layer signaling is performed based on RRC signaling (e.g., enableNCJT=enable), the UE may stop reception operation of the single SPS PDSCH or single NC-JT-based SPS PDSCH(s) in an already activated state. That is, the UE may determine that the single SPS PDSCH or single NC-JT-based SPS PDSCH(s) is deactivated through the RRC signaling.

As in Fourth-3 described above, the dynamic switching operation using DCI field information may be performed based on TCI information, antenna port information, TDRA or FDRA information.

For example, if the single SPS PDSCH or single NC-JT-based SPS PDSCH(s) is already activated in one of the two methods, and if a switching indication using at least one DCI field information described above is received, the UE may immediately perform switching the single SPS PDSCH or single NC-JT-based SPS PDSCH(s) in an already activated state. As another example, if the single SPS PDSCH or single NC-JT-based SPS PDSCH(s) is already activated in one of the two methods, and if the switching indication using at least one DCI field information described above is received, the UE may maintain the continuous reception operation without switching until the single SPS PDSCH or single NC-JT-based SPS PDSCH(s) in an already activated state is deactivated. That is, the UE may perform switching based on the switching indication using updated DCI field information at a time after the single SPS PDSCH or single NC-JT-based SPS PDSCH(s) is changed to an inactive state. As another example, if the single SPS PDSCH or single NC-JT-based SPS PDSCH(s) is already activated in one of the two methods, and the switching indication using at least one DCI field information described above is received, the UE may understand as changing the single SPS PDSCH or single NC-JT-based SPS PDSCH(s) in an already activated state to an inactive state.

[Method 6-4] By extending the above-described Fourth-3 embodiment, the base station and the UE may not support switching operation of a single SPS PDSCH and an NC-JT-based SPS PDSCH(s) using a repetitively transmitted PDCCH.

### Fifth-2 Embodiment: Dropping Method in the Case where (a Single SPS PDSCH or) NC-JT Based SPS PDSCH Resources Overlap when PDCCH is Repetitively Transmitted Based on CORESET in which Different CORESETPoolIndex are Configured

With reference to FIG. 24, the base station may transmit a first PDCCH (PDCCH #1) in a first TRP (TRP-A) configured to CORESETPoolIndex #0, and a second PDCCH (PDCCH #1′) in a second TRP (TRP-B) configured to CORESETPoolIndex #1 to the UE. In this case, if DCI field values of at least some or all of the first PDCCH and the second PDCCH are configured to the same value, some ambiguous interpretation or undefined interpretation may occur. In particular, the operation and definition for dropping when a single SPS PDSCH transmission or a plurality of NC-JT-based SPS PDSCH transmissions are activated when repetitively transmitting PDCCH based on CORESET in which different CORESETPoolIndex are configured and the configured SPS PDSCH(s) are received are required.

[Method 7-1] In one slot scheduled by the DCI in the first PDCCH and second PDCCH repetitively transmitted in CORESET in which different CORESETPoolIndex are configured by the base station according to the above-described Fifth-1 embodiment as shown in FIG. 24, if the resources of the single SPS PDSCH or NC-JT-based SPS PDSCH are configured to overlap at least partially or entirely with each other, the UE may determine whether or not to receive the SPS PDSCH depending on whether the PDCCH scheduling the overlapping SPS PDSCH resources (or resource pairs) is the PDCCH based on the repetitive transmission. That is, in the case where the PDSCH scheduled according to the repetitive PDCCH transmission configured by the base station overlap in some or all of the time resource regions (e.g., symbols), the UE may receive all of the PDSCHs and perform decoding of the same. Specifically, the UE may receive signals from non-overlapping resources as well as overlapping resources and perform decoding. On the other hand, if the PDSCHs overlapping in part or all of the time resource region are not scheduled according to repetitive PDCCH transmission, the UE may receive and decode PDSCHs except for the overlapping PDSCHs. In this case, the UE may exclude the PDSCH based on the above-described dropping rule for overlapped PDSCH.

For example, the UE identifies whether the HARQ process numbers are sequentially allocated (e.g., 1st PDSCH: n, 2nd PDSCH: n+1), and if so, the application of the above-described dropping rule for overlapped PDSCH (step 0 to step 3) may be excluded. That is, if the resource of a single DL SPS (or single UL grant Type 2 SPS) overlaps and the HARQ process number of the PDCCH scheduling this resource is sequential, the UE may receive all overlapping SPS PDSCH resources (or resource pairs) and perform decoding of the same.

Specifically, therefore, in the case where the PDSCH is scheduled by repetitive PDCCH transmission, the repetitively transmitted PDCCH may be transmitted through each CORESET corresponding to two CORESETPoolIndex (index 0, 1). In this case, the HARQ Process ID may be determined as follows according to the configuration of harq-ProcID-Offset, and in this case, the formula for determining the Harq process number may be changed as follows according to the CORESETPoolindex configured in the UE. Therefore, in the case where the PDSCH is scheduled by repetitive PDCCH transmission, the HARQ process ID may be sequentially allocated by the CORESETPoolIndex, and the UE may receive all the PDSCHs scheduled by the PDCCH having the sequentially allocated HARQ process ID regardless of overlapping and perform decoding of the same. Here, CURRENT_slot is [(SFN numberOfSlotsPerFrame), and numberOfSlotsPerFrame follows the number of consecutive slots per frame set by the standard.

HARQProcssID=[floor(CURRENT_slot×10/(numberOfSlotsPerFrame×periodicity))] modulo nrofHARQ-Processs+CORESETPOOlindex HARQ Process ID=[floor(CURRENT_slot×10/(numberOfSlotsPerFrame×periodicity))] modulo nrofHARQ-Processes+harq-ProcID-Offset+CORESETPOOlindex

However, the scope of rights of the disclosure is not limited thereto. That is, according to the method for determining the HARQ Process ID, the HARQ Process ID may not be sequentially determined even in the case of repetitive transmission of the PDCCH. Even in this case, in the case where PDSCHs overlap according to repetitive PDCCH transmission, the UE may receive all overlapped PDSCHs and perform decoding the same.

[Method 7-2] In CORESET in which different CORESETPoolIndex are configured by the base station according to the above-described Fifth-1 embodiment as shown in FIG. 24, if the resources of the single SPS PDSCH or NC-JT-based SPS PDSCH are configured to overlap at least partially or entirely with each other, the UE may determine based on the actual resource allocation related information (e.g., TDRA, FDRA) regardless of the HARQ process ID of the PDCCH scheduling the overlapping SPS PDSCH resource pairs.

As described in Method 7-1 or Method 7-2 above, in CORESET in which different CORESETPoolIndex are configured, a resource configuration in which the resources of the single SPS PDSCH or NC-JT-based SPS PDSCH(s), which are scheduled in the DCI in the first PDCCH and second PDCCH repetitively transmitted, or the preceding two resources overlap at least partially or completely with each other may be basically included in an operation based on UE capability. Specifically, as the UE capability parameter, the number of overlapping SPS PDSCH(s) within a single slot may be defined or the number of SPS PDSCH(s) that the UE may receive within a single slot may be defined.

### Fifth-3 Embodiment: Method for Deactivating a Single SPS PDSCH Transmission or a Plurality of NC-JT-Based SPS PDSCH Transmission Based on Scheduling of Repetitively Transmitted PDCCHs

Method 1: Performing Deactivation Operation by a Single PDCCH

In the case where the CORESETPoolIndex is not configured for the UE by the base station or only one CORESETPoolIndex is configured for the UE by the base station, the single SPS PDSCH or single NC-JT-based SPS PDSCH(s) activated by the method described in the above Fifth-1 embodiment may be deactivated by a single PDCCH. Here, the UE may operate according to the determination conditions in Table 32-1 or Table 32-4 described in [SPS PDSCH activation/deactivation].

As an example, in the case where the RNTI used to scrambling the DCI and CRC of the DCI transmitted through the PDCCH is the CS-RNTI, and where the HARQ process number, redundancy version, modulation and coding scheme, and frequency domain resource assignment fields included in the DCI satisfy Table 32-3, the UE and the base station may understand that the DL SPS or UL grant type 2 is deactivated. As another example, in the case where the RNTI used to scrambling the DCI and CRC of the DCI transmitted through the PDCCH is the CS-RNTI, and the redundancy version, modulation and coding scheme, and frequency domain resource assignment fields included in the DCI satisfy Table 32-4, the UE and the base station may understand that one DL SPS or UL grant type 2 among ones in which a plurality of DL SPS or UL grant type 2 is configured is deactivated.

On the other hand, in the case where CORESETPoolIndex is not configured for the UE by the base station or only one CORESETPoolIndex is configured for the UE by the base station, a plurality of SPS PDSCHs or a plurality of NC-JT-based SPS PDSCHs(s) activated by the method described in the above Fifth-1 embodiment may be deactivated by a single PDCCH. Here, the UE may operate according to the determination conditions in Table 32-1 or Table 32-4 described in [SPS PDSCH activation/deactivation].

If a plurality of SPS-based PDSCHs or UL grant type 2 PUSCH(s) are configured, if the information related to ConfiguredGrantConfigType2 DeactivationStateList or sps-ConfigDeactivationStateList is configured in a higher layer and activated by the PDCCH, as described above in [Deactivation of multiple SPSs], the UE may identify the HARQ process ID(s) allocated by the PDCCH and perform an operation of deactivating reception of the SPS-based PDSCH or UL grant type 2 PUSCH(s) corresponding to the HARQ process ID(s).

For example, the value of the HARQ process number field in the DCI format indicates a value of an entry corresponding to scheduling for releasing at least one UL grant Type 2 PUSCH or SPS-based PDSCH configuration, and the UE may identify a field value of the DCI format HARQ process number and release SPS-related operations.

As another example, if a plurality of SPS-based PDSCHs or UL grant type 2 PUSCH(s) are configured and the information related to ConfiguredGrantConfigType2 DeactivationStateList or sps-ConfigDeactivationStateList is not configured through a higher layer, the value of the HARQ process number field in the DCI format may indicate to release the UL grant Type 2 PUSCH or SPS-based PDSCH configuration having the same value respectively configured in ConfiguredGrantConfigIndex or sps-ConfigIndex. Therefore, the UE may identify the field value of the DCI format HARQ process number to release the SPS-related operation.

Method 2: Performing deactivation operation by PDCCH repetitively transmitted from CORESETs in two different CORESETPoolIndexes

In order to deactivate the SPS PDSCH or NC-JT-based SPS PDSCH activated by repetitive PDCCH transmission within CORESET configured through two different CORESETPoolIndexes, the base station may indicate to deactivate the above activated SPS PDSCH or NC-JT-based SPS PDSCH through the PDCCHs repetitively transmitted within CORESETs configured to the two CORESETPoolIndexes.

For example, in order to identify the deactivation indication based on the PDCCH repetitively transmitted within the CORESET configured through two different CORESETPoolIndex, the UE may identify whether the RNTI used to scrambling the DCI and CRC of the DCI transmitted through the PDCCH associated with a search space (set) repetitively transmitted in the DCI format is the CS-RNTI. In addition, the UE may identify whether the HARQ process number, redundancy version, modulation and coding scheme, and frequency domain resource assignment fields included in each DCI are as shown in Table 32-3 or Table 32-4 below. After determining that the deactivation is indicated, the UE may not perform the reception operation of the configured SPS PDSCH or NC-JT-based SPS PDSCH. That is, the UE may not receive data from the SPS PDSCH after determining that the deactivation of the SPS PDSCH is indicated, or may not decode data from the SPS PDSCH even though at least some SPS PDSCHs are received, or may not attempt to decode data from the SPS PDSCH.

As another example, the UE may identify the HARQ process ID field of the PDCCH repetitively transmitted in the DCI format in order to identify the deactivation indication based on the PDCCH repetitively transmitted in the CORESET configured to two different CORESETPoolIndex. The UE may determine whether each PDCCH includes the same value as at least one HARQ process number or HARQ process ID(s) configured in the upper layer SPS-ConfigDeactivationState or sequential values. The UE may identify the repetitively transmitted PDCCH, and if the HARQ process ID(s) is included, the UE determines that the deactivation of all activated SPS PDSCHs or NC-JT based SPS PDSCHs is indicated, and may not perform the reception operation of SPS PDSCHs or NC-JT based SPSs subsequently configured. That is, after determining that the deactivation of the SPS PDSCH is indicated, the UE may not receive data from the SPS PDSCH, may not decode data from the SPS PDSCH, or may not attempt to decode data from the SPS PDSCH.

Alternatively, the UE may not perform a reception operation only for the SPS PDSCH or NC-JT-based SPS PDSCH corresponding to the HARQ process ID by identifying the repetitively transmitted PDCCH. That is, after determining that the deactivation of the SPS PDSCH or NC-JT-based SPS PDSCH corresponding to the HARQ process ID is indicated, the UE may not receive data from the SPS PDSCH, or may not decode data from the SPS PDSCH, or may not attempt to decode data from the SPS PDSCH.

FIG. 25B is a flowchart illustrating an operation in which an UE receives control and/or data transmitted by a BS in a communication system according to an example embodiment.

With reference to FIG. 25B, the matters illustrated in the above described FIGS. 21 to 24 and Fifth-1 embodiment are briefly shown.

The base station may transmit at least one of configuration information related to repetitive transmission by at least one base station and SPS configuration information (or at least one parameter information related to the SPS PDSCH) to the UE through RRC configuration 25-50. Accordingly, the UE may receive at least one of at least one piece of parameter information related to repetitive transmission and at least one piece of parameter information related to the SPS PDSCH through RRC configuration. For example, the information related to transmission by at least one base station may include at least one of information related to the above described CORESET or CORESETPoolIndex configuration, information related to PDSCH resource configuration, information related to TCI stats configuration, information related to antenna port configuration, and SPS related information configured in ConfiguredGrantConfigIndex sps-ConfigIndex. As another example, as parameter information related to repetitive PDCCH transmission, information on a plurality of search spaces explicitly connected by higher layer signaling and whether or not different CORESETPoolIndexes are configured or able to be configured in a plurality of CORESETs respectively connected to the corresponding search spaces may be included, and information indicating whether or not activate transmission of a plurality of NC-JT-based PDSCHs that may be scheduled based on a plurality of CORESETs having differently configured CORESETPoolIndex and respectively connected to a plurality of explicitly connected search spaces (e.g., enableNCJT) may be included. In addition, as described above, the base station may receive UE capability information according to the request of the base station. The UE capability information may be received before or after the transmitting of the RRC configuration information. Also, the reception of the UE capability information may be omitted. For example, in a situation where the base station has already received the UE capability information, the requesting the UE capability information may be omitted.

The UE may receive a first PDCCH and/or a second PDCCH according to the configured parameter information and identify at least one of the respective first PDSCH and/or second PDSCH resource allocation information, antenna port information, HARQ process number, RV related information and/or TCI-related information, based on the first PDCCH and/or second PDCCH. In addition, the UE may determine whether or not to activate SPS PDSCH based on the first PDCCH and/or second PDCCH 25-55. The method for determining the activation of the SPS PDSCH is the same as the method described in Fifth-1 embodiment, and is omitted below. The UE may determine whether to receive a single SPS PDSCH or a plurality of NC-JT-based SPS PDSCHs among the first PDSCH and/or the second PDSCH, based on the identified information 25-60. The UE may receive at least one of the first PDSCH and/or the second PDSCH, based on the determined information 25-65.

Meanwhile, a plurality of activated SPS PDSCHs may exist, and some of the resources may overlap. In this case, the UE may determine whether data is received in the overlapped resource according to whether the first PDCCH and the second PDCCH are PDCCHs in which repetitive transmission is configured. Specifically, if the first PDCCH and the second PDCCH are PDCCHs in which repetitive transmission is configured, the UE may receive and decode data on all SPS PDSCHs activated through the first PDCCH and the second PDCCH. On the other hand, if the first PDCCH and the second PDCCH are not PDCCHs in which repetitive transmission is configured, the UE may receive data from some SPS PDSCHs according to the above-described dropping rule.

In this case, whether the first PDCCH and the second PDCCH are PDCCHs in which repetition configuration is configured may be determined based on the HARQ process ID determined based on a control channel index related to the PDCCH. Specific details are the same as those described above and will be omitted below.

FIG. 25C is a flowchart illustrating an operation in which an UE receives control and/or data transmitted by a base station in a wireless communication system according to an example embodiment.

The base station may transmit at least one of configuration information related to repetitive transmission by at least one base station and SPS configuration information (or at least one parameter information related to the SPS PDSCH) to the UE through RRC configuration 25-70. Accordingly, the UE may receive at least one of at least one piece of parameter information related to repetitive transmission and at least one piece of parameter information related to the SPS PDSCH through RRC configuration. For example, information related to repetitive transmission by at least one base station may include at least one of information related to the above described CORESET or CORESETPoolIndex configuration, information related to PDSCH resource configuration, information related to TCI stats configuration, information related to antenna port configuration, SPS related information configured in ConfiguredGrantConfigIndex sps-ConfigIndex. As another example, as parameter information related to repetitive PDCCH transmission, information on a plurality of search spaces explicitly connected by higher layer signaling and whether or not different CORESETPoolIndex are configured or able to be configured in a plurality of CORESETs respectively connected to the corresponding search spaces may be included, and information indicating whether or not activate transmission of a plurality of NC-JT-based PDSCHs that may be scheduled based on a plurality of CORESETs having differently configured CORESETPoolIndex and respectively connected to a plurality of explicitly connected search spaces (e.g., enableNCJT) may be included. In addition, as described above, the base station may receive UE capability information according to the request of the base station. The UE capability information may be received before or after the transmitting of the RRC configuration information. Also, the reception of the UE capability information may be omitted. For example, in a situation where the base station has already received the UE capability information, the requesting the UE capability information may be omitted.

The UE may receive a first PDCCH and/or a second PDCCH according to the configured parameter information and identify at least one of the respective first PDSCH and/or second PDSCH resource allocation information, antenna port information, HARQ process number, RV, MCS, FRDA related information and/or TCI-related information, based on the first PDCCH and/or second PDCCH. In addition, the UE may determine whether or not to deactivate SPS PDSCH based on the first PDCCH and/or second PDCCH 25-75. Based on the identified information, the UE may determine to release reception of a single SPS PDSCH or a plurality of SPS PDSCHs based on NC-JT among the first PDSCH and/or the second PDSCH 25-80. The UE may not perform reception of at least one SPS PDSCH among reception of the first PDSCH and/or the second PDSCH based on the determined information 25-85. Alternatively, the UE may not attempt decoding of the SPS PDSCH based on the determined information.

Here, the base station and the UE may consider the following methods for the timing of determining and applying deactivation.

For example, the UE may perform deactivation based on at least one of the same slot, minislot, or subslot based on a PDCCH time point in a CORESET scheduled first or last among repetitively transmitted PDCCH resources. As another example, the UE may perform deactivation after N slots, minislots, or subslots based on a PDCCH time point in a CORESET scheduled first or last among repetitively transmitted PDCCH resources.

### Sixth Embodiment: A Timing of TCI State Update Operation Before SPS PDSCH Deactivation Indication is Transmitted

According to an example embodiment, if a single SPS PDSCH or a plurality of NC-JT-based SPS PDSCHs are activated, a UE may receive at least one SPS PDSCH corresponding to one PDCCH. As described in the fifth embodiment, the UE may maintain the operation of receiving the SPS PDSCH until receiving the deactivation indication. Here, the UE may receive a TCI state update indication transmitted by the base station, and the UE needs a criterion for determining when to receive control channel information including the TCI update transmitted by the base station and apply the same.

First, the UE may update the TCI state at a time of receiving the PDCCH, which includes the DCI satisfying the condition for activating the SPS-based PDSCH or UL grant type 2 or after a certain time (e.g., 1 to n slots) from the time of receiving the PDCCH. The predetermined time may be determined in units of slots, units of symbols, or units of absolute time. For example, the base station may transmit DCI indicating additional activation to change the TCI state of the SPS-based PDSCH or UL grant type 2 of a specific UE. The UE may determine that the TCI is changed from the resource of the SPS PDSCH scheduled by the PDCCH including the TCI state change information.

Second, the UE may update the TCI state at the time of receiving the PDCCH including information for updating the configuration of the SPS or after a certain time (e.g., 1 to n slots) from the time of receiving the PDCCH. The predetermined time may be determined in units of slots, units of symbols, or units of absolute time. As an example, the base station may transmit the DCI indicating additional SPS update to change the TCI state of the SPS-based PDSCH or UL grant type 2 of a specific terminal. The UE may determine that the TCI is changed from the resource of the SPS PDSCH scheduled by the PDCCH including the TCI state change information.

According to the above two embodiments, even if the UE receives a MAC CE-based TCI state update command, the UE may ignore the TCI state without reflecting the same.

Thirdly, the UE may perform an update after receiving a MAC CE message including the TCI information including the updated TCI state transmitted by the base station. As an example, the UE may receive a MAC CE-based message for TCI update and perform TCI change after a certain time (e.g., 1 to n slots). The predetermined time may be determined in units of slots, units of symbols, or units of absolute time.

Fourth, even if the UE receives the MAC CE message including the TCI information including the updated TCI state transmitted by the base station, the UE may ignore the MAC CE message without performing TCI change.

Therefore, a method performed by a UE according to an example embodiment includes receiving, from a base station, semi persistent scheduling (SPS) configuration information and control channel configuration information, receiving, from the base station, downlink control information (DCI) repetitively transmitted through a plurality of physical downlink control channels (PDCCHs) based on the control channel configuration information, and identifying whether activated SPS PDSCH is deactivated based on information included in each of the repetitively transmitted DCI. In the case where the activated SPS PDSCH is deactivated, decoding of data is not attempted in the deactivated SPS PDSCH.

In addition, a method performed by a base station according to an example embodiment includes transmitting, to a terminal, semi persistent scheduling (SPS) configuration information and control channel configuration information; determining deactivation of an activated SPS physical downlink shared channel (PDSCH); producing repetitively transmitted downlink control information (DCI) each including information for deactivating the activated SPS PDSCH; and transmitting, to the terminal, the repetitively transmitted DCI through a plurality of physical downlink control channels (PDCCHs) based on the control channel configuration information, wherein data is not transmitted in the deactivated SPS PDSCH.

In addition, a terminal according to an example embodiment includes a transceiver; and a controller to receive, from a base station, semi persistent scheduling (SPS) configuration information and control channel configuration information, receive, from the base station, repetitively transmitted downlink control information (DCI) through a plurality of physical downlink control channels (PDCCHs) based on the control channel configuration information, and identify whether an activated SPS PDSCH is deactivated based on information included in each of the repetitively transmitted DCI. In the case where the activated SPS PDSCH is deactivated, decoding of data in the deactivated SPS PDSCH is not attempted.

In addition, a base station according to an example embodiment includes a transceiver; and a controller that is connected, directly or indirectly, to the transceiver and transmits, to a terminal, semi persistent scheduling (SPS) configuration information and control channel configuration information, determines deactivation of an activated SPS physical downlink shared channel (PDSCH), produces repetitively transmitted downlink control information (DCI) each including information for deactivating the activated SPS PDSCH, and transmits, to the terminal, the repetitively transmitted DCI through a plurality of physical downlink control channels (PDCCHs) based on the control channel configuration. The data is not transmitted in the deactivated SPS PDSCH.

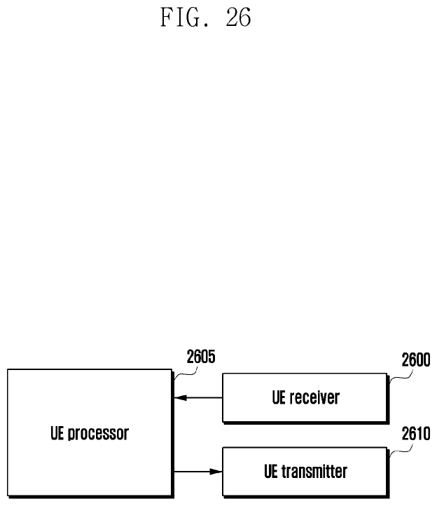

FIG. 26 is a diagram illustrating the structure of a UE in a wireless communication system according to an example embodiment.

With reference to FIG. 26, the UE may include a transceiver with reference to a UE receiver 2600 and a UE transmitter 2610, a memory (not shown), and a UE processor 2605 (or a UE controller or processor). According to the above-described communication method of the UE, the UE transceiver 2600 and 2610, the memory, and the UE processor 2605 may operate. However, the components of the UE are not limited to the above-described examples. For example, the UE may include more or fewer components than the aforementioned components. In addition, the transceiver, the memory, and the processor may be implemented in the form of one chip.

The transceiver may transmit/receive a signal to/from the base station. Here, the signal may include control information and data. To this end, the transceiver may include an RF transmitter for up-converting and amplifying a frequency of a transmitted signal, and an RF receiver for low-noise amplifying and down-converting a received signal. However, this is only an embodiment of the transceiver, and the components of the transceiver are not limited to the RF transmitter and the RF receiver.

In addition, the transceiver may receive a signal through a radio channel, output the same to the processor, and transmit a signal output from the processor through a radio channel.

The memory may store programs and data necessary for the operation of the UE. In addition, the memory may store control information or data included in a signal transmitted and received by the UE. The memory may be configured as a storage medium such as read only memory (ROM), random access memory (RAM), hard disks, compact disc read only memory (CD-ROM), and digital versatile disc (DVD), or a combination thereof. In addition, a plurality of memories may be provided.

In addition, the processor may control a series of processes such that the UE operates according to the above-described embodiment. For example, the processor may control the components of the UE so as to receive DCI comprised of two layers, thereby simultaneously receiving a plurality of PDSCHs. A plurality of processors may be provided, and the processor may execute a program stored in the memory to perform a component control operation of the UE.

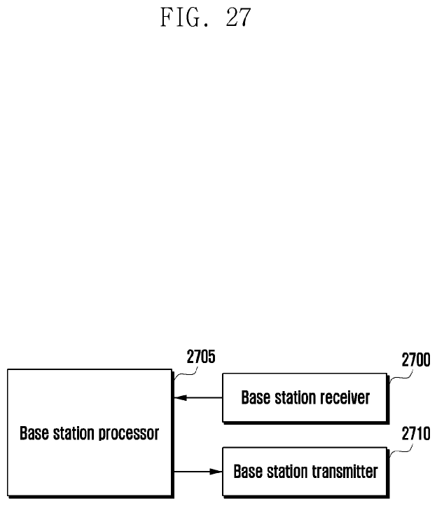

FIG. 27 is a diagram illustrating the structure of a base station in a wireless communication system according to an example embodiment.

With reference to FIG. 27, the base station may include a transceiver with reference to a base station receiver 2700 and a base station transmitter 2710, a memory (not shown), and a base station processor 2705 (or a base station controller or processor). According to the above-described communication method of the base station, the base station transceiver 2700 and 2710, the memory, and the base station processor 2705 may operate. However, the components of the base station are not limited to the above-described examples. For example, the base station may include more or fewer components than the aforementioned components. In addition, the transceiver, the memory, and the processor may be implemented in the form of one chip.

The transceiver may transmit/receive a signal to/from the UE. Here, the signal may include control information and data. To this end, the transceiver may include an RF transmitter for up-converting and amplifying a frequency of a transmitted signal, and an RF receiver for low-noise amplifying and down-converting a received signal. However, this is only an embodiment of the transceiver, and the components of the transceiver are not limited to the RF transmitter and the RF receiver.

In addition, the transceiver may receive a signal through a radio channel, output the same to the processor, and transmit a signal output from the processor through a radio channel.

The memory may store programs and data necessary for the operation of the base station. In addition, the memory may store control information or data included in a signal transmitted and received by the base station. The memory may be configured as a storage medium such as ROM, RAM, hard disks, CD-ROM, and DVD, or a combination thereof. In addition, a plurality of memories may be provided.

The processor may control a series of processes such that the base station operates according to the above-described embodiment. For example, the processor may control the components of the base station so as to configure and transmit two-layer DCI including allocation information for a plurality of PDSCHs. A plurality of processors may be provided, and the processor may execute a program stored in the memory to perform a component control operation of the base station.

The methods according to embodiments described in the claims or the specification of the disclosure may be implemented by hardware, software, or a combination of hardware and software.

In the case where the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

The programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. Further, a plurality of such memories may be included.

In addition, the programs may be stored in an attachable storage device which may be accessed through communication networks such as the Internet, Intranet, Local Area Network (LAN), Wide LAN (WLAN), and Storage Area Network (SAN) or a combination thereof. Such a storage device may access the device performing the embodiments of the disclosure via an external port. Further, a separate storage device on the communication network may access the device performing the embodiments of the disclosure.

In the above-described detailed embodiments of the disclosure, a component included in the disclosure is expressed in the singular or the plural according to presented detailed embodiments. However, the singular form or plural form is selected appropriately to the presented situation for the convenience of description, and the disclosure is not limited by components expressed in the singular or the plural. Therefore, either a component expressed in the plural may also include a single component or a component expressed in the singular may also include multiple components.

Meanwhile, the embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Further, the above respective embodiments may be employed in combination, as necessary. For example, an example embodiment may be partially combined with another embodiment to operate a base station and a terminal. As an example, embodiments 1 and 2 of the disclosure may be partially combined to operate a base station and a terminal. Further, although the above embodiments have been described by way of the FDD LTE system, other variants based on the technical idea of the embodiments may be implemented in other systems such as TDD LTE and 5G or NR systems. “Based on” as used herein covers based at least on.

Meanwhile, in the drawings in which methods of the disclosure are described, the order of the description does not always correspond to the order in which steps of each method are performed, and the order relationship between the steps may be changed or the steps may be performed in parallel.

Alternatively, in the drawings in which methods of the disclosure are described, some components may be omitted and only some components may be included therein without departing from the essential spirit and scope of the disclosure.

Further, in methods of the disclosure, some or all of the contents of each embodiment may be implemented in combination without departing from the essential spirit and scope of the disclosure.

Various embodiments of the disclosure have been described. The above description of the disclosure is for the purpose of illustration, and embodiments of the disclosure are not limited to the embodiments set forth herein. Those skilled in the art will appreciate that other specific modifications and changes may be easily made thereto the without departing from the technical idea or essential features of the disclosure. The scope of the disclosure is defined not by the above description but by the appended claims to be described below, and all modifications or changes derived from the meaning and scope of the claims and equivalent concepts thereof shall be construed as falling within the scope of the disclosure. While the disclosure has been illustrated and described with reference to various embodiments, it will be understood that the various embodiments are intended to be illustrative, not limiting. It will further be understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

1. A method performed by a terminal in a communication system, the method comprising:
receiving, from a base station, semi persistent scheduling (SPS) configuration information and control channel configuration information;
receiving, from the base station, downlink control information (DCI) repetitively transmitted via a plurality of physical downlink control channels (PDCCHs) based on the control channel configuration information; and
identifying whether activated SPS PDSCH is deactivated based on information included in each of the repetitively transmitted DCI,
wherein, based on a determining that the activated SPS PDSCH is deactivated, decoding of data is not attempted in the deactivated SPS PDSCH.

2. The method of claim 1, wherein:
in a case that the repetitively transmitted DCI is associated with CS-RNTI, and that a hybrid automatic repeat request (HARQ) process number, redundancy version, modulation and coding scheme, and frequency domain resource assignment fields included in each of the repetitively transmitted DCI are configured to preconfigured values, the activated SPS PDSCH is deactivated, or
in a case that the repetitively transmitted DCI is associated with the CS-RNTI and that information corresponding to the HARQ process ID (identity) included in the SPS configuration information is included in each of the repetitively transmitted DCI, the SPS PDSCH is deactivated.

3. The method of claim 1, wherein the receiving the SPS configuration information and the control channel configuration information further comprises receiving data based on the activated SPS PDSCH based on the SPS configuration information and a plurality of DCI,
in a case that the activated SPS PDSCH overlaps in a slot and the plurality of DCI is the repetitively transmitted DCI, data received in all the activated SPS PDSCHs is decoded;
in a case that at least two identifiers determined based on index of a control channel through which each of the plurality of DCI is transmitted are consecutive, the plurality of DCI is the repetitively transmitted DCI.

4. The method of claim 1, wherein the repetitively transmitted DCI is received via PDCCHs of control channels with different indexes,
in a case that the activated SPS PDSCH is deactivated, the data is not decoded at a time point determined based on a first transmitted PDCCH or last transmitted PDCCH among the plurality of PDCCHs, and
in a case that the DCI including changed transmission configuration indication (TCI) state information is received before the activated SPS PDSCH is deactivated, a TCI state is changed after a time point determined based on a time point the DCI is received

5. A method performed by a base station in a communication system, the method comprising:
transmitting, to a terminal, semi persistent scheduling (SPS) configuration information and control channel configuration information;
determining deactivation of an activated SPS physical downlink shared channel (PDSCH);
producing repetitively transmitted downlink control information (DCI) each including information for deactivating the activated SPS PDSCH; and
transmitting, to the terminal, the repetitively transmitted DCI via a plurality of physical downlink control channels (PDCCHs) based on the control channel configuration information,
wherein data is not transmitted in the deactivated SPS PDSCH.

6. The method of claim 5, wherein in a case that the repetitively transmitted DCI is associated with CS-RNTI, and that a hybrid automatic repeat request (HARQ) process number, redundancy version, modulation and coding scheme, and frequency domain resource assignment fields included in each of the repetitively transmitted DCI are configured to preconfigured values, the SPS PDSCH is deactivated, or
in case that the repetitively transmitted DCI is associated with the CS-RNTI and that information corresponding to the HARQ process ID (identity) included in the SPS configuration information is included in each of the repetitively transmitted DCI, the SPS PDSCH is deactivated.

7. The method of claim 5, wherein the transmitting the SPS configuration information and the control channel configuration information further comprises transmitting data based on the activated SPS PDSCH based on the SPS configuration information and a plurality of DCI,
in a case that the activated SPS PDSCH overlaps in a slot and the plurality of DCI is the repetitively transmitted DCI, data is transmitted in all the activated SPS PDSCHs, and
in a case that at least two identifiers determined based on index of a control channel through which each of the plurality of DCI is transmitted are consecutive, the plurality of DCI is the repetitively transmitted DCI.

8. The method of claim 5, wherein the repetitively transmitted DCI is received via PDCCHs of control channels with different indexes,
in a case that the activated SPS PDSCH is deactivated, the data is not decoded at a time point determined based on a first transmitted PDCCH or last transmitted PDCCH among the plurality of PDCCHs, and
in a case that the DCI including changed transmission configuration indication (TCI) state information is transmitted before the activated SPS PDSCH is deactivated, a TCI state is changed after a time point determined based on a time point the DCI is received.

9. A terminal in a communication system, the terminal comprising:
a transceiver; and
a controller coupled with the transceiver and configured to:
receive, from a base station, semi persistent scheduling (SPS) configuration information and control channel configuration information,
receive, from the base station, repetitively transmitted downlink control information (DCI) via a plurality of physical downlink control channels (PDCCHs) based on the control channel configuration information, and
identify whether an activated SPS PDSCH is deactivated based on information included in each of the repetitively transmitted DCI,
wherein, in a case that the activated SPS PDSCH is deactivated, decoding of data in the deactivated SPS PDSCH is not attempted.

10. The terminal of claim 9, wherein, in a case that the repetitively transmitted DCI is associated with CS-RNTI, and where a hybrid automatic repeat request (HARQ) process number, redundancy version, modulation and coding scheme, and frequency domain resource assignment fields included in each of the repetitively transmitted DCI are configured to preconfigured values, the activated SPS PDSCH is deactivated, or
wherein, in a case that the repetitively transmitted DCI is associated with the CS-RNTI and where information corresponding to the HARQ process ID (identity) included in the SPS configuration information is included in each of the repetitively transmitted DCI, the SPS PDSCH is deactivated.

11. The terminal of claim 9, wherein the controller is configured to:
receive data based on the activated SPS PDSCH based on the SPS configuration information and a plurality of DCI,
in a case that the activated SPS PDSCH overlaps in a slot and the plurality of DCI is the repetitively transmitted DCI, data received in all the activated SPS PDSCHs is decoded, and
in a case that at least two identifiers determined based on index of a control channel through which each of the plurality of DCI is transmitted are consecutive, the plurality of DCI is the repetitively transmitted DCI.

12. The terminal of claim 9, wherein the repetitively transmitted DCI is received through PDCCHs of control channels having different indexes,
in a case that the activated SPS PDSCH is deactivated, the data is not decoded at a time point determined based on a first transmitted PDCCH or last transmitted PDCCH among the plurality of PDCCHs, and
in a case that the DCI including changed transmission configuration indication (TCI) state information is received before the activated SPS PDSCH is deactivated, TCI state is changed after a time point determined based on a time point the DCI is received.

13. A base station in a communication system, the base station comprising:
a transceiver; and
a controller coupled with the transceiver and configured to:
transmit, to a terminal, semi persistent scheduling (SPS) configuration information and control channel configuration information,
determine deactivation of an activated SPS physical downlink shared channel (PDSCH),
produce repetitively transmitted downlink control information (DCI) each including information for deactivating the activated SPS PDSCH, and
control to transmit, to the terminal, the repetitively transmitted DCI via a plurality of physical downlink control channels (PDCCHs) based on the control channel configuration information,
wherein the data is not transmitted in the deactivated SPS PDSCH.

14. The base station of claim 13, wherein, in a case that the repetitively transmitted DCI is associated with CS-RNTI, and where a hybrid automatic repeat request (HARQ) process number, redundancy version, modulation and coding scheme, and frequency domain resource assignment fields included in each of the repetitively transmitted DCI are configured to preconfigured values, the SPS PDSCH is deactivated, or
wherein, in a case that the repetitively transmitted DCI is associated with the CS-RNTI and where information corresponding to the HARQ process ID (identity) included in the SPS configuration information is included in each of the repetitively transmitted DCI, the SPS PDSCH is deactivated.

15. The base station of claim 13, wherein the controller is configured to transmit data based on the activated SPS PDSCH based on the SPS configuration information and a plurality of DCI, and
in a case that the activated SPS PDSCH overlaps in one slot and the plurality of DCI is the repetitively transmitted DCI, data is transmitted in all the activated SPS PDSCHs,
in a case that at least two identifiers determined based on index of a control channel through which each of the plurality of DCI is transmitted are consecutive, the plurality of DCI is the repetitively transmitted DCI,
the repetitively transmitted DCI is received through PDCCHs of control channels having different indexes,
in a case that the activated SPS PDSCH is deactivated, the data is not decoded at a time point determined based on a first transmitted PDCCH or last transmitted PDCCH among the plurality of PDCCHs, and
in a case that the DCI including changed transmission configuration indication (TCI) state information is transmitted before the activated SPS PDSCH is deactivated, TCI state is changed after a time point determined based on a time point the DCI is received.
